(19) United States
(12) Patent Application Publication
(10) Pub. No.: US 2023/0004970 A1
(43) Pub. Date: Jan. 5, 2023

(54) Distributed Ledgers with Ledger Entries Containing Redactable Payloads

(71) Applicant: Artema Labs, Inc, Los Angeles, CA (US)

(72) Inventors: Bjorn Markus Jakobsson, Portola Valley, CA (US); Stephen C. Gerber, Austin, TX (US); Ajay Kapur, Valencia, CA (US); Keir Finlow-Bates, Eura (FI); Sven Stefan Dufva, Stockholm (SE); Rebecca Anne Fiebrink, London (GB)

(73) Assignee: Artema Labs, Inc, Los Angeles, CA (US)

(21) Appl. No.: 17/810,085

(22) Filed: Jun. 30, 2022

Related U.S. Application Data
(60) Provisional application No. 63/366,391, filed on Jun. 14, 2022.
(60) Provisional application No. 63/232,728, filed on Aug. 13, 2021.
(60) Provisional application No. 63/216,662, filed on Jun. 30, 2021.

(51) Int. Cl. G06Q 20/40; G06Q 20/38

(52) U.S. Cl. CPC G06Q 20/407; G06Q 20/389

(57) ABSTRACT

The ability to write illegal information or rights holder information into an immutable public ledger is problematic for society. Similarly, the inability to selectively cause funds transfers to be undone currently gives rise to significant abuses. In various embodiments, a processor, can be configured to obtain a ledger entry associated with a distributed ledger. The ledger entry can comprise an assertion authentication value and a reference. Data can be requested based on the reference. When the data is not available, an assertion can be obtained. a result can be generated and then compared. when the result and the assertion authentication value match, a challenge can be computed using a cryptographic system, wherein the challenge is based on the ledger entry. A block that incorporates the ledger entry can be broadcast to securely add the block to the distributed ledger.

### CROSS-REFERENCE TO RELATED APPLICATIONS

The current application claims the benefit of and priority under 35 U.S.C. § 119(e) to U.S. Provisional Patent Application No. 63/366,391 entitled “Reversal of Blockchain Transactions” filed Jun. 14, 2022, U.S. Provisional Patent Application No. 63/232,728 entitled “Secure and Intelligent Decentralized Technology” filed Aug. 13, 2021, and U.S. Provisional Patent Application No. 63/216,662 entitled “Pseudo-Immutable Blockchain Method” filed Jun. 30, 2021, the disclosures of which are hereby incorporated by reference in their entireties for all purposes.

### FIELD OF THE INVENTION

This invention relates to cryptography. More particularly it relates to cryptographic systems for maintaining distributed ledgers.

### BACKGROUND OF THE INVENTION

Cryptography can be used to provide security, privacy and authenticity to transactions. Some cryptographic components, such as digital signatures and encryption functions, are standardized and well-studied with known security characteristics. Cryptography can be used to create immutable ledgers such as (but not limited to) blockchains. Immutable ledgers and blockchains can be based on a variety of cryptographic methods. In some implementations of immutable ledgers and blockchains, mining is used to securely add information. Mining can include computer systems (often referred to as “miners”) generating proofs based on computational challenges. Generally, a proof can be an output of a function that conforms to one or more requirements defined by a challenge. A proof protocol can be a function used to generate a proposed proof. The proof protocol can be iteratively performed until a proof is generated which meets the requirements of the challenge. The requirements of the challenge can be based on a difficulty. Mining can also include the use of computer systems known as “verifiers” that perform processes to check the generated proofs. In many instances, a proof can be easily verified based on providing successful inputs to a verifier. Miners and verifies can be implemented using any one or more of personal computers, application-specific integrated circuits, mobile devices (e.g. a mobile phone or tablet), server computer systems, virtual machines executing on computer systems, and/or any other form of computing device capable of performing computations associated with the performance of a particular mining or verifier function.

In a traditional blockchain based payment, a payer receives a public key from a payee and generates a digital signature on a message that includes the received public key. This enables the holder of the associated private key, namely the payee, to use the generated digital signature and the private key associated with the signed public key to spend money according to the same technique as the payer used to transfer funds to the payee. In traditional systems, a token (e.g. a fungible token) can be transferred to multiple payees (e.g. transfer ⅓ of token to a payee and ⅔ of a token to a second payee (e.g. the payer). Traditionally, non-fungible token, cannot be transferred in part, so there can only be one recipient.

### SUMMARY OF THE INVENTION

A device can be configured to close a ledger maintained by a cryptographic system. In an embodiment, the device includes a network interface, memory, and a processor. The processor configured to obtain a ledger entry associated with a distributed ledger. The ledger entry including an assertion authentication value and a reference. The processor further configured to request data based on the reference, to obtain an assertion when data is not available, to generate a result based on the assertion, to determine that the result and the assertion authentication value match, to compute a challenge using a cryptographic system when the result and the assertion authentication value match, wherein the challenge is based on the ledger entry, and to broadcast a block that incorporates the ledger entry to securely add the block to the distributed ledger. The block is capable of being validated by using a cryptographic system to obtain a proof based on the challenge.

In another embodiment, the processor is further configured to receive the block, and the proof can be obtained based on the block.

In a further embodiment, the proof is generated based on an iterative process.

In still another embodiment, the ledger entry further includes a reference.

In a still further embodiment, the processor is further configured to transmit a request for content data based on a reference.

In yet another embodiment, transmitting a request for content data based on a reference includes contacting a domain name service.

In a still yet further embodiment, obtaining an assertion includes receiving an assertion in response to a request for content data.

In still another additional embodiment, generating a result based on the assertion includes generating a hash of the assertion.

In a still further additional embodiment, the assertion authentication value is a hash of an assertion.

In still another embodiment again, the assertion includes a digital signature.

In yet another additional embodiment, the digital signature is associated with an entity storing content data.

In a yet further additional embodiment, determining that the result and the assertion authentication value match includes determining that the result and the assertion authentication value are equal.

A device can be configured to generate a ledger entry with a redactable payload. In an embodiment, the device includes a network interface, a memory, and a processor. The processor configured to generate a ledger entry. The ledger entry including a payload, an availability verifier value, and a redaction indicator. The redaction indicator is a preimage to the availability verifier value. The processor further configured to compute a challenge using a cryptographic system. The challenge is based on the ledger entry. The processor further configured to broadcast a block that incorporates the ledger entry to securely add the block to a distributed ledger. The block is capable of being validated by using a cryptographic system to obtain a proof based on the challenge.

In yet another embodiment again the processor is further configured to receive the block, and the proof is obtained based on the block.

In a yet further embodiment again, the proof is generated based on an iterative process.

In another additional embodiment again, wherein the payload is content data.

In a further additional embodiment again, wherein the payload is a reference to content data.

In still yet another additional embodiment, wherein the ledger entry further includes a redaction indicator.

In another embodiment, wherein a hash of the redaction indicator is equal to the availability verifier value.

In a further embodiment, wherein the availability verifier value is based on a Merkle tree.

In still another embodiment, wherein the availability verifier value is generated by iterated application of a one-way function to leaf values of a Merkle tree.

A device can be configured to transfer tokens to a holder of a private key associated with an entry. In an embodiment the device includes a network interface, memory, and a processor. The processor configured to obtain a winning number, obtain a plurality of lottery tickets, obtain a bounty hunter entry, the bounty hunter entry comprising a public key and evidence. The processor further configured to identify a winning lottery ticket, from among the plurality of lottery tickets, by determining both that the winning lottery ticket was generated based on the bounty hunter entry and that the winning lottery ticket and the winning number match. The processor further configured to generate a ledger entry associating tokens with the public key, compute a challenge using a cryptographic system. The challenge is based on the ledger entry. The processor further configured to broadcast a block that incorporates the ledger entry to securely add the block to a distributed ledger. The block is capable of being validated by using a cryptographic system to obtain a proof based on the challenge.

In a still further embodiment, the processor is further configured to receive the block; and the proof is obtained based on the block.

In yet another embodiment, the proof is generated based on an iterative process.

In a yet further embodiment, the winning number is determined based on a proof, the proof used to close a ledger.

In another additional embodiment, determining that the winning lottery ticket and the winning number match can be based on selecting a portion of the winning lottery ticket.

In a further additional embodiment, the evidence includes a solution to a problem.

In a further additional embodiment again, wherein the bounty hunter entry can include a forward link.

In still yet another embodiment, wherein the winning number is determined based on a portion of a proof, the proof used to close a ledger.

A device can be configured to enable transfers using an anonymity enhancing ledger entry structure. In an embodiment, the device includes a network interface, memory, and a processor. The processor configured to obtain a plurality of encrypted transferee public keys in a first order from a plurality of closed ledger entries. The plurality of closed ledger entries incorporated on a closed ledger, each closed ledger entry including an encrypted transferee public key, and a transferor digital signature. The processor further configured to reorder the plurality of encrypted transferee public keys to a second order, decrypt the plurality of encrypted transferee public keys, generate one or more new ledger entries transferring tokens to each of the plurality of decrypted transferee public keys. The one or more new ledger entries includes the plurality of decrypted transferee public keys in the second order. The processor further configured to compute a challenge using a cryptographic system. The challenge is based on the one or more new ledger entries. The processor further configured to broadcast a block that incorporates the one or more new ledger entries to securely add the block to a distributed ledger. The block is capable of being validated by using a cryptographic system to obtain a proof based on the challenge.

In a still yet further embodiment, the processor is further configured to receive the block; and the proof is obtained based on the block.

In still another additional embodiment, the proof is generated based on an iterative process.

In a still further additional embodiment, the transferee encrypted public key is encrypted based on a mix network public key.

In still another embodiment again, each encrypted transferee public key of the plurality of encrypted transferee public keys is associated with a transaction.

In a still further embodiment again, each transaction is identified as having a type.

In yet another additional embodiment, the processor is further configured to determine that a sufficient number of transactions identified a having a specific type have been added to an open ledger.

In yet another embodiment again, the plurality of encrypted transferee public keys are randomly reordered.

In a yet further embodiment again, the processor is further configured to receive a plurality of ledger entries, each ledger entry comprising an encrypted transferee public key.

In another additional embodiment again, the processor is further configured to receive a plurality of ledger entries, each ledger entry comprising an encrypted transferee public key, and a transferor digital signature.

A device can be configured to reverse a transaction recorded on a distributed ledger maintained by a cryptographic system. In an embodiment, the device including a network interface, memory, and a processor. The processor configured to obtain a petition for reversal of a transaction. The transaction incorporated into a distributed ledger. The processor further configured to obtain one or more votes from one or more trusted entities, generate a ledger entry reversing the transaction based on the obtained one or more votes, compute a challenge using a cryptographic system. The challenge is based on the ledger entry. The processor further configured to broadcast a block incorporating the ledger entry to securely add the block to the distributed ledger. The block is capable of being validated by using a cryptographic system to obtain a proof based on the challenge.

In another embodiment, the processor is further configured to receive the block; and the proof is obtained based on the block.

In a further embodiment, the proof is generated based on an iterative process.

In a still further embodiment, the petition includes a transaction Id, a sending address and a receiving address.

In yet another embodiment, the one or more trusted entities are registered on a ledger.

In a yet further embodiment, the processor is further configured to register a list of trusted entities.

In another additional embodiment, the one or more trusted entities are one or more trusted stakers.

In a further additional embodiment, the processor is further configured to notify the one or more trusted entities.

In another embodiment again, notifying the one or more trusted entities includes using a blockchain monitoring component.

In a further embodiment again, the blockchain monitoring component regularly queries a smart contract for any votes in progress.

In still yet another embodiment, notifying the one or more trusted entities includes sending a message to the one or more trusted entities.

In a still yet further embodiment, the one or more votes are recorded on the distributed ledger.

In still another additional embodiment, the one or more votes are received from one or more trusted entities.

In a still further additional embodiment, the transaction is reversed based on a tally of the one or more votes.

In still another embodiment again, a tally of the one or more votes is determined after all trusted entities have voted.

In a still further embodiment again, a tally of the one or more votes is determined after a specified period of time has passed.

In yet another additional embodiment, reversing the transaction includes rewriting a record of ownership of one or more tokens in the distributed ledger.

In yet another embodiment again, reversing the transaction includes rewriting a record of ownership of one or more tokens in the distributed ledger to match an original record of ownership.

In a yet further embodiment again, reversing the transaction includes submitting an inverse transaction, the inverse transaction configured to undo changes associated with the transaction.

In a further additional embodiment again, the processor if further configured to generate a reward transaction, the reward transaction transferring tokens to an entity that submitted the petition.

In still yet another additional embodiment, the petition includes a transfer of tokens.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 is a conceptual diagram of an NFT platform in accordance with an embodiment of the invention.

FIG. 2 is a network architecture diagram of an NFT platform in accordance with an embodiment of the invention.

FIG. 3 is a conceptual diagram of a permissioned blockchain in accordance with an embodiment of the invention.

FIG. 4 is a conceptual diagram of a permissionless blockchain in accordance with an embodiment of the invention.

FIGS. 5A-5B are diagrams of a dual blockchain in accordance with a number of embodiments of the invention.

FIG. 6 conceptually illustrates a process followed by a Proof of Work consensus mechanism in accordance with an embodiment of the invention.

FIG. 7 conceptually illustrates a process followed by a Proof of Space consensus mechanism in accordance with an embodiment of the invention.

FIG. 8 illustrates a dual proof consensus mechanism configuration in accordance with an embodiment of the invention.

FIG. 9 illustrates a process followed by a Trusted Execution Environment-based consensus mechanism in accordance with some embodiments of the invention

FIGS. 10-12 depicts various devices that can be utilized alongside an NFT platform in accordance with various embodiments of the invention.

FIG. 13 depicts a media wallet application configuration in accordance with an embodiment of the invention.

FIGS. 14A-14C depicts user interfaces of various media wallet applications in accordance with a number of embodiments of the invention.

FIG. 15 illustrates an NFT ledger entry corresponding to an NFT identifier.

FIGS. 16A-16B illustrate an NFT arrangement relationship with corresponding physical content in accordance with an embodiment of the invention.

FIG. 17 illustrates a process for establishing a relationship between an NFT and corresponding physical content.

FIG. 18 conceptually illustrates an example process for validating a ledger with unavailable content.

FIG. 19 illustrates an example of a ledger entry configured to allow redacting a payload associated with a ledger entry.

FIG. 20 conceptually illustrates an example of a process for generating an availability verifier value with an incorporation of a Merkle tree.

FIG. 21 conceptually illustrates an example process for generating leaf values based on a seed incorporated in a ledger entry.

FIG. 22 illustrates an example anonymity enhancing ledger entry.

FIG. 23 conceptually illustrates an example process for using a mix network to decrypt an encrypted transferee public key.

FIG. 24 conceptually illustrates an example process for distributing probabilistically aggregated rewards to bounty hunters.

FIG. 25 conceptually illustrates an example process for updating an asset using artificial intelligence or machine learning, such as an animated character personality.

FIG. 26 illustrates an example of an AI classifier.

FIG. 27 conceptually illustrates an example process for using an artificial intelligence or machine learning entity to adjust security requirements based on a shift in security posture.

FIG. 28 conceptually illustrates an example process for requesting an off-chain resource.

FIG. 29 conceptually illustrates an example of a process for computing a function computed with a first step computed in secure nodes and a second step computed and/or stored using a consensus mechanism.

FIG. 30 conceptually illustrates an example process for accessing content data using a decryption key.

FIG. 31 conceptually illustrates an example process for performing a requested action.

FIG. 32 conceptually illustrates an example of accessing decentralized storage and processing.

FIG. 33 conceptually illustrates an example system including a bounty hunter for monitoring decentralized processing and storage systems.

FIG. 34 conceptually illustrates an example process reversing a transaction based on a vote.

FIG. 35 illustrates an example smart contract for implementing a process for reversing a transaction based on a vote.

FIG. 36 conceptually illustrates an example process for transaction confirmation.

FIG. 37 conceptually illustrates an example of a process for a controlled transfer of a digital asset for value.

FIG. 38 conceptually illustrates an example process for reverting a previous transfer of ownership.

FIG. 39 illustrates an example of an escrow authority.

FIG. 40 conceptually illustrates a process for two entities exchanging digital assets.

### DETAILED DESCRIPTION

The ability to write illegal information or rights holder information into an immutable public ledger is problematic for society. For instance, the ability to write an MP3, image, video, corporate trade secret, or confidential information into a public record without the ability to remove it creates problems for artists, corporations, governments, society (e.g., child pornography, revenge porn), etc. Similarly, the inability to selectively cause funds transfers to be undone currently gives rise to significant abuses, such as crypto heists in which the entire content of exchanges are stolen; blackmail, extortion and related attacks.

In several embodiments, methods can allow for selective modification of content from ledgers. The ledger can still be capable of verification after the removal of content. Modification can be by removal, correction, and/or other markups. In many embodiments, modifications can only be performed by select entities. Select entities can include (but are not limited to) national governments, certified authorities, and/or other entities. In certain embodiments, the existence of a modification event having taken place can be publicly detectable. This can prevent abuse in which time-stamped ledger entries are modified without the occurrence of the modification being possible to detect. The ability to remove or modify content on a ledger can be beneficial when illegal content is posted.

On many blockchains it is costly, bordering infeasible at times, to track transfers that are made with the intention of obfuscating the source or destination. Accordingly, criminals commonly perform a series of transfers to conceal their activities. They can maintain movement of tokens by constantly transferring tokens to new wallets, corresponding to new public keys thereby evading detection this way. In order to address such problems, problems in accordance with several embodiments of the invention can associate forward links with all or a large number of tokens that have been used. In various embodiments, the effort of associating the forward can be borne by bounty hunters that verify the transfer (e.g., as they process a ledger entry for other reasons). The reporting in accordance with numerous embodiments of the invention can be made by the transferor, to which the backwards reference is immediately known.

In some blockchains, ledger entries can be anonymity stripping for transactions to and from known addresses. In various embodiments, this problem can be addressed by anonymity enhancing ledger entry structures associated with a cryptographic system. Anonymity enhancing ledger entry structures can include encrypted transferee public keys. Methods for protecting the privacy of honest users, while not protecting criminals are described herein. In several embodiments, these results can be achieved using a quorum of privacy protecting entities.

In several embodiments, bounty hunters can perform tasks and receive rewards. In some embodiments, rewards can be probabilistically aggregated. Probabilistic aggregation of rewards can reduce transaction costs for small payments since the payment are aggregated. Probabilistic aggregation can be fair over a large number of rewards.

Today's consensus-driven cryptographic systems are static systems whose code only changes as new standards are deployed. This manual, and extremely slow, evolution is a significant shortcoming of existing distributed systems, and threatens the survival of such systems by its inability to address rapidly evolving threats in an automated manner.

Automated changes to consensus-drive cryptographic systems can enable dynamic responses to threats. In several embodiments, decentralized storage and processing can be accessed through a token. The token can include references to resources. In several embodiments, a cryptographic system can have configuration parameters controlled by processes utilizing artificial intelligence and/or machine learning. These systems and/or processes can improve the security, efficiency and/or functionality of a cryptographic system.

Another shortcoming of the prior art is the absence of immutability mechanisms for the storage of rich media associated with a blockchain. To immutably store rich media using blockchain, a reference (or multiple references) for the asset, such as a URL, can be stored in the blockchain. When accessed, the URL can be resolved to an IP address. Data can be received from a server. The data can be stored on decentralized storage to improve the availability and immutability of the data.

Content owners can desire to selectively distribute content to end-users, such as peers, collaborators, fans, and/or influencers, but while retaining control over how such entities redistribute the content. This need can be addressed in the context of rich media associated with a blockchain. In various embodiments, DRM policies are associated with content containers. Content containers can be encrypted using a symmetric key that is known by or can be acquired by a DRM-enabled computational entity, such as a computer equipped with an Intel Trusted Execution Technology, or an Apple DRM enabled device. In a number of embodiments, content containers can contain a DRM policy or be associated with it. The DRM policy can identify the conditions under which data is allowed to be extracted from the content container, and optionally enable access to decryption keys.

In several embodiments, decentralized storage on the blockchain is improved. Providing an incentive to store data can be insufficient to assure the immutability of the data, as an entity that has promised to store data can fail to do so, whether intentionally (e.g., selling space that does not exist) or accidentally (e.g., suffering a hard drive crash). A combination of incentives and penalties can increase the resilience of the data. Intentional erasure can be subjected to penalties. To prevent loss of data, replication can be used.

In some embodiments, replication can mean to create multiple copies of each data item. However, that is a very coarse-grained approach that does not permit gradual increases of assurance. In some embodiments, error-correction can be performed on a file or on a series of segments of a file. In this way, a file can be expanded to various extents, where a greater degree of error correction will correspond directly to a greater degree of expansion of the file or file segment. Such error-corrected files or file segments can then be broken into parts and distributed to multiple entities.

A persistent problem in the blockchain space is the wrongful transfer or theft of digital assets, compounded by the irreversibility of transactions perpetrating such transfers. Blockchains currently require users to carefully guard the private keys of their public blockchain addresses against which their ownership of digital assets are recorded. Users must be careful not to sign transactions that either transfer their assets to the wrong destination, or provide a potentially malicious party with an authorization to transfer their assets.

In several embodiments, methods and techniques enable the reversal of transactions on a blockchain. The methods can implement smart contracts to perform the reversals. Traditionally, no method exists for reversing blockchain transactions.

Reversals can be useful in various scenarios, such as (but not limited to) undoing accidental transfer, for undoing fraudulent transfers, for undoing spam transfers (e.g., advertising airdrop of NFT), etc. In some embodiments, a transaction written to a blockchain can be undone based on a vote of trusted entities. In some embodiments, a transaction can be sent to an escrow authority. The escrow authority can hold the transaction for some time before completing the transaction. During the hold time the transaction can be reversible by the escrow authority.

### Non-Fungible Token (NFT) Platforms

Turning now to the drawings, systems and methods for implementing blockchain-based Non-Fungible Token (NFT) platforms in accordance with various embodiments of the invention are illustrated. In several embodiments, blockchain-based NFT platforms are platforms which enable content creators to issue, mint, and transfer Non-Fungible Tokens (NFTs) directed to content including, but not limited to, rich media content.

In a number of embodiments, content creators can issue NFTs to users within the NFT platform. NFTs can be created around a large range of real-world media content and intellectual property. Movie studios can mint digital collectibles for their movies, characters, notable scenes and/or notable objects. Record labels can mint digital collectibles for artists, bands, albums and/or songs. Similarly, official digital trading cards can be made from likeness of celebrities, cartoon characters and/or gaming avatars.

NFTs minted using NFT platforms in accordance with various embodiments of the invention can have multifunctional programmable use cases including rewards, private access to premium content and experiences, as discounts toward the purchase of goods, among many other value-added use cases.

In many embodiments, each NFT can have a set of attributes that define its unique properties. NFTs may therefore be classified based on which attributes are emphasized. Possible classifications may address, but are not limited to: NFTs as identifying entities, NFTs output by other NFTs, NFTs as content creation assets, and NFTs as evaluating entities. NFTs can be interpreted differently by various platforms in order to create platform-specific user experiences. The metadata associated with an NFT may also include digital media assets such as (but not limited to) images, videos about the specific NFT, and the context in which it was created (studio, film, band, company song etc.).

In many embodiments, NFT storage may be facilitated through mechanisms for the transfer of payment from users to one or more service providers. Through these mechanisms, a payment system for NFT maintenance can allow for incremental payment and ongoing asset protection. NFT storage may be additionally self-regulated through willing participants disclosing unsatisfactory NFT management in exchange for rewards.

In many embodiments, the NFT platform can include media wallet applications that enable users to securely store NFTs and/or other tokens on their devices. Furthermore, media wallets (also referred to as “digital wallets”) can enable users to obtain NFTs that prove purchase of rights to access a particular piece of media content on one platform and use the NFT to gain access to the purchased content on another platform. The consumption of such content may be governed by content classification directed to visual user interface systems.

In several embodiments, users can download and install media wallet applications to store NFTs on the same computing devices used to consume streamed and/or downloaded content. Media wallet applications and NFTs can disseminate data concerning media consumption on the computing devices on which the media wallet applications are installed and/or based upon observations indicative of media consumption independently of the device. Media consumption data may include, but is not limited to, data reporting the occurrence of NFT transactions, data reporting the occurrence of NFT event interactions data reporting the content of NFT transactions, data reporting the content of media wallet interactions, and/or data reporting the occurrence of media wallet interactions.

While various aspects of NFT platforms, NFTs, media wallets, blockchain configurations, reporting structures, and maintenance systems are discussed above, NFT platforms and different components that can be utilized within NFT platforms in accordance with various embodiments of the invention are discussed further below.

### NFT Platforms

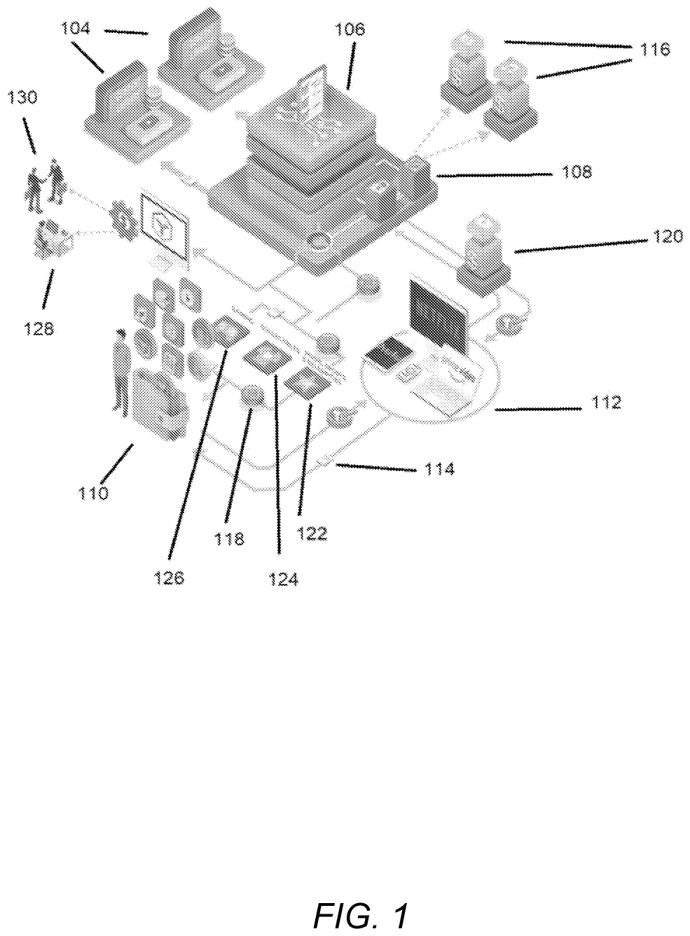

An NFT platform in accordance with an embodiment of the invention is illustrated in FIG. 1. The NFT platform 100 utilizes one or more immutable ledgers (e.g. one or more blockchains) to enable a number of verified content creators 104 to access an NFT registry service to mint NFTs 106 in a variety of forms including (but not limited to) celebrity NFTs 122, character NFTs from games 126, NFTs that are redeemable within games 126, NFTs that contain and/or enable access to collectibles 124, and NFTs that have evolutionary capabilities representative of the change from one NFT state to another NFT state.

Issuance of NFTs 106 via the NFT platform 100 enables verification of the authenticity of NFTs independently of the content creator 104 by confirming that transactions written to one or more of the immutable ledgers are consistent with the smart contracts 108 underlying the NFTs.

As is discussed further below, content creators 104 can provide the NFTs 106 to users to reward and/or incentivize engagement with particular pieces of content and/or other user behavior including (but not limited to) the sharing of user personal information (e.g. contact information or user ID information on particular services), demographic information, and/or media consumption data with the content creator and/or other entities. In addition, the smart contracts 108 underlying the NFTs can cause payments of residual royalties 116 when users engage in specific transactions involving NFTs (e.g. transfer of ownership of the NFT).

In a number of embodiments, users utilize media wallet applications 110 on their devices to store NFTs 106 distributed using the NFT platform 100. Users can use media wallet applications 110 to obtain and/or transfer NFTs 106. In facilitating the retention or transfer of NFTs 106, media wallet applications may utilize wallet user interfaces that engage in transactional restrictions through either uniform or personalized settings. Media wallet applications 110 in accordance with some embodiments may incorporate NFT filtering systems to avoid unrequested NFT assignment. Methods for increased wallet privacy may also operate through multiple associated wallets with varying capabilities. As can readily be appreciated, NFTs 106 that are implemented using smart contracts 108 having interfaces that comply with open standards are not limited to being stored within media wallets and can be stored in any of a variety of wallet applications as appropriate to the requirements of a given application. Furthermore, a number of embodiments of the invention support movement of NFTs 106 between different immutable ledgers. Processes for moving NFTs between multiple immutable ledgers in accordance with various embodiments of the invention are discussed further below.

In several embodiments, content creators 104 can incentivize users to grant access to media consumption data using offers including (but not limited to) offers of fungible tokens 118 and/or NFTs 106. In this way, the ability of the content creators to mint NFTs enables consumers to engage directly with the content creators and can be utilized to incentivize users to share with content creators' data concerning user interactions with additional content. The permissions granted by individual users may enable the content creators 104 to directly access data written to an immutable ledger. In many embodiments, the permissions granted by individual users enable authorized computing systems to access data within an immutable ledger and content creators 104 can query the authorized computing systems to obtain aggregated information. Numerous other example functions for content creators 104 are possible, some of which are discussed below.

NFT blockchains in accordance with various embodiments of the invention enable issuance of NFTs by verified users. In many embodiments, the verified users can be content creators that are vetted by an administrator of networks that may be responsible for deploying and maintaining the NFT blockchain. Once the NFTs are minted, users can obtain and conduct transactions with the NFTs. In several embodiments, the NFTs may be redeemable for items or services in the real world such as (but not limited to) admission to movie screenings, concerts, and/or merchandise.

As illustrated in FIG. 1, users can install the media wallet application 110 onto their devices and use the media wallet application 110 to purchase fungible tokens. The media wallet application could also be provided by a browser, or by a dedicated hardware unit executing instructions provided by a wallet manufacturer. The different types of wallets may have slightly different security profiles and may offer different features, but would all be able to be used to initiate the change of ownership of tokens, such as NFTs. In many embodiments, the fungible tokens can be fully converted into fiat currency and/or other cryptocurrency. In several embodiments, the fungible tokens are implemented using split blockchain models in which the fungible tokens can be issued to multiple blockchains (e.g. Ethereum). As can readily be appreciated, the fungible tokens and/or NFTs utilized within an NFT platform in accordance with various embodiments of the invention are largely dependent upon the requirements of a given application.

In several embodiments, the media wallet application is capable of accessing multiple blockchains by deriving accounts from each of the various immutable ledgers used within an NFT platform. For each of these blockchains, the media wallet application can automatically provide simplified views whereby fungible tokens and NFTs across multiple accounts and/or multiple blockchains can be rendered as single user profiles and/or wallets. In many embodiments, the single view can be achieved using deep-indexing of the relevant blockchains and API services that can rapidly provide information to media wallet applications in response to user interactions. In certain embodiments, the accounts across the multiple blockchains can be derived using BIP32 deterministic wallet key. In other embodiments, any of a variety of techniques can be utilized by the media wallet application to access one or more immutable ledgers as appropriate to the requirements of a given application.

NFTs can be purchased by way of exchanges 130 and/or from other users. In addition, content creators can directly issue NFTs to the media wallets of specific users (e.g. by way of push download or AirDrop). In many embodiments, the NFTs are digital collectibles such as celebrity NFTs 122, character NFTs from games 126, NFTs that are redeemable within games 126, and/or NFTs that contain and/or enable access to collectibles 124. It should be appreciated that a variety of NFTs are described throughout the discussion of the various embodiments described herein and can be utilized in any NFT platform and/or with any media wallet application.

While the NFTs are shown as static in the illustrated embodiment, content creators can utilize users' ownership of NFTs to engage in additional interactions with the user. In this way, the relationship between users and particular pieces of content and/or particular content creators can evolve over time around interactions driven by NFTs. In a number of embodiments, collection of NFTs can be gamified to enable unlocking of additional NFTs. In addition, leaderboards can be established with respect to particular content and/or franchises based upon users' aggregation of NFTs. As is discussed further below, NFTs and/or fungible tokens can also be utilized by content creators to incentivize users to share data.

NFTs minted in accordance with several embodiments of the invention may incorporate a series of instances of digital content elements in order to represent the evolution of the digital content over time. Each one of these digital elements can have multiple numbered copies, just like a lithograph, and each such version can have a serial number associated with it, and/or digital signatures authenticating its validity. The digital signature can associate the corresponding image to an identity, such as the identity of the artist. The evolution of digital content may correspond to the transition from one representation to another representation. This evolution may be triggered by the artist, by an event associated with the owner of the artwork, by an external event measured by platforms associated with the content, and/or by specific combinations or sequences of event triggers. Some such NFTs may also have corresponding series of physical embodiments. These may be physical and numbered images that are identical to the digital instances described above. They may also be physical representations of another type, e.g., clay figures or statues, whereas the digital representations may be drawings. The physical embodiments may further be of different aspects that relate to the digital series. Evolution in compliance with some embodiments may also be used to spawn additional content, for example, one NFT directly creating one or more secondary NFTs.

When the user wishes to purchase an NFT using fungible tokens, media wallet applications can request authentication of the NFT directly based upon the public key of the content creator and/or indirectly based upon transaction records within the NFT blockchain. As discussed above, minted NFTs can be signed by content creators and administrators of the NFT blockchain. In addition, users can verify the authenticity of particular NFTs without the assistance of entities that minted the NFT by verifying that the transaction records involving the NFT within the NFT blockchain are consistent with the various royalty payment transactions required to occur in conjunction with transfer of ownership of the NFT by the smart contract underlying the NFT.

Applications and methods in accordance with various embodiments of the invention are not limited to media wallet applications or use within NFT platforms. Accordingly, it should be appreciated that the data collection capabilities of any media wallet application described herein can also be implemented outside the context of an NFT platform and/or in a dedicated application and/or in an application unrelated to the storage of fungible tokens and/or NFTs. Various systems and methods for implementing NFT platforms and media wallet applications in accordance with various embodiments of the invention are discussed further below.

### NFT Platform Network Architectures

NFT platforms in accordance with many embodiments of the invention utilize public blockchains and permissioned blockchains. In several embodiments, the public blockchain is decentralized and universally accessible. Additionally, in a number of embodiments, private/permissioned blockchains are closed systems that are limited to publicly inaccessible transactions. In many embodiments, the permissioned blockchain can be in the form of distributed ledgers, while the blockchain may alternatively be centralized in a single entity.

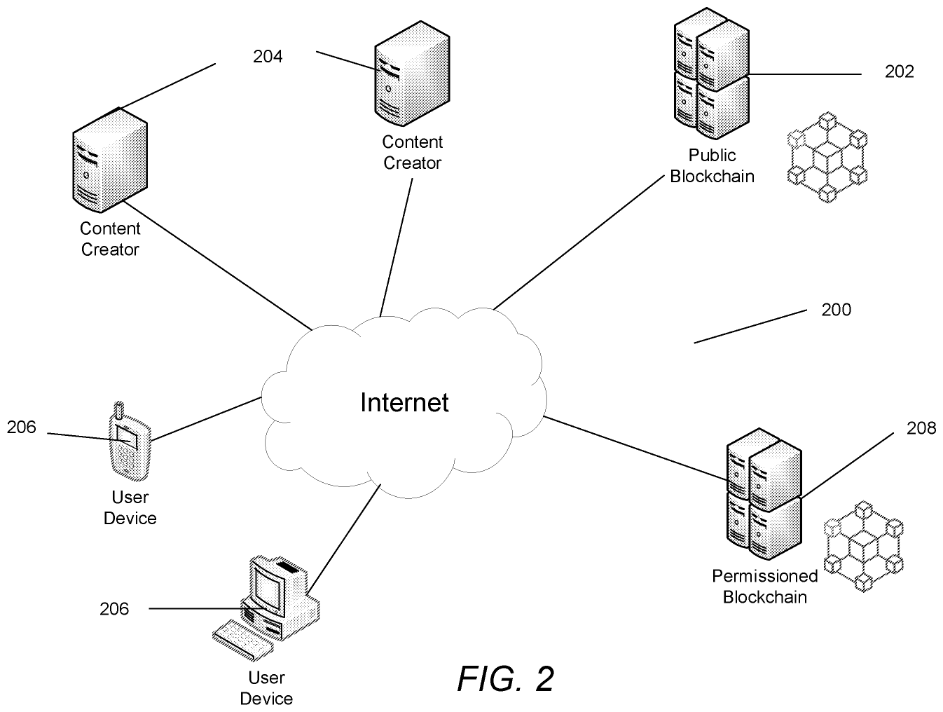

An example of network architecture that can be utilized to implement an NFT platform including a public blockchain and a permissioned blockchain in accordance with several embodiments of the invention is illustrated in FIG. 2. The NFT platform 200 utilizes computer systems implementing a public blockchain 202 such as (but not limited to) Ethereum and Solana. A benefit of supporting interactions with public blockchains 202 is that the NFT platform 200 can support minting of standards based NFTs that can be utilized in an interchangeable manner with NFTs minted by sources outside of the NFT platform on the public blockchain. In this way, the NFT platform 200 and the NFTs minted within the NFT platform are not part of a walled garden, but are instead part of a broader blockchain-based ecosystem. The ability of holders of NFTs minted within the NFT platform 200 to transact via the public blockchain 202 increases the likelihood that individuals acquiring NFTs will become users of the NFT platform. Initial NFTs minted outside the NFT platform can also be developed through later minted NFTs, with the initial NFTs being used to further identify and interact with the user based upon their ownership of both NFTs. Various systems and methods for facilitating the relationships between NFTs, both outside and within the NFT platform are discussed further below.

Users can utilize user devices configured with appropriate applications including (but not limited to) media wallet applications to obtain NFTs. In many embodiments, media wallets are smart device enabled, front-end applications for fans and/or consumers, central to all user activity on an NFT platform. As is discussed in detail below, different embodiments of media wallet applications can provide any of a variety of functionality that can be determined as appropriate to the requirements of a given application. In the illustrated embodiment, the user devices 206 are shown as mobile phones and personal computers. As can readily be appreciated user devices can be implemented using any class of consumer electronics device including (but not limited to) tablet computers, laptop computers, televisions, game consoles, virtual reality headsets, mixed reality headsets, augmented reality headsets, media extenders, and/or set top boxes as appropriate to the requirements of a given application.

In many embodiments, NFT transaction data entries in the permissioned blockchain 208 are encrypted using users' public keys so that the NFT transaction data can be accessed by the media wallet application. In this way, users control access to entries in the permissioned blockchain 208 describing the user's NFT transaction. In several embodiments, users can authorize content creators 204 to access NFT transaction data recorded within the permissioned blockchain 208 using one of a number of appropriate mechanisms including (but not limited to) compound identities where the user is the owner of the data and the user can authorize other entities as guests that can also access the data. As can readily be appreciated, particular content creators' access to the data can be revoked by revoking their status as guests within the compound entity authorized to access the NFT transaction data within the permissioned blockchain 208. In certain embodiments, compound identities are implemented by writing authorized access records to the permissioned blockchain using the user's public key and the public keys of the other members of the compound entity.

When content creators wish to access particular pieces of data stored within the permissioned blockchain 208, they can make a request to a data access service. The data access service may grant access to data stored using the permissioned blockchain 208 when the content creators' public keys correspond to public keys of guests. In a number of embodiments, guests may be defined within a compound identity. The access record for the compound entity may also authorize the compound entity to access the particular piece of data. In this way, the user has complete control over access to their data at any time by admitting or revoking content creators to a compound entity, and/or modifying the access policies defined within the permissioned blockchain 208 for the compound entity. In several embodiments, the permissioned blockchain 208 supports access control lists and users can utilize a media wallet application to modify permissions granted by way of the access control list. In many embodiments, the manner in which access permissions are defined enables different restrictions to be placed on particular pieces of information within a particular NFT transaction data record within the permissioned blockchain 208. As can readily be appreciated, the manner in which NFT platforms and/or immutable ledgers provide fine-grained data access permissions largely depends upon the requirements of a given application.

In many embodiments, storage nodes within the permissioned blockchain 208 do not provide content creators with access to entire NFT transaction histories. Instead, the storage nodes simply provide access to encrypted records. In several embodiments, the hash of the collection of records from the permissioned blockchain is broadcast. Therefore, the record is verifiably immutable and each result includes the hash of the record and the previous/next hashes. As noted above, the use of compound identities and/or access control lists can enable users to grant permission to decrypt certain pieces of information or individual records within the permissioned blockchain. In several embodiments, the access to the data is determined by computer systems that implement permission-based data access services.

In many embodiments, the permissioned blockchain 208 can be implemented using any blockchain technology appropriate to the requirements of a given application. As noted above, the information and processes described herein are not limited to data written to permissioned blockchains 208, and NFT transaction data simply provides an example. Systems and methods in accordance with various embodiments of the invention can be utilized to enable applications to provide fine-grained permission to any of a variety of different types of data stored in an immutable ledger as appropriate to the requirements of a given application in accordance with various embodiments of the invention.

While various implementations of NFT platforms are described above with reference to FIG. 2, NFT platforms can be implemented using any number of immutable and pseudo-immutable ledgers as appropriate to the requirements of specific applications in accordance with various embodiments of the invention. Blockchain databases in accordance with various embodiments of the invention may be managed autonomously using peer-to-peer networks and distributed timestamping servers. In some embodiments, any of a variety of consensus mechanisms may be used by public blockchains, including but not limited to Proof of Space mechanisms, Proof of Work mechanisms, Proof of Stake mechanisms, and hybrid mechanisms.

NFT platforms in accordance with many embodiments of the invention may benefit from the oversight and increased security of private blockchains. As can readily be appreciated, a variety of approaches can be taken to the writing of data to permissioned blockchains and the particular approach is largely determined by the requirements of particular applications. As such, computer systems in accordance with various embodiments of the invention can have the capacity to create verified NFT entries written to permissioned blockchains.

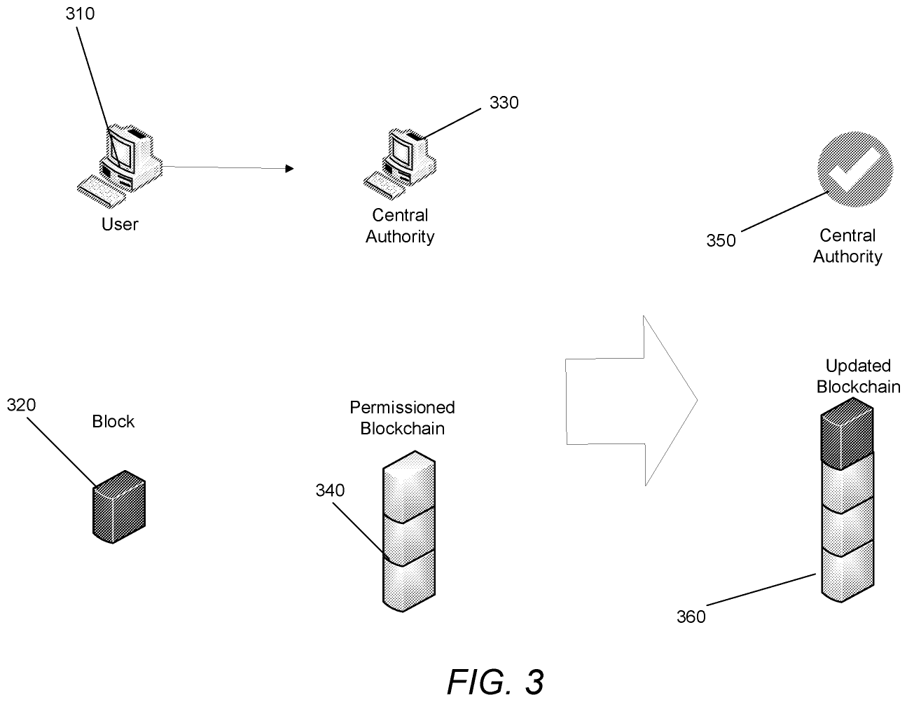

An implementation of permissioned (or private) blockchains in accordance with some embodiments of the invention is illustrated in FIG. 3. Permissioned blockchains 340 can typically function as closed computing systems in which each participant is well defined. In several embodiments, private blockchain networks may require invitations. In a number of embodiments, entries, or blocks 320, to private blockchains can be validated. In some embodiments, the validation may come from central authorities 330. Private blockchains can allow an organization or a consortium of organizations to efficiently exchange information and record transactions. Specifically, in a permissioned blockchain, a preapproved central authority 330 (which should be understood as potentially encompassing multiple distinct authorized authorities) can approve a change to the blockchain. In a number of embodiments, approval may come without the use of a consensus mechanism involving multiple authorities. As such, through a direct request from users 310 to the central authority 330, the determination of whether blocks 320 can be allowed access to the permissioned blockchain 340 can be determined. Blocks 320 needing to be added, eliminated, relocated, and/or prevented from access may be controlled through these means. In doing so the central authority 330 may manage accessing and controlling the network blocks incorporated into the permissioned blockchain 340. Upon the approval 350 of the central authority, the now updated blockchain 360 can reflect the added block 320.

NFT platforms in accordance with many embodiments of the invention may also benefit from the anonymity and accessibility of a public blockchain. Therefore, NFT platforms in accordance with many embodiments of the invention can have the capacity to create verified NFT entries written to a permissioned blockchain.

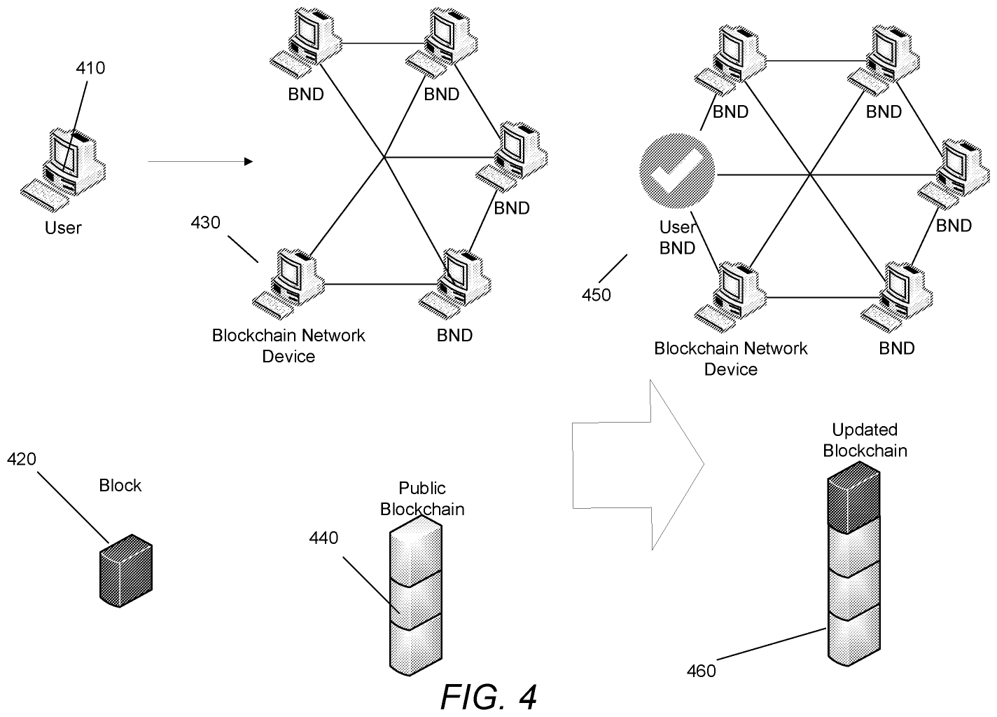

An implementation of a permissionless, decentralized, or public blockchain in accordance with an embodiment of the invention is illustrated in FIG. 4. In a permissionless blockchain, individual users 410 can directly participate in relevant networks and operate as blockchain network devices 430. As blockchain network devices 430, parties would have the capacity to participate in changes to the blockchain and participate in transaction verifications (via the mining mechanism). Transactions are broadcast over the computer network and data quality is maintained by massive database replication and computational trust. Despite being decentralized, an updated blockchain 460 cannot remove entries, even if anonymously made, making it immutable. In many decentralized blockchains, many blockchain network devices 430, in the decentralized system may have copies of the blockchain, allowing the ability to validate transactions. In many instances, the blockchain network device 430 can personally add transactions, in the form of blocks 420 appended to the public blockchain 440. To do so, the blockchain network device 430 would take steps to allow for the transactions to be validated 450 through various consensus mechanisms (Proof of Work, Proof of Stake, etc.). A number of consensus mechanisms in accordance with various embodiments of the invention are discussed further below.

Additionally, in the context of blockchain configurations, the term smart contract is often used to refer to software programs that run on blockchains. While a standard legal contract outlines the terms of a relationship (usually one enforceable by law), a smart contract enforces a set of rules using self-executing code within NFT platforms. As such, smart contracts may have the means to automatically enforce specific programmatic rules through platforms. Smart contracts are often developed as high-level programming abstractions that can be compiled down to bytecode. Said bytecode may be deployed to blockchains for execution by computer systems using any number of mechanisms deployed in conjunction with the blockchain. In many instances, smart contracts execute by leveraging the code of other smart contracts in a manner similar to calling upon a software library.

A number of existing decentralized blockchain technologies intentionally exclude or prevent rich media assets from existing within the blockchain, because they would need to address content that is not static (e.g., images, videos, music files). Therefore, NFT platforms in accordance with many embodiments of the invention may address this with blockchain mechanisms, that preclude general changes but account for updated content.

NFT platforms in accordance with many embodiments of the invention can therefore incorporate decentralized storage pseudo-immutable dual blockchains. In some embodiments, two or more blockchains may be interconnected such that traditional blockchain consensus algorithms support a first blockchain serving as an index to a second, or more, blockchains serving to contain and protect resources, such as the rich media content associated with NFTs.

In storing rich media using blockchain, several components may be utilized by an entity (“miner”) adding transactions to said blockchain. References, such as URLs, may be stored in the blockchain to identify assets. Multiple URLs may also be stored when the asset is separated into pieces. An alternative or complementary option may be the use of APIs to return either the asset or a URL for the asset. In accordance with many embodiments of the invention, references can be stored by adding a ledger entry incorporating the reference enabling the entry to be timestamped. In doing so, the URL, which typically accounts for domain names, can be resolved to IP addresses. However, when only files of certain types are located on particular resources, or where small portions of individual assets are stored at different locations, users may require methods to locate assets stored on highly-splintered decentralized storage systems. To do so, systems may identify at least primary asset destinations and update those primary asset destinations as necessary when storage resources change. The mechanisms used to identify primary asset destinations may take a variety of forms including, but not limited to, smart contracts.

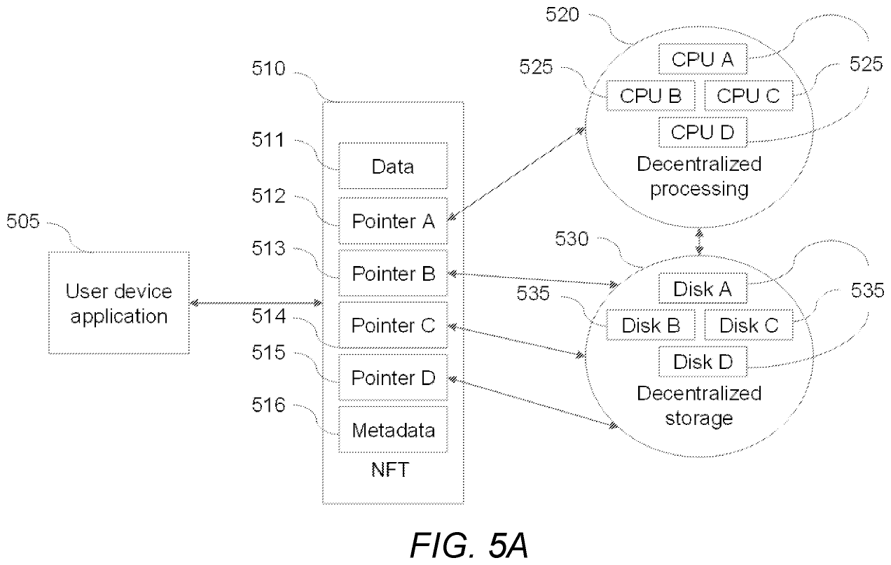

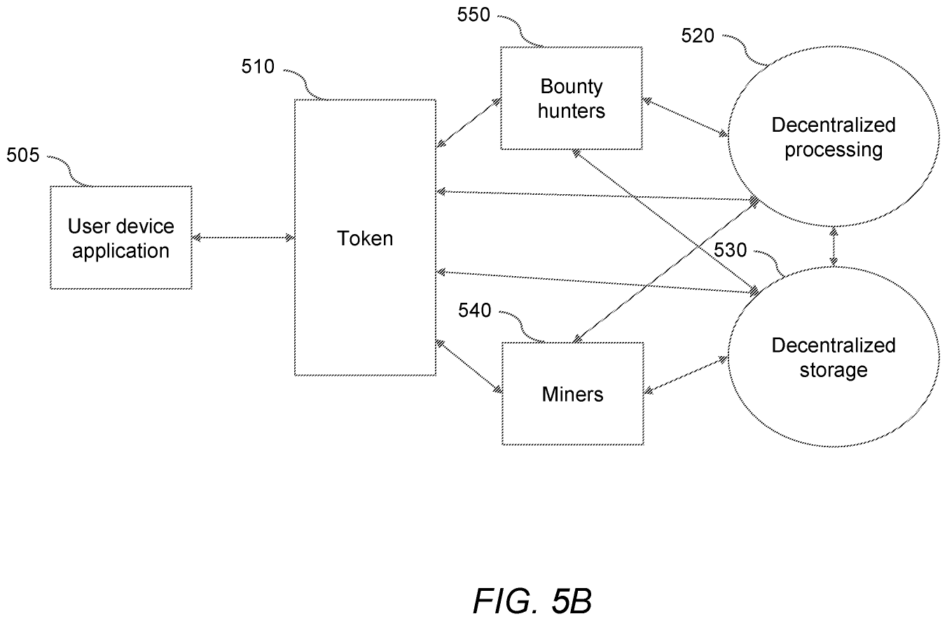

A dual blockchain, including decentralized processing 520 and decentralized storage 530 blockchains, in accordance with some embodiments of the invention is illustrated in FIG. 5A. Application running on devices 505, may interact with or make a request related to NFTs 510 interacting with such a blockchain. An NFT 510 in accordance with several embodiments of the invention may include many values including generalized data 511 (e.g. URLs), and pointers such as pointer A 512, pointer B 513, pointer C 514, and pointer D 515. In accordance with many embodiments of the invention, the generalized data 511 may be used to access corresponding rich media through the NFT 510. The NFT 510 may additionally have associated metadata 516.

Pointers within the NFT 510 may direct an inquiry toward a variety of on or off-ledger resources. In some embodiments of the invention, as illustrated FIG. 5A, pointer A 512 can direct the need for processing to the decentralized processing network 520. Processing systems are illustrated as CPU A, CPU B, CPU C, and CPU D 525. The CPUs 525 may be personal computers, server computers, mobile devices, edge IoT devices, etc. Pointer A may select one or more processors at random to perform the execution of a given smart contract. The code may be secure or nonsecure and the CPU may be a trusted execution environment (TEE), depending upon the needs of the request. In the example reflected in FIG. 5A, pointer B 513, pointer C 514, and pointer D 515 all point to a decentralized storage network 530 including remote off-ledger resources including storage systems illustrated as Disks A, B, C, and D 535.

The decentralized storage system may co-mingle with the decentralized processing system as the individual storage systems utilize CPU resources and connectivity to perform their function. From a functional perspective, the two decentralized systems may also be separate. Pointer B 513 may point to one or more decentralized storage networks 530 for the purposes of maintaining an off-chain log file of token activity and requests. Pointer C 514 may point to executable code within one or more decentralized storage networks 530. And Pointer D 515 may point to rights management data, security keys, and/or configuration data within one or more decentralized storage networks 530.

Dual blockchains may additionally incorporate methods for detection of abuse, essentially operating as a “bounty hunter” 550. FIG. 5B illustrates the inclusion of bounty hunters 550 within dual blockchain structures implemented in accordance with an embodiment of the invention. Bounty hunters 550 allow NFTs 510, which can point to networks that may include decentralized processing 520 and/or storage networks 530, to be monitored. The bounty hunter's 550 objective may be to locate incorrectly listed or missing data and executable code within the NFT 510 or associated networks. Additionally, the miner 540 can have the capacity to perform all necessary minting processes or any process within the architecture that involves a consensus mechanism.

Bounty hunters 550 may also choose to verify each step of a computation, and if they find an error, submit evidence of this in return for some reward. This can have the effect of invalidating the incorrect ledger entry and, potentially based on policies, all subsequent ledger entries. Such evidence can be submitted in a manner that is associated with a public key, in which the bounty hunter 550 proves knowledge of the error, thereby assigning value (namely the bounty) with the public key.

Assertions made by bounty hunters 550 may be provided directly to miners 540 by broadcasting the assertion. Assertions may be broadcast in a manner including, but not limited to posting it to a bulletin board. In some embodiments of the invention, assertions may be posted to ledgers of blockchains, for instance, the blockchain on which the miners 540 operate. If the evidence in question has not been submitted before, this can automatically invalidate the ledger entry that is proven wrong and provide the bounty hunter 550 with some benefit.

Applications and methods in accordance with various embodiments of the invention are not limited to use within NFT platforms. Accordingly, it should be appreciated that the capabilities of any blockchain configuration described herein can also be implemented outside the context of an NFT platform network architecture unrelated to the storage of fungible tokens and/or NFTs. A variety of components, mechanisms, and blockchain configurations that can be utilized within NFT platforms are discussed further below. Moreover, any of the blockchain configurations described herein with reference to FIGS. 3-5B (including permissioned, permissionless, and/or hybrid mechanisms) can be utilized within any of the networks implemented within the NFT platforms described above.

### NFT Platform Consensus Mechanisms

NFT platforms in accordance with many embodiments of the invention can depend on consensus mechanisms to achieve agreement on network state, through proof resolution, to validate transactions. In accordance with many embodiments of the invention, Proof of Work (PoW) mechanisms may be used as a means of demonstrating non-trivial allocations of processing power. Proof of Space (PoS) mechanisms may be used as a means of demonstrating non-trivial allocations of memory or disk space. As a third possible approach, Proof of Stake mechanisms may be used as a means of demonstrating non-trivial allocations of fungible tokens and/or NFTs as a form of collateral. Numerous consensus mechanisms are possible in accordance with various embodiments of the invention, some of which are expounded on below.

Traditional mining schemes, such as Bitcoin, are based on Proof of Work, based on performing the aforementioned large computational tasks. The cost of such tasks may not only be computational effort, but also energy expenditure, a significant environmental concern. To address this problem, mining methods operating in accordance with many embodiments of the invention may instead operate using Proof of Space mechanisms to accomplish network consensus, wherein the distinguishing factor can be memory rather than processing power. Specifically, Proof of Space mechanisms can perform this through network optimization challenges. In several embodiments the network optimization challenge may be selected from any of a number of different challenges appropriate to the requirements of specific applications including graph pebbling. In some embodiments, graph pebbling may refer to a resource allocation game played on discrete mathematics graphs, ending with a labeled graph disclosing how a player might get at least one pebble to every vertex of the graph.

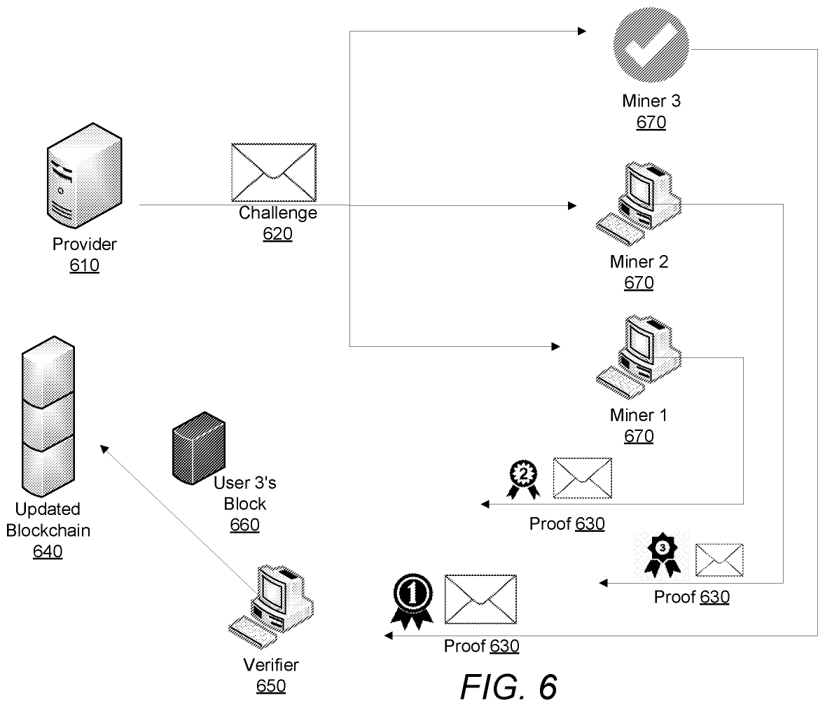

An example of Proof of Work consensus mechanisms that may be implemented in decentralized blockchains, in accordance with a number of embodiments of the invention, is conceptually illustrated in FIG. 6. The example disclosed in this figure is a challenge-response authentication, a protocol classification in which one party presents a complex problem (“challenge”) 610 and another party must broadcast a valid answer (“proof”) 620 to have clearance to add a block to the decentralized ledger that makes up the blockchain 630. As a number of miners may be competing to have this ability, there may be a need for determining factors for the addition to be added first, which in this case is processing power. Once an output is produced, verifiers 640 in the network can verify the proof, something which typically requires much less processing power, to determine the first device that would have the right to add the winning block 650 to the blockchain 630. As such, under a Proof of Work consensus mechanism, each miner involved can have a success probability proportional to the computational effort expended.

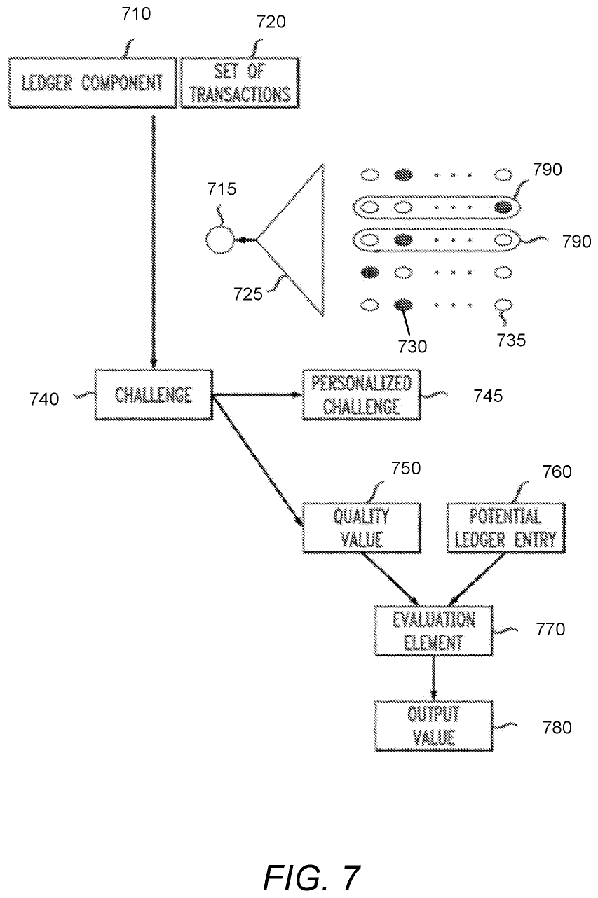

An example of Proof of Space implementations on devices in accordance with some embodiments of the invention is conceptually illustrated in FIG. 7. The implementation includes a ledger component 710, a set of transactions 720, and a challenge 740 computed from a portion of the ledger component 710. A representation 715 of a miner's state may also be recorded in the ledger component 710 and be publicly available.

In some embodiments, the material stored on the memory of the device includes a collection of nodes 730, 735, where nodes that depend on other nodes have values that are functions of the values of the associated nodes on which they depend. For example, functions may be one-way functions, such as cryptographic hash functions. In several embodiments the cryptographic hash function may be selected from any of a number of different cryptographic hash functions appropriate to the requirements of specific applications including (but not limited to) the SHA1 cryptographic hash function. In such an example, one node in the network may be a function of three other nodes. Moreover, the node may be computed by concatenating the values associated with these three nodes and applying the cryptographic hash function, assigning the result of the computation to the node depending on these three parent nodes. In this example, the nodes are arranged in rows, where two rows 790 are shown. The nodes are stored by the miner, and can be used to compute values at a setup time. This can be done using Merkle tree hash-based data structures 725, or another structure such as a compression function and/or a hash function.

Challenges 740 may be processed by the miner to obtain personalized challenges 745, made to the device according to the miner's storage capacity. The personalized challenge 745 can be the same or have a negligible change, but could also undergo an adjustment to account for the storage space accessible by the miner, as represented by the nodes the miner stores. For example, when the miner does not have a large amount of storage available or designated for use with the Proof of Space system, a personalized challenge 745 may adjust challenges 740 to take this into consideration, thereby making a personalized challenge 745 suitable for the miner's memory configuration.

In some embodiments, the personalized challenge 745 can indicate a selection of nodes 730, denoted in FIG. 7 by filled-in circles. In the FIG. 7 example specifically, the personalized challenge corresponds to one node per row. The collection of nodes selected as a result of computing the personalized challenge 745 can correspond to a valid potential ledger entry 760. However, here a quality value 750 (also referred to herein as a qualifying function value) can also be computed from the challenge 740, or from other public information that is preferably not under the control of any one miner.

A miner may perform matching evaluations 770 to determine whether the set of selected nodes 730 matches the quality value 750. This process can take into consideration what the memory constraints of the miner are, causing the evaluation 770 to succeed with a greater frequency for larger memory configurations than for smaller memory configurations. This can simultaneously level the playing field to make the likelihood of the evaluation 770 succeeding roughly proportional to the size of the memory used to store the nodes used by the miner. In some embodiments, non-proportional relationships may be created by modifying the function used to compute the quality value 750. When the evaluation 770 results in success, then the output value 780 may be used to confirm the suitability of the memory configuration and validate the corresponding transaction.

In many embodiments, nodes 730 and 735 can also correspond to public keys. The miner may submit valid ledger entries, corresponding to a challenge-response pair including one of these nodes. In that case, public key values can become associated with the obtained NFT. As such, miners can use a corresponding secret/private key to sign transaction requests, such as purchases. Additionally, any type of digital signature can be used in this context, such as RSA signatures, Merkle signatures, DSS signatures, etc. Further, the nodes 730 and 735 may correspond to different public keys or to the same public key, the latter preferably augmented with a counter and/or other location indicator such as a matrix position indicator, as described above. Location indicators in accordance with many embodiments of the invention may be applied to point to locations within a given ledger. In accordance with some embodiments of the invention, numerous Proof of Space consensus configurations are possible, some of which are discussed below.

Hybrid methods of evaluating Proof of Space problems can also be implemented in accordance with many embodiments of the invention. In many embodiments, hybrid methods can be utilized that conceptually correspond to modifications of Proof of Space protocols in which extra effort is expanded to increase the probability of success, or to compress the amount of space that may be applied to the challenge. Both come at a cost of computational effort, thereby allowing miners to improve their odds of winning by spending greater computational effort. Accordingly, in many embodiments of the invention dual proof-based systems may be used to reduce said computational effort. Such systems may be applied to Proof of Work and Proof of Space schemes, as well as to any other type of mining-based scheme.

When utilizing dual proofs in accordance with various embodiments of the invention, the constituent proofs may have varying structures. For example, one may be based on Proof of Work, another on Proof of Space, and a third may be a system that relies on a trusted organization for controlling the operation, as opposed to relying on mining for the closing of ledgers. Yet other proof structures can be combined in this way. The result of the combination will inherit properties of its components. In many embodiments, the hybrid mechanism may incorporate a first and a second consensus mechanism. In several embodiments, the hybrid mechanism includes a first, a second, and a third consensus mechanisms. In a number of embodiments, the hybrid mechanism includes more than three consensus mechanisms. Any of these embodiments can utilize consensus mechanisms selected from the group including (but not limited to) Proof of Work, Proof of Space, and Proof of Stake without departing from the scope of the invention. Depending on how each component system is parametrized, different aspects of the inherited properties will dominate over other aspects.

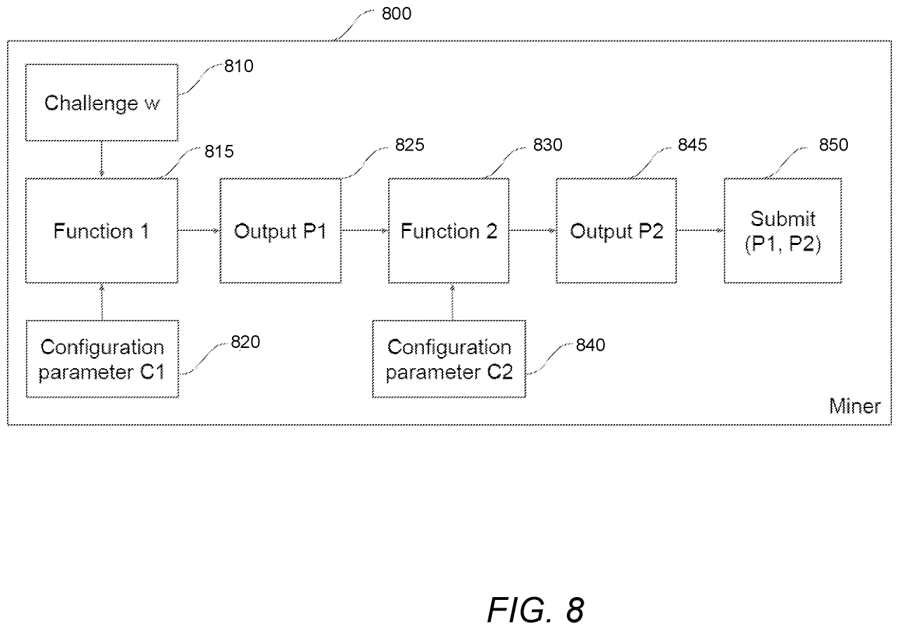

Dual proof configurations in accordance with a number of embodiments of the invention is illustrated in FIG. 8. A proof configuration in accordance with some embodiments of the invention may tend to use the notion of quality functions for tie-breaking among multiple competing correct proofs relative to a given challenge (w) 810. This classification of proof can be described as a qualitative proof, inclusive of proofs of work and proofs of space. In the example reflected in FIG. 8, proofs P1 and P2 are each one of a Proof of Work, Proof of Space, Proof of Stake, and/or any other proof related to a constrained resource, wherein P2 may be of a different type than P1, or may be of the same type.

Systems in accordance with many embodiments of the invention may introduce the notion of a qualifying proof, which, unlike qualitative proofs, are either valid or not valid, using no tie-breaking mechanism. Said systems may include a combination of one or more qualitative proofs and one or more qualifying proofs. For example, it may use one qualitative proof that is combined with one qualifying proof, where the qualifying proof is performed conditional on the successful creation of a qualitative proof. FIG. 8 illustrates challenge w 810, as described above, with a function 1 815, which is a qualitative function, and function 2 830, which is a qualifying function.

To stop miners from expending effort after a certain amount of effort has been spent, thereby reducing the environmental impact of mining, systems in accordance with a number of embodiments of the invention can constrain the search space for the mining effort. This can be done using a configuration parameter that controls the range of random or pseudo-random numbers that can be used in a proof. Upon challenge w 810 being issued to one or more miners 800, it can be input to Function 1 815 along with configuration parameter C1 820. Function 1 815 may output proof P1 825, in this example the qualifying proof to Function 2 830. Function 2 830 is also provided with configuration parameter C2 840 and computes qualifying proof P2 845. The miner 800 can then submit the combination of proofs (P1, P2) 850 to a verifier, in order to validate a ledger associated with challenge w 810. In some embodiments, miner 800 can also submit the proofs (P1, P2) 850 to be accessed by a 3rd-party verifier.

NFT platforms in accordance with many embodiments of the invention may additionally benefit from alternative energy-efficient consensus mechanisms. Therefore, computer systems in accordance with several embodiments of the invention may instead use consensus-based methods alongside or in place of proof-of-space and proof-of-space based mining. In particular, consensus mechanisms based instead on the existence of a Trusted Execution Environment (TEE), such as ARM TrustZone™ or Intel SGX™ may provide assurances exist of integrity by virtue of incorporating private/isolated processing environments.

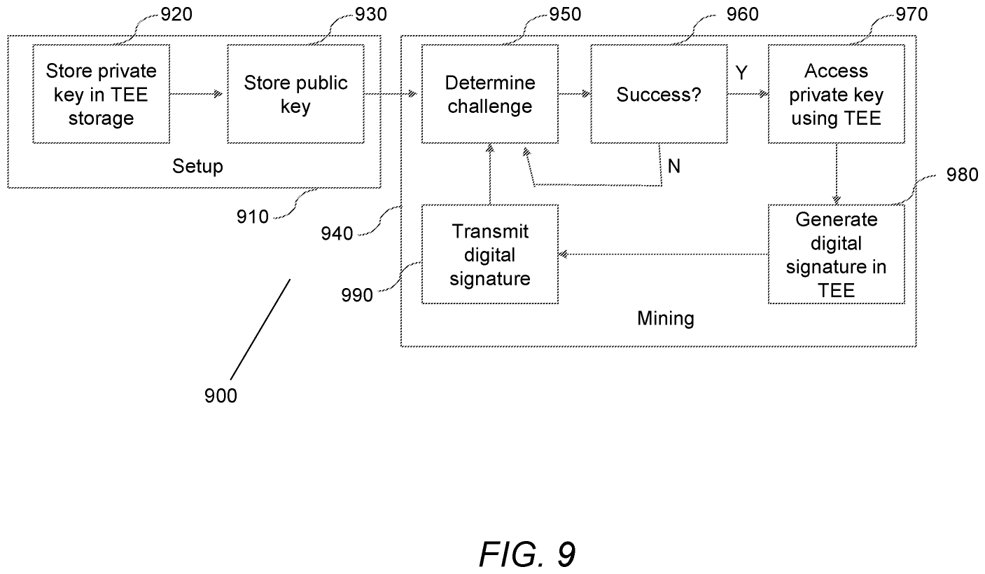

An illustration of sample process 900 undergone by TEE-based consensus mechanisms in accordance with some embodiments of the invention is depicted in FIG. 9. In some such configurations, a setup 910 may be performed by an original equipment manufacturer (OEM) or a party performing configurations of equipment provided by an OEM. Once a private key/public key pair is generated in the secure environment, process 900 may store (920) the private key in TEE storage (i.e. storage associated with the Trusted Execution Environment). While storage may be accessible from the TEE, it can be shielded from applications running outside the TEE. Additionally, processes can store (930) the public key associated with the TEE in any storage associated with the device containing the TEE. Unlike the private key, the public key may also be accessible from applications outside the TEE. In a number of embodiments, the public key may also be certified. Certification may come from OEMs or trusted entities associated with the OEMs, wherein the certificate can be stored with the public key.

In many embodiments of the invention, mining-directed steps can also be influenced by the TEE. In the illustrated embodiment, the process 900 can determine (950) a challenge. For example, this may be by computing a hash of the contents of a ledger. In doing so, process 900 may also determine whether the challenge corresponds to success 960. In some embodiments of the invention, the determination of success may result from some pre-set portion of the challenge matching a pre-set portion of the public key, e.g. the last 20 bits of the two values matching. In several embodiments the success determination mechanism may be selected from any of a number of alternate approaches appropriate to the requirements of specific applications. The matching conditions may also be modified over time. For example, modification may result from an announcement from a trusted party or based on a determination of a number of participants having reached a threshold value.

When the challenge does not correspond to a success 960, process 900 can return to determine (950) a new challenge. In this context, process 900 can determine (950) a new challenge after the ledger contents have been updated and/or a time-based observation is performed. In several embodiments the determination of a new challenge may come from any of a number of approaches appropriate to the requirements of specific applications, including, but not limited to, the observation of as a second elapsing since the last challenge. If the challenge corresponds to a success 960, then the processing can continue on to access (970) the private key using the TEE.

When the private key is accessed, process can generate (980) a digital signature using the TEE. The digital signature may be on a message that includes the challenge and/or which otherwise references the ledger entry being closed. Process 900 can also transmit (980) the digital signature to other participants implementing the consensus mechanism. In cases where multiple digital signatures are received and found to be valid, a tie-breaking mechanism can be used to evaluate the consensus. For example, one possible tie-breaking mechanism may be to select the winner as the party with the digital signature that represents the smallest numerical value when interpreted as a number. In several embodiments the tie-breaking mechanism may be selected from any of a number of alternate tie-breaking mechanisms appropriate to the requirements of specific applications.

Applications and methods in accordance with various embodiments of the invention are not limited to use within NFT platforms. Accordingly, it should be appreciated that consensus mechanisms described herein can also be implemented outside the context of an NFT platform network architecture unrelated to the storage of fungible tokens and/or NFTs. Moreover, any of the consensus mechanisms described herein with reference to FIGS. 6-9 (including Proof of Work, Proof of Space, Proof of Stake, and/or hybrid mechanisms) can be utilized within any of the blockchains implemented within the NFT platforms described above with reference to FIGS. 3-5B. Various systems and methods for implementing NFT platforms and applications in accordance with numerous embodiments of the invention are discussed further below.

### NFT Platform Constituent Devices and Applications

A variety of computer systems that can be utilized within NFT platforms and systems that utilize NFT blockchains in accordance with various embodiments of the invention are illustrated below. The computer systems in accordance with many embodiments of the invention may implement a processing system 1010, 1120, 1220 using one or more CPUs, GPUs, ASICs, FPGAs, and/or any of a variety of other devices and/or combinations of devices that are typically utilized to perform digital computations. As can readily be appreciated each of these computer systems can be implemented using one or more of any of a variety of classes of computing devices including (but not limited to) mobile phone handsets, tablet computers, laptop computers, personal computers, gaming consoles, televisions, set top boxes and/or other classes of computing device.

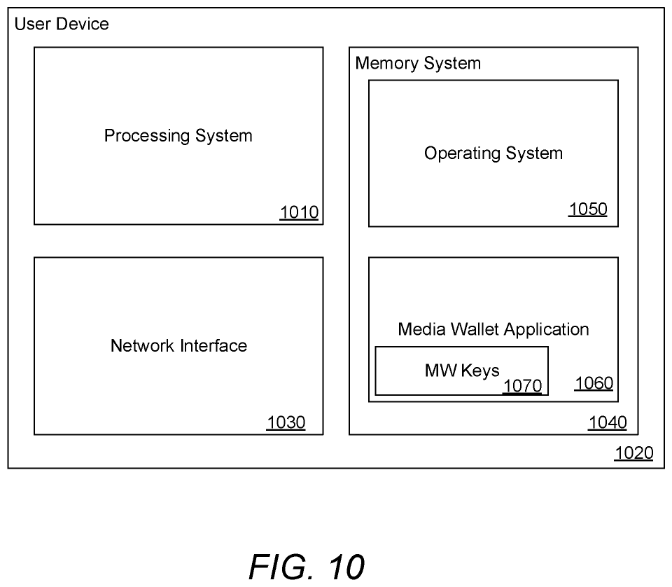

A user device capable of communicating with an NFT platform in accordance with an embodiment of the invention is illustrated in FIG. 10. The memory system 1040 of particular user devices may include an operating system 1050 and media wallet applications 1060. Media wallet applications may include sets of media wallet (MW) keys 1070 that can include public key/private key pairs. The set of MW keys may be used by the media wallet application to perform a variety of actions including, but not limited to, encrypting and signing data. In many embodiments, the media wallet application enables the user device to obtain and conduct transactions with respect to NFTs by communicating with an NFT blockchain via the network interface 1030. In some embodiments, the media wallet applications are capable of enabling the purchase of NFTs using fungible tokens via at least one distributed exchange. User devices may implement some or all of the various functions described above with reference to media wallet applications as appropriate to the requirements of a given application in accordance with various embodiments of the invention.

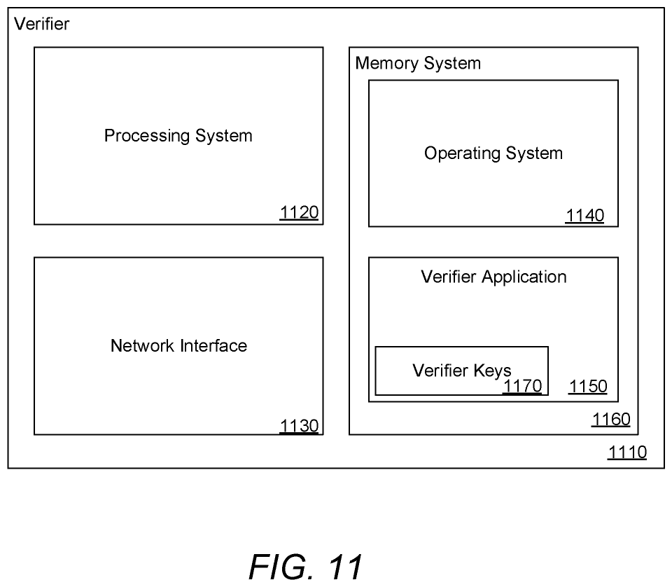

A verifier 1110 capable of verifying blockchain transactions in an NFT platform in accordance with many embodiments of the invention is illustrated in FIG. 11. The memory system 1160 of the verifier computer system includes an operating system 1140 and a verifier application 1150 that enables the verifier 1110 computer system to access a decentralized blockchain in accordance with various embodiments of the invention. Accordingly, the verifier application 1150 may utilize a set of verifier keys 1170 to affirm blockchain entries. When blockchain entries can be verified, the verifier application 1150 may transmit blocks to the corresponding blockchains. The verifier application 1150 can also implement some or all of the various functions described above with reference to verifiers as appropriate to the requirements of a given application in accordance with various embodiments of the invention.

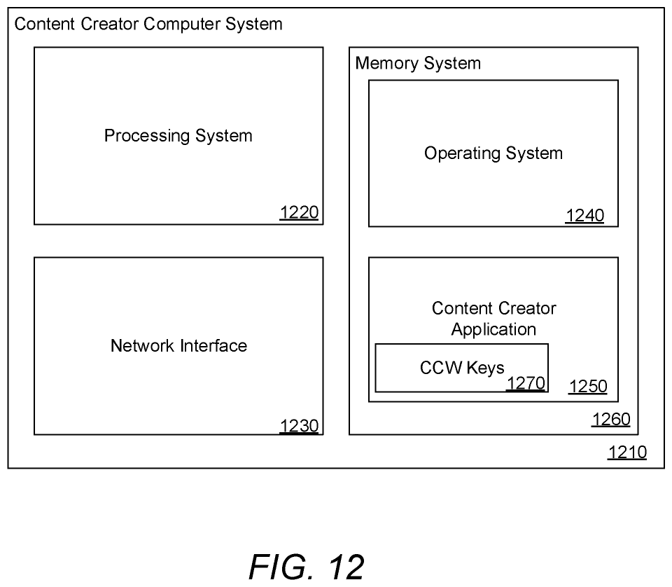

A content creator system 1210 capable of disseminating content in an NFT platform in accordance with an embodiment of the invention is illustrated in FIG. 12. The memory system 1260 of the content creator computer system may include an operating system 1240 and a content creator application 1250. The content creator application 1250 may enable the content creator computer system to mint NFTs by writing smart contracts to blockchains via the network interface 1230. The content creator application can include sets of content creator wallet (CCW) keys 1270 that can include a public key/private key pairs. Content creator applications may use these keys to sign NFTs minted by the content creator application. The content creator application can also implement some or all of the various functions described above with reference to content creators as appropriate to the requirements of a given application in accordance with various embodiments of the invention.

Computer systems in accordance with many embodiments of the invention incorporate digital wallets (herein also referred to as “wallets” or “media wallets”) for NFT and/or fungible token storage. In several embodiments, the digital wallet may securely store rich media NFTs and/or other tokens. Additionally, in some embodiments, the digital wallet may display user interface through which user instructions concerning data access permissions can be received.

In a number of embodiments of the invention, digital wallets may be used to store at least one type of token-directed content. Example content types may include, but are not limited to crypto currencies of one or more sorts; non-fungible tokens; and user profile data.

Example user profile data may incorporate logs of user actions. In accordance with some embodiments of the invention, example anonymized user profile data may include redacted, encrypted, and/or otherwise obfuscated user data. User profile data in accordance with some embodiments may include, but are not limited to, information related to classifications of interests, determinations of a post-advertisement purchases, and/or characterizations of wallet contents.

Media wallets, when storing content, may store direct references to content. Media wallets may also reference content through keys to decrypt and/or access the content. Media wallets may use such keys to additionally access metadata associated with the content. Example metadata may include, but is not limited to, classifications of content. In a number of embodiments, the classification metadata may govern access rights of other parties related to the content.

Access governance rights may include, but are not limited to, whether a party can indicate their relationship with the wallet; whether they can read summary data associated with the content; whether they have access to peruse the content; whether they can place bids to purchase the content; whether they can borrow the content, and/or whether they are biometrically authenticated.

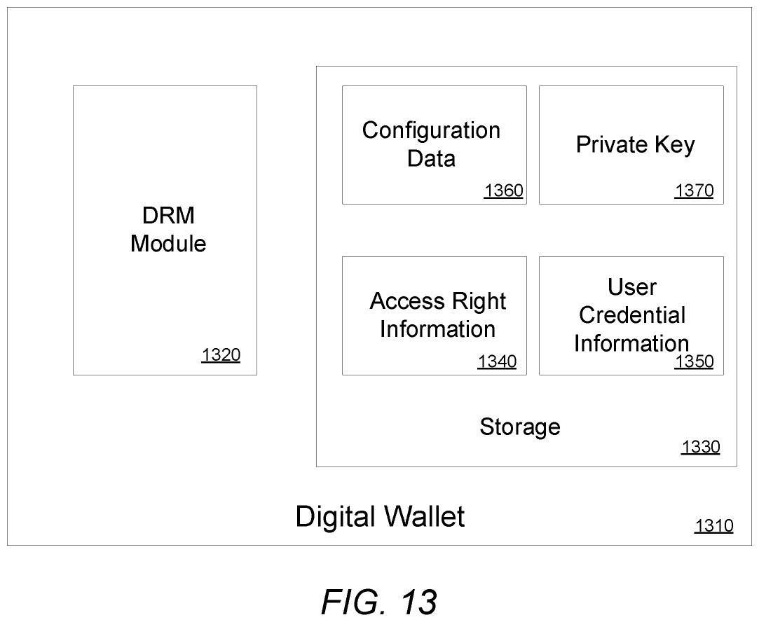

An example of a media wallet 1310 capable of storing rich media NFTs in accordance with an embodiment of the invention is illustrated in FIG. 13. Media wallets 1310 may include a storage component 1330, including access right information 1340, user credential information 1350, token configuration data 1360, and/or at least one private key 1370. In accordance with many embodiments of the invention, a private key 1370 may be used to perform a plurality of actions on resources, including but not limited to decrypting NFT and/or fungible token content. Media wallets may also correspond to a public key, referred to as a wallet address. An action performed by private keys 1370 may be used to prove access rights to digital rights management modules. Additionally, private keys 1370 may be applied to initiating ownership transfers and granting NFT and/or fungible token access to alternate wallets. In accordance with some embodiments, access right information 1340 may include lists of elements that the wallet 1310 has access to. Access right information 1340 may also express the type of access provided to the wallet. Sample types of access include, but are not limited to, the right to transfer NFT and/or fungible ownership, the right to play rich media associated with a given NFT, and the right to use an NFT and/or fungible token. Different rights may be governed by different cryptographic keys. Additionally, the access right information 1340 associated with a given wallet 1310 may utilize user credential information 1350 from the party providing access.

In accordance with many embodiments of the invention, third parties initiating actions corresponding to requesting access to a given NFT may require user credential information 1350 of the party providing access to be verified. User credential information 1350 may be taken from the group including, but not limited to, a digital signature, hashed passwords, PINs, and biometric credentials. User credential information 1350 may be stored in a manner accessible only to approved devices. In accordance with some embodiments of the invention, user credential information 1350 may be encrypted using a decryption key held by trusted hardware, such as a trusted execution environment. Upon verification, user credential information 1350 may be used to authenticate wallet access.

Available access rights may be determined by digital rights management (DRM) modules 1320 of wallets 1310. In the context of rich media, encryption may be used to secure content. As such, DRM systems may refer to technologies that control the distribution and use of keys required to decrypt and access content. DRM systems in accordance with many embodiments of the invention may require a trusted execution zone. Additionally, said systems may require one or more keys (typically a certificate containing a public key/private key pair) that can be used to communicate with and register with DRM servers. DRM modules 1320 in some embodiments may also use one or more keys to communicate with a DRM server. In several embodiments, the DRM modules 1320 may include code used for performing sensitive transactions for wallets including, but not limited to, content access. In accordance with a number of embodiments of the invention, the DRM module 1320 may execute in a Trusted Execution Environment. In a number of embodiments, the DRM may be facilitated by an Operating System (OS) that enables separation of processes and processing storage from other processes and their processing storage.

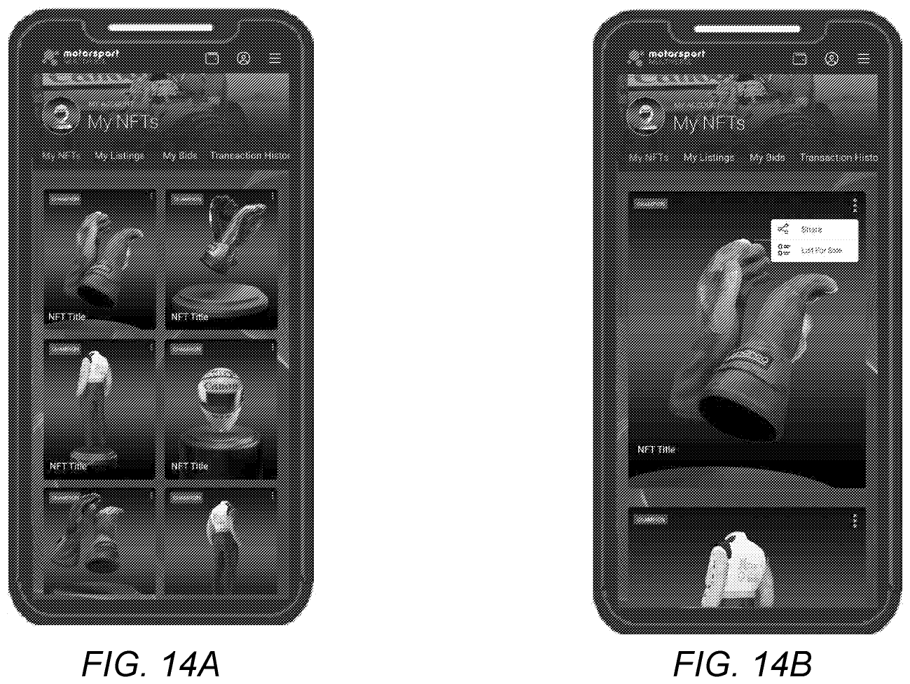

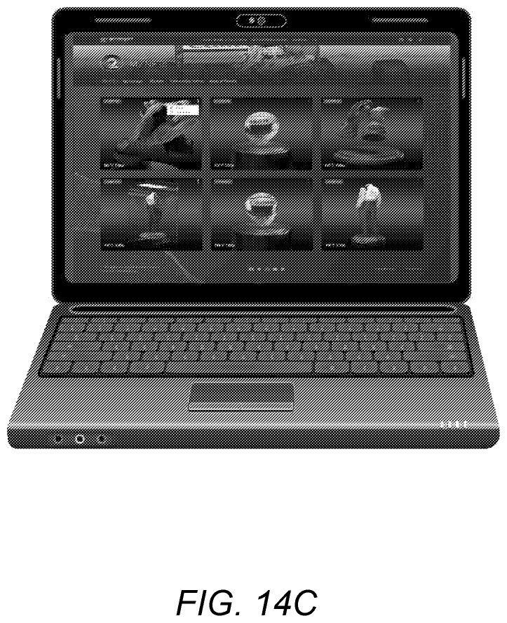

Operation of media wallet applications implemented in accordance with some embodiments of the invention is conceptually illustrated by way of the user interfaces shown in FIGS. 14A-14C. In many embodiments, media wallet applications can refer to applications that are installed upon user devices such as (but not limited to) mobile phones and tablet computers running the iOS, Android and/or similar operating systems. Launching media wallet applications can provide a number of user interface contexts. In many embodiments, transitions between these user interface contexts can be initiated in response to gestures including (but not limited to) swipe gestures received via a touch user interface. As can readily be appreciated, the specific manner in which user interfaces operate through media wallet applications is largely dependent upon the user input capabilities of the underlying user device. In several embodiments, a first user interface context is a dashboard (see, FIGS. 14A, 14C) that can include a gallery view of NFTs owned by the user. In several embodiments, the NFT listings can be organized into category index cards. Category index cards may include, but are not limited to digital merchandise/collectibles, special event access/digital tickets, fan leaderboards. In certain embodiments, a second user interface context (see, for example, FIG. 14B) may display individual NFTs. In a number of embodiments, each NFT can be main-staged in said display with its status and relevant information shown. Users can swipe through each collectible and interacting with the user interface can launch a collectible user interface enabling greater interaction with a particular collectible in a manner that can be determined based upon the smart contract underlying the NFT.

A participant of an NFT platform may use a digital wallet to classify wallet content, including NFTs, fungible tokens, content that is not expressed as tokens such as content that has not yet been minted but for which the wallet can initiate minting, and other non-token content, including executable content, webpages, configuration data, history files and logs. This classification may be performed using a visual user interface. Users interface may enable users to create a visual partition of a space. In some embodiments of the invention, a visual partition may in turn be partitioned into sub-partitions. In some embodiments, a partition of content may separate wallet content into content that is not visible to the outside world (“invisible partition”), and content that is visible at least to some extent by the outside world (“visible partition”). Some of the wallet content may require the wallet use to have an access code such as a password or a biometric credential to access, view the existence of, or perform transactions on. A visible partition may be subdivided into two or more partitions, where the first one corresponds to content that can be seen by anybody, the second partition corresponds to content that can be seen by members of a first group, and/or the third partition corresponds to content that can be seen by members of a second group.

For example, the first group may be users with which the user has created a bond, and invited to be able to see content. The second group may be users who have a membership and/or ownership that may not be controlled by the user. An example membership may be users who own non-fungible tokens (NFTs) from a particular content creator. Content elements, through icons representing the elements, may be relocated into various partitions of the space representing the user wallet. By doing so, content elements may be associated with access rights governed by rules and policies of the given partition.

One additional type of visibility may be partial visibility. Partial visibility can correspond to a capability to access metadata associated with an item, such as an NFT and/or a quantity of crypto funds, but not carry the capacity to read the content, lend it out, or transfer ownership of it. As applied to a video NFT, an observer to a partition with partial visibility may not be able to render the video being encoded in the NFT but see a still image of it and a description indicating its source.

Similarly, a party may have access to a first anonymized profile which states that the user associated with the wallet is associated with a given demographic. The party with this access may also be able to determine that a second anonymized profile including additional data is available for purchase. This second anonymized profile may be kept in a sub-partition to which only people who pay a fee have access, thereby expressing a form of membership. Alternatively, only users that have agreed to share usage logs, aspects of usage logs or parts thereof may be allowed to access a given sub-partition. By agreeing to share usage log information with the wallet comprising the sub-partition, this wallet learns of the profiles of users accessing various forms of content, allowing the wallet to customize content, including by incorporating advertisements, and to determine what content to acquire to attract users of certain demographics.

Another type of membership may be held by advertisers who have sent promotional content to the user. These advertisers may be allowed to access a partition that stores advertisement data. Such advertisement data may be encoded in the form of anonymized profiles. In a number of embodiments, a given sub-partition may be accessible only to the advertiser to whom the advertisement data pertains. Elements describing advertisement data may be automatically placed in their associated partitions, after permission has been given by the user. This partition may either be visible to the user. Visibility may also depend on a direct request to see “system partitions.” A first partition may correspond to material associated with a first set of public keys, a second partition to material associated with a second set of public keys not overlapping with the first set of public keys, wherein such material may comprise tokens such as crypto coins and NFTs. A third partition may correspond to usage data associated with the wallet user, and a fourth partition may correspond to demographic data and/or preference data associated with the wallet user. Yet other partitions may correspond to classifications of content, e.g., child-friendly vs. adult; classifications of whether associated items are for sale or not, etc.

The placing of content in a given partition may be performed by a drag-and-drop action performed on a visual interface. By selecting items and clusters and performing a drag-and-drop to another partition and/or to a sub-partition, the visual interface may allow movement including, but not limited to, one item, a cluster of items, and a multiplicity of items and clusters of items. The selection of items can be performed using a lasso approach in which items and partitions are circled as they are displayed. The selection of items may also be performed by alternative methods for selecting multiple items in a visual interface, as will be appreciated by a person of skill in the art.

Some content classifications may be automated in part or full. For example, when user place ten artifacts, such as NFTs describing in-game capabilities, in a particular partition, they may be asked if additional content that are also in-game capabilities should be automatically placed in the same partition as they are acquired and associated with the wallet. When “yes” is selected, then this placement may be automated in the future. When “yes, but confirm for each NFT” is selected, then users can be asked, for each automatically classified element, to confirm its placement. Before the user confirms, the element may remain in a queue that corresponds to not being visible to the outside world. When users decline given classifications, they may be asked whether alternative classifications should be automatically performed for such elements onwards. In some embodiments, the selection of alternative classifications may be based on manual user classification taking place subsequent to the refusal.

Automatic classification of elements may be used to perform associations with partitions and/or folders. The automatic classification may be based on machine learning (ML) techniques considering characteristics including, but not limited to, usage behaviors exhibited by the user relative to the content to be classified, labels associated with the content, usage statistics; and/or manual user classifications of related content.

Multiple views of wallets may also be accessible. One such view can correspond to the classifications described above, which indicates the actions and interactions others can perform relative to elements. Another view may correspond to a classification of content based on use, type, and/or users-specified criterion. For example, all game NFTs may be displayed in one collection view. The collection view may further subdivide the game NFTs into associations with different games or collections of games. Another collection may show all audio content, clustered based on genre. users-specified classification may be whether the content is for purposes of personal use, investment, or both. A content element may show up in multiple views. users can search the contents of his or her wallet by using search terms that result in potential matches.

Alternatively, the collection of content can be navigated based the described views of particular wallets, allowing access to content. Once a content element has been located, the content may be interacted with. For example, located content elements may be rendered. One view may be switched to another after a specific item is found. For example, this may occur through locating an item based on its genre and after the item is found, switching to the partitioned view described above. In some embodiments, wallet content may be rendered using two or more views in a simultaneous manner. They may also select items using one view.

Media wallet applications in accordance with various embodiments of the invention are not limited to use within NFT platforms. Accordingly, it should be appreciated that applications described herein can also be implemented outside the context of an NFT platform network architecture unrelated to the storage of fungible tokens and/or NFTs. Moreover, any of the computer systems described herein with reference to FIGS. 10-14C can be utilized within any of the NFT platforms described above.

### NFT Platform NFT Interactions

NFT platforms in accordance with many embodiments of the invention may incorporate a wide variety of rich media NFT configurations. The term “Rich Media Non-Fungible Tokens” can be used to refer to blockchain-based cryptographic tokens created with respect to a specific piece of rich media content and which incorporate programmatically defined digital rights management. In some embodiments of the invention, each NFT may have a unique serial number and be associated with a smart contract defining an interface that enables the NFT to be managed, owned and/or traded.

Under a rich media blockchain in accordance with many embodiments of the invention, a wide variety of NFT configurations may be implemented. Some NFTs may be referred to as anchored NFTs (or anchored tokens), used to tie some element, such as a physical entity, to an identifier. Of this classification, one sub-category may be used to tie users' real-world identities and/or identifiers to a system identifier, such as a public key. In this disclosure, this type of NFT applied to identifying users, may be called a social NFT, identity NFT, identity token, and a social token. In accordance with many embodiments of the invention, an individual's personally identifiable characteristics may be contained, maintained, and managed throughout their lifetime so as to connect new information and/or NFTs to the individual's identity. A social NFT's information may include, but are not limited to, personally identifiable characteristics such as name, place and date of birth, and/or biometrics.

An example social NFT may assign a DNA print to a newborn's identity. In accordance with a number of embodiments of the invention, this first social NFT might then be used in the assignment process of a social security number NFT from the federal government. In some embodiments, the first social NFT may then be associated with some rights and capabilities, which may be expressed in other NFTs. Additional rights and capabilities may also be directly encoded in a policy of the social security number NFT.

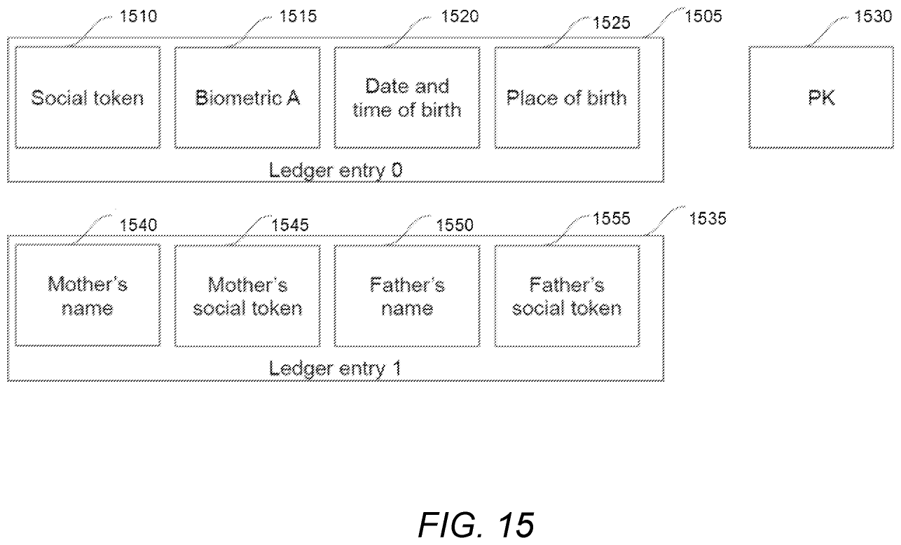

A social NFT may exist on a personalized branch of a centralized and/or decentralized blockchain. Ledger entries related to an individual's social NFT in accordance with several embodiments of the invention are depicted in FIG. 15. Ledger entries of this type may be used to build an immutable identity foundation whereby biometrics, birth and parental information are associated with an NFT. As such, this information may also be protected with encryption using a private key 1530. The initial entry in a ledger, “ledger entry 0” 1505, may represent a social token 1510 assignment to an individual with a biometric “A” 1515. In this embodiment, the biometric may include but is not limited to a footprint, a DNA print, and a fingerprint. The greater record may also include the individual's date and time of birth 1520 and place of birth 1525. A subsequent ledger entry 1 1535 may append parental information including but not limited to mothers' name 1540, mother's social token 1545, father's name 1550, and father's social token 1555.

In a number of embodiments, the various components that make up a social NFT may vary from situation to situation. In a number of embodiments, biometrics and/or parental information may be unavailable in a given situation and/or period of time. Other information including, but not limited to, race gender, and governmental number assignments such as social security numbers, may be desirable to include in the ledger. In a blockchain, future NFT creation may create a life-long ledger record of an individual's public and private activities. In accordance with some embodiments, the record may be associated with information including, but not limited to, identity, purchases, health and medical records, access NFTs, family records such as future offspring, marriages, familial history, photographs, videos, tax filings, and/or patent filings. The management and/or maintenance of an individual's biometrics throughout the individual's life may be immutably connected to the first social NFT given the use of a decentralized blockchain ledger.

In some embodiments, a certifying third party may generate an NFT associated with certain rights upon the occurrence of a specific event. In one such embodiment, the DMV may be the certifying party and generate an NFT associated with the right to drive a car upon issuing a traditional driver's license. In another embodiment, the certifying third party may be a bank that verifies a person's identity papers and generates an NFT in response to a successful verification. In a third embodiment, the certifying party may be a car manufacturer, who generates an NFT and associates it with the purchase and/or lease of a car.

In many embodiments, a rule may specify what types of policies the certifying party may associate with the NFT. Additionally, a non-certified entity may also generate an NFT and assert its validity. This may require putting up some form of security. In one example, security may come in the form of a conditional payment associated with the NFT generated by the non-certified entity. In this case, the conditional payment may be exchangeable for funds if abuse can be detected by a bounty hunter and/or some alternate entity. Non-certified entities may also relate to a publicly accessible reputation record describing the non-certified entity's reputability.

Anchored NFTs may additionally be applied to automatic enforcement of programming rules in resource transfers. NFTs of this type may be referred to as promise NFTs. A promise NFT may include an agreement expressed in a machine-readable form and/or in a human-accessible form. In a number of embodiments, the machine-readable and human-readable elements can be generated one from the other. In some embodiments, an agreement in a machine-readable form may include, but is not limited to, a policy and/or an executable script. In some embodiments, an agreement in a human-readable form may include, but is not limited to, a text and/or voice-based statement of the promise.

In some embodiments, regardless of whether the machine-readable and human-readable elements are generated from each other, one can be verified based on the other. Smart contracts including both machine-readable statements and human-accessible statements may also be used outside the implementation of promise NFTs. Moreover, promise NFTs may be used outside actions taken by individual NFTs and/or NFT-owners. In some embodiments, promise NFTs may relate to general conditions, and may be used as part of a marketplace.

In one such example, horse betting may be performed through generating a first promise NFT that offers a payment of $10 if a horse does not win. Payment may occur under the condition that the first promise NFT is matched with a second promise NFT that causes a transfer of funds to a public key specified with the first promise NFT if horse X wins.

A promise NFT may be associated with actions that cause the execution of a policy and/or rule indicated by the promise NFT. In some embodiments of the invention, a promise of paying a charity may be associated with the sharing of an NFT. In this embodiment, the associated promise NFT may identify a situation that satisfies the rule associated with the promise NFT, thereby causing the transfer of funds when the condition is satisfied (as described above). One method of implementation may be embedding in and/or associating a conditional payment with the promise NFT. A conditional payment NFT may induce a contract causing the transfer of funds by performing a match. In some such methods, the match may be between the promise NFT and inputs that identify that the conditions are satisfied, where said input can take the form of another NFT. In a number of embodiments, one or more NFTs may also relate to investment opportunities.

For example, a first NFT may represent a deed to a first building, and a second NFT a deed to a second building. Moreover, the deed represented by the first NFT may indicate that a first party owns the first property. The deed represented by the second NFT may indicate that a second party owns the second property. A third NFT may represent one or more valuations of the first building. The third NFT may in turn be associated with a fourth NFT that may represent credentials of a party performing such a valuation. A fifth NFT may represent one or more valuations of the second building. A sixth may represent the credentials of one of the parties performing a valuation. The fourth and sixth NFTs may be associated with one or more insurance policies, asserting that if the parties performing the valuation are mistaken beyond a specified error tolerance, then the insurer would pay up to a specified amount.

A seventh NFT may then represent a contract that relates to the planned acquisition of the second building by the first party, from the second party, at a specified price. The seventh NFT may make the contract conditional provided a sufficient investment and/or verification by a third party. A third party may evaluate the contract of the seventh NFT, and determine whether the terms are reasonable. After the evaluation, the third party may then verify the other NFTs to ensure that the terms stated in the contract of the seventh NFT agree. If the third party determines that the contract exceeds a threshold in terms of value to risk, as assessed in the seventh NFT, then executable elements of the seventh NFT may cause transfers of funds to an escrow party specified in the contract of the sixth NFT.

Alternatively, the first party may initiate the commitment of funds, conditional on the remaining funds being raised within a specified time interval. The commitment of funds may occur through posting the commitment to a ledger. Committing funds may produce smart contracts that are conditional on other events, namely the payments needed to complete the real estate transaction. The smart contract also may have one or more additional conditions associated with it. For example, an additional condition may be the reversal of the payment if, after a specified amount of time, the other funds have not been raised. Another condition may be related to the satisfactory completion of an inspection and/or additional valuation.

NFTs may also be used to assert ownership of virtual property. Virtual property in this instance may include, but is not limited to, rights associated with an NFT, rights associated with patents, and rights associated with pending patents. In a number of embodiments, the entities involved in property ownership may be engaged in fractional ownership. In some such embodiments, two parties may wish to purchase an expensive work of digital artwork represented by an NFT. The parties can enter into smart contracts to fund and purchase valuable works. After a purchase, an additional NFT may represent each party's contribution to the purchase and equivalent fractional share of ownership.

Another type of NFTs that may relate to anchored NFTs may be called “relative NFTs.” This may refer to NFTs that relate two or more NFTs to each other. Relative NFTs associated with social NFTs may include digital signatures that is verified using a public key of a specific social NFT. In some embodiments, an example of a relative NFT may be an assertion of presence in a specific location, by a person corresponding to the social NFT. This type of relative NFT may also be referred to as a location NFT and a presence NFT. Conversely, a signature verified using a public key embedded in a location NFT may be used as proof that an entity sensed by the location NFT is present. Relative NFTs are derived from other NFTs, namely those they relate to, and therefore may also be referred to as derived NFTs. An anchored NFT may tie to another NFT, which may make it both anchored and relative. An example of such may be called pseudonym NFTs.

Pseudonym NFTs may be a kind of relative NFT acting as a pseudonym identifier associated with a given social NFT. In some embodiments, pseudonym NFTs may, after a limited time and/or a limited number of transactions, be replaced by a newly derived NFTs expressing new pseudonym identifiers. This may disassociate users from a series of recorded events, each one of which may be associated with different pseudonym identifiers. A pseudonym NFT may include an identifier that is accessible to biometric verification NFTs. Biometric verification NFTs may be associated with a TEE and/or DRM which is associated with one or more biometric sensors. Pseudonym NFTs may be output by social NFTs and/or pseudonym NFTs.

Inheritance NFTs may be another form of relative NFTs, that transfers rights associated with a first NFT to a second NFT. For example, computers, represented by an anchored NFT that is related to a physical entity (the hardware), may have access rights to WiFi networks. When computers are replaced with newer models, users may want to maintain all old relationships, for the new computer. For example, users may want to retain WiFi hotspots. For this to be facilitated, a new computer can be represented by an inheritance NFT, inheriting rights from the anchored NFT related to the old computer. An inheritance NFT may acquire some or all pre-existing rights associated with the NFT of the old computer, and associate those with the NFT associated with the new computer.

More generally, multiple inheritance NFTs can be used to selectively transfer rights associated with one NFT to one or more NFTs, where such NFTs may correspond to users, devices, and/or other entities, when such assignments of rights are applicable. Inheritance NFTs can also be used to transfer property. One way to implement the transfer of property can be to create digital signatures using private keys. These private keys may be associated with NFTs associated with the rights. In accordance with a number of embodiments, transfer information may include the assignment of included rights, under what conditions the transfer may happen, and to what NFT(s) the transfer may happen. In this transfer, the assigned NFTs may be represented by identifies unique to these, such as public keys. The digital signature and message may then be in the form of an inheritance NFT, or part of an inheritance NFT. As rights are assigned, they may be transferred away from previous owners to new owners through respective NFTs. Access to financial resources is one such example.

However, sometimes rights may be assigned to new parties without taking the same rights away from the party (i.e., NFT) from which the rights come. One example of this may be the right to listen to a song, when a license to the song is sold by the artist to consumers. However, if the seller sells exclusive rights, this causes the seller not to have the rights anymore.

In accordance with many embodiments of the invention, multiple alternative NFT configurations may be implemented. One classification of NFT may be an employee NFT or employee token. Employee NFTs may be used by entities including, but not limited to, business employees, students, and organization members. Employee NFTs may operate in a manner analogous to key card photo identifications. In a number of embodiments, employee NFTs may reference information including, but not limited to, company information, employee identity information and/or individual identity NFTs.

Additionally, employee NFTs may include associated access NFT information including but not limited to, what portions of a building employees may access, and what computer system employees may utilize. In several embodiments, employee NFTs may incorporate their owner's biometrics, such as a face image. In a number of embodiments, employee NFTs may operate as a form of promise NFT. In some embodiments, employee NFT may comprise policies or rules of employing organization. In a number of embodiments, the employee NFT may reference a collection of other NFTs.

Another type of NFT may be referred to as the promotional NFT or promotional token. Promotional NFTs may be used to provide verification that promoters provide promotion winners with promised goods. In some embodiments, promotional NFTs may operate through decentralized applications for which access restricted to those using an identity NFT. The use of a smart contract with a promotional NFT may be used to allow for a verifiable release of winnings. These winnings may include, but are not limited to, cryptocurrency, money, and gift card NFTs useful to purchase specified goods. Smart contracts used alongside promotional NFTs may be constructed for winners selected through random number generation.

Another type of NFT may be called the script NFT or script token. Script tokens may incorporate script elements including, but not limited to, story scripts, plotlines, scene details, image elements, avatar models, sound profiles, and voice data for avatars. Script tokens may also utilize rules and policies that describe how script elements are combined. Script tokens may also include rightsholder information, including but not limited to, licensing and copyright information. Executable elements of script tokens may include instructions for how to process inputs; how to configure other elements associated with the script tokens; and how to process information from other tokens used in combination with script tokens.

Script tokens may be applied to generate presentations of information. In accordance with some embodiments, these presentations may be developed on devices including but not limited to traditional computers, mobile computers, and virtual reality display devices. Script tokens may be used to provide the content for game avatars, digital assistant avatars, and/or instructor avatars. Script tokens may comprise audio-visual information describing how input text is presented, along with the input text that provides the material to be presented. It may also comprise what may be thought of as the personality of the avatar, including how the avatar may react to various types of input from an associated user.

In some embodiments, script NFTs may be applied to govern behavior within an organization. For example, this may be done through digital signatures asserting the provenance of the scripts. Script NFTs may also, in full and/or in part, be generated by freelancers. For example, a text script related to a movie, an interactive experience, a tutorial, and/or other material, may be created by an individual content creator. This information may then be combined with a voice model or avatar model created by an established content producer. The information may then be combined with a background created by additional parties. Various content producers can generate parts of the content, allowing for large-scale content collaboration.

Features of other NFTs can be incorporated in a new NFT using techniques related to inheritance NFTs, and/or by making references to other NFTs. As script NFTs may consist of multiple elements, creators with special skills related to one particular element may generate and combine elements. This may be used to democratize not only the writing of storylines for content, but also outsourcing for content production. For each such element, an identifier establishing the origin or provenance of the element may be included. Policy elements can also be incorporated that identify the conditions under which a given script element may be used. Conditions may be related to, but are not limited to execution environments, trusts, licenses, logging, financial terms for use, and various requirements for the script NFTs. Requirements may concern, but are not limited to, what other types of elements the given element are compatible with, what is allowed to be combined with according the terms of service, and/or local copyright laws that must be obeyed.

Evaluation units may be used with various NFT classifications to collect information on their use. Evaluation units may take a graph representing subsets of existing NFTs and make inferences from the observed graph component. From this, valuable insights into NFT value may be derived. For example, evaluation units may be used to identify NFTs whose popularity is increasing or waning. In that context, popularity may be expressed as, but not limited to, the number of derivations of the NFT that are made; the number of renderings, executions or other uses are made; and the total revenue that is generated to one or more parties based on renderings, executions or other uses.

Evaluation units may make their determination through specific windows of time and/or specific collections of end-users associated with the consumption of NFT data in the NFTs. Evaluation units may limit assessments to specific NFTs (e.g. script NFTs). This may be applied to identify NFTs that are likely to be of interest to various users. In addition, the system may use rule-based approaches to identify NFTs of importance, wherein importance may be ascribed to, but is not limited to, the origination of the NFTs, the use of the NFTs, the velocity of content creation of identified clusters or classes, the actions taken by consumers of NFT, including reuse of NFTs, the lack of reuse of NFTs, and the increased or decreased use of NFTs in selected social networks.

Evaluations may be repurposed through recommendation mechanisms for individual content consumers and/or as content originators. Another example may address the identification of potential combination opportunities, by allowing ranking based on compatibility. Accordingly, content creators such as artists, musicians and programmers can identify how to make their content more desirable to intended target groups.

The generation of evaluations can be supported by methods including, but not limited to machine learning (ML) methods, artificial intelligence (AI) methods, and/or statistical methods. Anomaly detection methods developed to identify fraud can be repurposed to identify outliers. This can be done to flag abuse risks or to improve the evaluation effort.

Multiple competing evaluation units can make competing predictions using alternative and proprietary algorithms. Thus, different evaluation units may be created to identify different types of events to different types of subscribers, monetizing their insights related to the data they access.

In a number of embodiments, evaluation units may be a form of NFTs that derive insights from massive amounts of input data. Input data may correspond, but is not limited to the graph component being analyzed. Such NFTs may be referred to as evaluation unit NFTs.

The minting of NFTs may associate rights with first owners and/or with an optional one or more policies and protection modes. An example policy and/or protection mode directed to financial information may express royalty requirements. An example policy and/or protection mode directed to non-financial requirements may express restrictions on access and/or reproduction. An example policy directed to data collection may express listings of user information that may be collected and disseminated to other participants of the NFT platform.

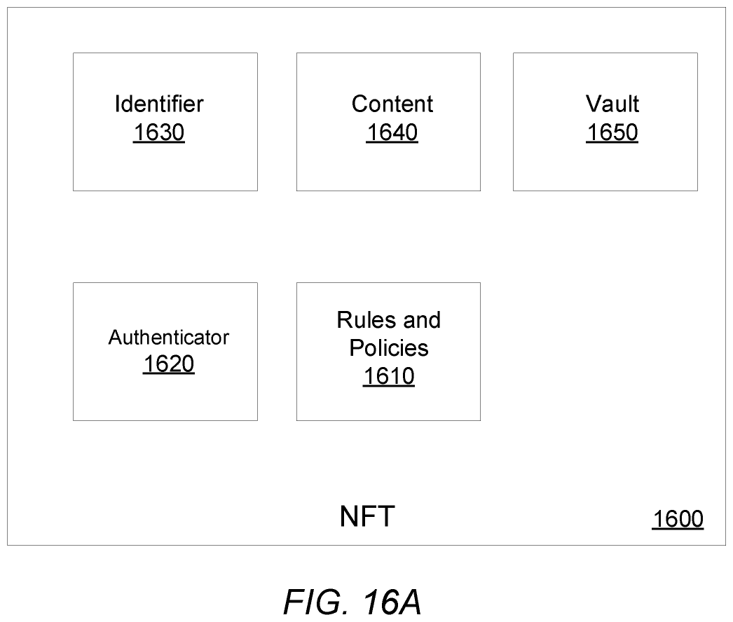

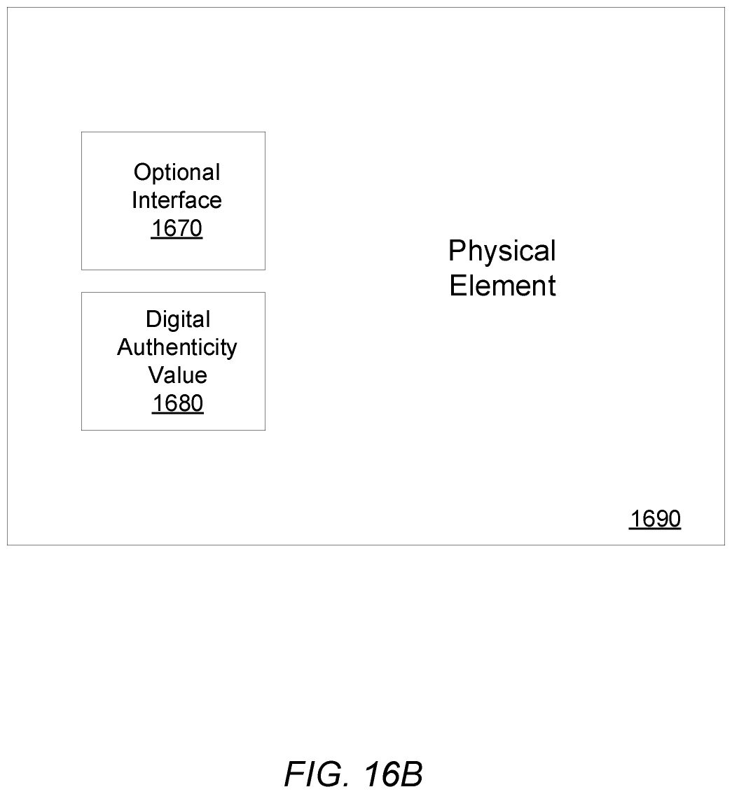

An example NFT which may be associated with specific content in accordance with several embodiments of the invention is illustrated in FIG. 16. In some embodiments, an NFT 1600 may utilize a vault 1650, which may control access to external data storage areas. Methods of controlling access may include, but are not limited to, user credential information 1350. In accordance with a number of embodiments of the invention, control access may be managed through encrypting content 1640. As such, NFTs 1600 can incorporate content 1640, which may be encrypted, not encrypted, yet otherwise accessible, or encrypted in part. In accordance with some embodiments, an NFT 1600 may be associated with one or more content 1640 elements, which may be contained in or referenced by the NFT. A content 1640 element may include, but is not limited to, an image, an audio file, a script, a biometric user identifier, and/or data derived from an alternative source. An example alternative source may be a hash of biometric information). An NFT 1600 may also include an authenticator 1620 capable of affirming that specific NFTs are valid.

In accordance with many embodiments of the invention, NFTs may include a number of rules and policies 1610. Rules and policies 1610 may include, but are not limited to access rights information 1340. In some embodiments, rules and policies 1610 may also state terms of usage, royalty requirements, and/or transfer restrictions. An NFT 1600 may also include an identifier 1630 to affirm ownership status. In accordance with many embodiments of the invention, ownership status may be expressed by linking the identifier 1630 to an address associated with a blockchain entry.

In accordance with a number of embodiments of the invention, NFTs may represent static creative content. NFTs may also be representative of dynamic creative content, which changes over time. In accordance with many examples of the invention, the content associated with an NFT may be a digital content element.

One example of a digital content element in accordance with some embodiments may be a set of five images of a mouse. In this example, the first image may be an image of the mouse being alive. The second may be an image of the mouse eating poison. The third may be an image of the mouse not feeling well. The fourth image may be of the mouse, dead. The fifth image may be of a decaying mouse.

The user credential information 1350 of an NFT may associate each image to an identity, such as of the artist. In accordance with a number of embodiments of the invention, NFT digital content can correspond to transitions from one representation (e.g., an image of the mouse, being alive) to another representation (e.g., of the mouse eating poison). In this disclosure, digital content transitioning from one representation to another may be referred to as a state change and/or an evolution. In a number of embodiments, an evolution may be triggered by the artist, by an event associated with the owner of the artwork, randomly, and/or by an external event.

When NFTs representing digital content are acquired in accordance with some embodiments of the invention, they may also be associated with the transfer of corresponding physical artwork, and/or the rights to said artwork. The first ownership records for NFTs may correspond to when the NFT was minted, at which time its ownership can be assigned to the content creator. Additionally, in the case of “lazy” minting, rights may be directly assigned to a buyer.

In some embodiments, as a piece of digital content evolves, it may also change its representation. The change in NFTs may also send a signal to an owner after it has evolved. In doing so, a signal may indicate that the owner has the right to acquire the physical content corresponding to the new state of the digital content. Under an earlier example, buying a live mouse artwork, as an NFT, may also carry the corresponding painting, and/or the rights to it. A physical embodiment of an artwork that corresponds to that same NFT may also be able to replace the physical artwork when the digital content of the NFT evolves. For example, should the live mouse artwork NFT change states to a decaying mouse, an exchange may be performed of the corresponding painting for a painting of a decaying mouse.

The validity of one of the elements, such as the physical element, can be governed by conditions related to an item with which it is associated. For example, a physical painting may have a digital authenticity value that attests to the identity of the content creator associated with the physical painting.

An example of a physical element 1690 corresponding to an NFT, in accordance with some embodiments of the invention is illustrated in FIG. 16. A physical element 1690 may be a physical artwork including, but not limited to, a drawing, a statue, and/or another physical representation of art. In a number of embodiments, physical representations of the content (which may correspond to a series of paintings) may each be embedded with a digital authenticity value (or a validator value) value. In accordance with many embodiments of the invention, a digital authenticity value (DAV) 1680 may be therefore be associated with a physical element 1690 and a digital element. A digital authenticity value may be a value that includes an identifier and a digital signature on the identifier. In some embodiments the identifier may specify information related to the creation of the content. This information may include the name of the artist, the identifier 1630 of the digital element corresponding to the physical content, a serial number, information such as when it was created, and/or a reference to a database in which sales data for the content is maintained. A digital signature element affirming the physical element may be made by the content creator and/or by an authority associating the content with the content creator.

In some embodiments, the digital authenticity value 1680 of the physical element 1690 can be expressed using a visible representation. The visible representation may be an optional physical interface 1670 taken from a group including, but not limited to, a barcode and a quick response (QR) code encoding the digital authenticity value. In some embodiments, the encoded value may also be represented in an authenticity database. Moreover, the physical interface 1670 may be physically associated with the physical element. One example of such may be a QR tag being glued to or printed on the back of a canvas. In some embodiments of the invention, the physical interface 1670 may be possible to physically disassociate from the physical item it is attached to. However, if a DAV 1680 is used to express authenticity of two or more physical items, the authenticity database may detect and block a new entry during the registration of the second of the two physical items. For example, if a very believable forgery is made of a painting the forged painting may not be considered authentic without the QR code associated with the digital element.

In a number of embodiments, the verification of the validity of a physical item, such as a piece of artwork, may be determined by scanning the DAV. In some embodiments, scanning the DAV may be used to determine whether ownership has already been assigned. Using techniques like this, each physical item can be associated with a control that prevents forgeries to be registered as legitimate, and therefore, makes them not valid. In the context of a content creator receiving a physical element from an owner, the content creator can deregister the physical element 1690 by causing its representation to be erased from the authenticity database used to track ownership. Alternatively, in the case of an immutable blockchain record, the ownership blockchain may be appended with new information. Additionally, in instances where the owner returns a physical element, such as a painting, to a content creator in order for the content creator to replace it with an “evolved” version, the owner may be required to transfer the ownership of the initial physical element to the content creator, and/or place the physical element in a stage of being evolved.

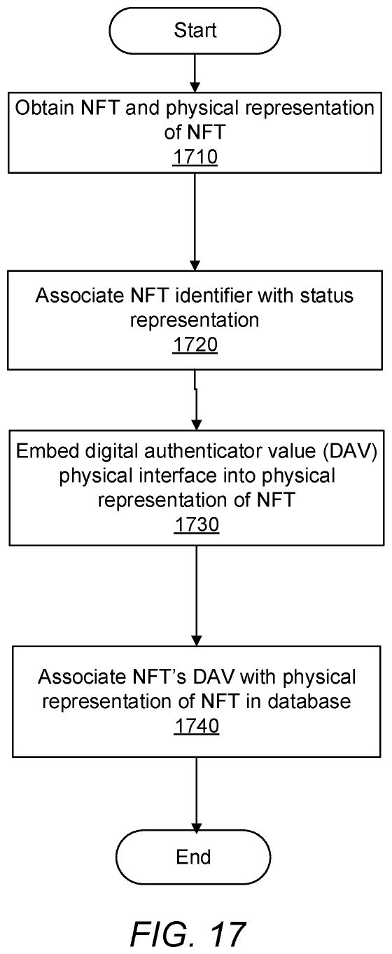

An example of a process for connecting an NFT digital element to physical content in accordance with some embodiments of the invention is illustrated in FIG. 17. Process 1700 may obtain (1710) an NFT and a physical representation of the NFT in connection with an NFT transaction. Under the earlier example, this may be a painting of a living mouse and an NFT of a living mouse. By virtue of establishing ownership of the NFT, the process 1700 may associate (1720) an NFT identifier with a status representation of the NFT. The NFT identifier may specify attributes including, but not limited to, the creator of the mouse painting and NFT (“Artist”), the blockchain the NFT is on (“NFT-Chain”), and an identifying value for the digital element (“no. 0001”). Meanwhile, the status representation may clarify the present state of the NFT (“alive mouse”). Process 1700 may also embed (1730) a DAV physical interface into the physical representation of the NFT. In a number of embodiments of the invention, this may be done by implanting a QR code into the back of the mouse painting. In affirming the connection between the NFT and painting, Process 1700 can associate (1740) the NFT's DAV with the physical representation of the NFT in a database. In some embodiments, the association can be performed through making note of the transaction and clarifying that it encapsulates both the mouse painting and the mouse NFT.

While specific processes are described above with reference to FIGS. 15-17, NFTs can be implemented in any of a number of different ways to enable as appropriate to the requirements of specific applications in accordance with various embodiments of the invention. Additionally, the specific manner in which NFTs can be utilized within NFT platforms in accordance with various embodiments of the invention is largely dependent upon the requirements of a given application.

Robust Selective Removal of Content from Ledgers

In several embodiments, a robust method allows for selective removal of content from ledgers. Robustness can refer to a capability to verify the validity of a ledger, or portions thereof, in light of portions of the ledger having been modified. Modification can be by removal, correction, and/or other markups. In many embodiments, modifications can only be performed by select entities. Select entities can include (but are not limited to) national governments, certified authorities, and/or other entities. In certain embodiments, the existence of a modification event having taken place can be publicly detectable. This can prevent abuse in which time-stamped ledger entries are modified without the occurrence of the modification being possible to detect. Thus, in several embodiments, a robust method allowing selective removal of content from ledgers can prevent abuse, and can maintain time-stamping and verifiability of the ledger.

In various embodiments, a ledger can be verified as being authentic (as opposed to corrupted) by determining that each closing of the ledger is performed relative to ledger entries between two closings of the ledger. In numerous embodiments, this relationship can be expressed in the form of a cryptographic hash of all the applicable ledger entries that can be interpreted as a challenge used for the calculation of the ledger closing. In several embodiments, ledger closings can be performed in conformance with the Bitcoin mining protocol, and/or by another method. Other methods for ledger closings in accordance with a variety of embodiments of the invention are described in co-pending U.S. patent application Ser. No. 17/806,725 entitled “Grinding Resistant Cryptographic Systems and Cryptographic Systems Based on Certified Miners” filed Jun. 13, 2022, the disclosure of which is incorporated by reference herein in its entirety.

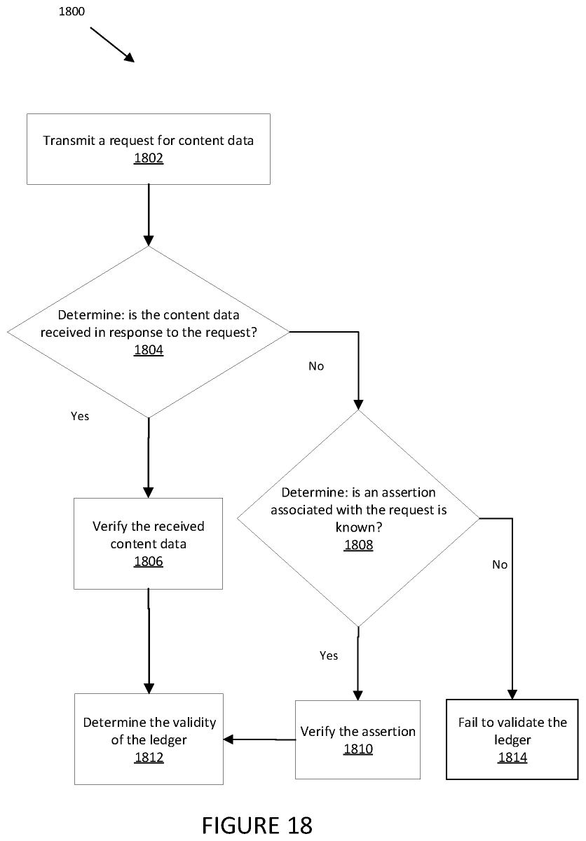

In some embodiments, a cryptographic system can include a robust method for selective removal of content from ledgers. A method can include validating a ledger as authentic after content has been removed from the ledger. An example process for validating a ledger with unavailable content is conceptually illustrated in FIG. 18.

A process 1800 can transmit (1802) a request for content data. In various embodiments, content data can be stored on a ledger. In several embodiments, references to content data can be stored on a ledger. In some embodiments, a ledger entry can include a reference associated with content data. The reference can be associated with a pre-approved service provider. The pre-approved service provider can resolve requests for the reference in various ways, e.g., by conveying the location of storage of the content data requested, by acting as an intermediary that requests the data from a location of storage associated (e.g., storing) the data requested, etc.

The process 1800 can determine (1804) if, in response to the request for the content data, the content data is received. If content data is received, then the content data is verified (1806). In some embodiments, verifying the content data includes computing a hash of the content data, and comparing the result to a content data authentication value. In several embodiments, a ledger entry can include a commitment to content data to be stored. The commitment to the data can be a content data authentication value. Content authentication values in accordance with certain embodiments of the invention can be used in verification by computing the hash of the data (e.g., content data), and comparing the result to the authentication value. If the comparison results in an equality, then the verification succeeds.

If the content data is not received in response to the request, (e.g., there is a timeout or an error), then it is determined (1808) whether an assertion associated with the request is known. A response to a request can include an assertion. Assertions in accordance with various embodiments of the invention can be an indication from the responder that the content data has been made unavailable by an authority. If the assertion is known, the process 1800 can verify (1810) the assertion. In some embodiments, verifying the assertion includes computing a hash of the assertion, and comparing the result to an assertion authentication value. The assertion authentication value can be a commitment to the assertion. In several embodiments, a commitment to the assertion can be included in a ledger entry. If the comparison results in an equality, then the verification can succeed. The successful verification of the assertion can correspond to a valid unavailability (e.g., not available at all, not available to the requestor, etc.) of the content data. A commitment to an assertion can be a cryptographic hash of the assertion. In various embodiments, the assertion can be a digital signature of an authority (e.g., the digital signature of an entity authorized to make content unavailable). The assertion can be unique to the ledger entry or to a collection of related ledger entries.

Based on a successful verification, either by 1806 or 1810, one or more ledger entries can be validly used as an input to the computation of a challenge. The validity of the ledger can be determined (1812) by verifying whether a closing of the ledger was completed correctly with respect to the computed challenge. In several embodiments, the challenge can be computed from a reference (e.g., the reference with which the content data is associated), the commitment to the data, and/or the commitment to the assertion. In various embodiments, if the content data is not available but the assertion value is presented, the challenge can be computed and used for verification of the ledger. If the ledger is determined to be not corrupted then the ledger can be accepted. A ledger can be determined as not corrupted when either of the two commitments associated with the ledger entry are determined to be valid. The ledger can be determined as valid independently of whether the content data associated with the reference is available.

If no content data is received, and no assertion is known, the process 1800 can fail (1814) to validate the ledger.

In many embodiments, content data associated with a reference can be stored by a process associated with a pre-approved service provider. The service provider can act as an intermediary. In several embodiments, the content data can be stored with a third-party entity that provides the data upon request. A reference to the data can be stored in a ledger entry. The third-party entity can be required to satisfy a requirement. The requirement can be an availability to guarantee that most requests are successfully responded to, that most requests are responded to within a pre-determined timeframe, and/or another requirement. The pre-approved service provider can act as a cache for commonly requested documents, thereby limiting the need to contact the third-party entity.

In several embodiments, it is important to provide immutability for legal content, but at the same time enable the blocking or redaction of content that is illegal. Content can be deemed legal or illegal based on local jurisdiction.

In a number of embodiments, the resolution of the reference, when requested from a service provider, can result in a different service provider being contacted. The selection of the contacted service provided can be based on the jurisdiction and the associated rules for resolving the address of the request (e.g., using locally managed Domain Name Service (DNS) resolution services). In many embodiments, the pre-approved service provider can store at least some of the content data. In several embodiments, a pre-approved service provider, that acts as an intermediary, can be a DNS. The DNS can act in accordance with a local jurisdiction.

In several embodiments, requests are resolved in accordance with rules associated with a jurisdiction. Jurisdiction-based control can be implemented in a variety of manners. In a number of embodiments, the network (e.g., using a blockchain) can prevent local storage of blocks based upon a real physical storage location of the blocks. In several embodiments, the network (e.g., using a blockchain) can prevent local storage of blocks based on the location of the computation system accessing a real physical storage location of the blocks.

In many embodiments, block modification can be controlled by the process accessing and controlling the network blocks stored at the real physical storage location. Block modification can include a block being eliminated, hidden, encrypted, relocated within the chain or to another chain, and/or prevented from access. In several embodiments, blocks, parts of blocks, or representations thereof, can be stored locally in jurisdictions. These jurisdictions can block any activity other than providing consensus that the integrity of the blockchain is proper. In many embodiments, blocks containing illegal content can be encrypted in those jurisdictions where it is necessary to prevent access to the underlying content. In jurisdictions that prevent even encrypted versions of illegal content, the block content can be left blank with provisions loaded into the block configuration to again ensure consensus of blocks located in different jurisdictions can be maintained. Several embodiments can allow a locally blank content block to recuse itself from a particular consensus round, or to request consensus results for that block from a trusted network peer.

In many embodiments, jurisdictional control can be provided at the destination whereby illegal data is prevented from being communicated to the local destination. Jurisdictional control at the destination can be executed by communication filters. Communication filters in accordance with a number of embodiments of the invention can be executed by router hardware, network software, or destination applications such as browsers and applications intending to access locally illegal content by policy. Various embodiments can support the ability to change ledger content in a pseudo-immutable manner based upon changes to local jurisdictional rules.

In several embodiments, the storage used for storing content data can correspond to a traditional server with associated hardware storage units, or it can correspond to a distributed storage facility, including cloud storage, decentralized storage, or a distributively managed storage. Distributively managed storage can be storage where individual users or organizations commit to storing data items or portions thereof, and then serve the stored data in response to requests.

While specific processes for validating a ledger with unavailable content are described above, any of a variety of processes can be utilized for validating a ledger with unavailable content as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to validating a ledger with unavailable content the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes as discussed herein.

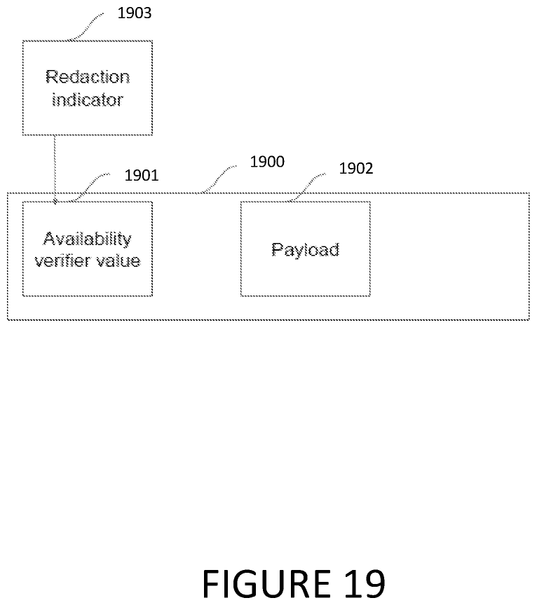

A cryptographic system can include ledger entries. Ledger entries in accordance with various embodiments of the invention can be data structures that allow redaction of a payload and robustly log the change. An example of a ledger entry configured to allow redacting a payload associated with a ledger entry is conceptually illustrated in FIG. 19. Processes for generating a ledger entry can be executed by a computer system (e.g., a miner or a verifier). Ledger entries can be stored in computer memory. A ledger entry 1900 can include a payload 1902. The payload 1902 can be content or a reference to content. The ledger entry 1900 can also include availability verifier value 1901. The verifier value 1901 can be determined based on a redaction indicator 1903. In some embodiments, an availability verifier value can be computed as a one-way function (e.g., SHA-256) of a redaction indicator. Redaction indicator 1903 is generated using a pseudo-random generator or a random generator. In various embodiments, a redaction indicator is a value that is not anticipatable by an observer. In some embodiments, the redaction indicator can be generated by an entity that posts ledger entry 1900. The redaction indicator can be retained for purposes of future redaction (e.g., self-redaction) of a payload. In this example, redaction indicator 1903 is not part of the ledger entry 1900 when ledger entry 1900 is posted.

A verifier of ledger entry 1900 can determine the validity of ledger entry 1900 by determining that ledger entry 1900, including payload 1902 and availability verifier value 1901, has been properly time-stamped. In several embodiments, determining the validity of a ledger entry can include verifying that the closing of the ledger uses a challenge computed from ledger entry 1900.

The entity posting ledger entry 1900 can redact the entry 1900. The entity can redact the entry 1900 by disclosing the redaction indicator 103. In several embodiments, redaction indicator 1903 can be stored in addition to availability verifier value 1901.

After the redaction indicator 1903 has been disclosed, a verifier can verify the validity of ledger entry 1900 in the same way as described above. Upon determining that redaction indicator 1903 is a proper preimage to availability verifier value 1901 (e.g., by applying SHA-256 to the redaction indicator 1903), comparing the result to availability verifier value 1901 and finding these to be the same, the verifier determines that the content associated with ledger entry 1900 should not be accessible. If payload 1902 is a reference to content, such as a URL to the location of the content, then determining that redaction indicator 1903 is valid will make the verifier not serve the content corresponding to payload 1902 to an entity requesting this. If the verifier stores the content associated with the payload 1902, it can erase the content associated with the payload 1902.

In several embodiments, when a redaction indicator is made available (e.g., the payload is redacted) then the redaction indicator can be stored in the ledger entry instead of the availability verifier value. Based on the redaction indicator, a verifier can generate the availability verifier value, as described elsewhere, and proceed with the verification using the computed availability verifier value. While specific systems including ledger entries configured to allow redacting a payload associated with a ledger entry are described above, any of a variety of systems including a ledger entries configured to allow redacting a payload associated with a ledger entry as appropriate to the requirements of specific applications. In certain embodiments, components can be arranged and included in any order or sequence not limited to the order and sequence shown and described. In a number of embodiments, some of the above components may be omitted or rearranged. Although the above embodiments of the invention are described in reference to systems including ledger entries configured to allow redacting a payload associated with a ledger entry the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

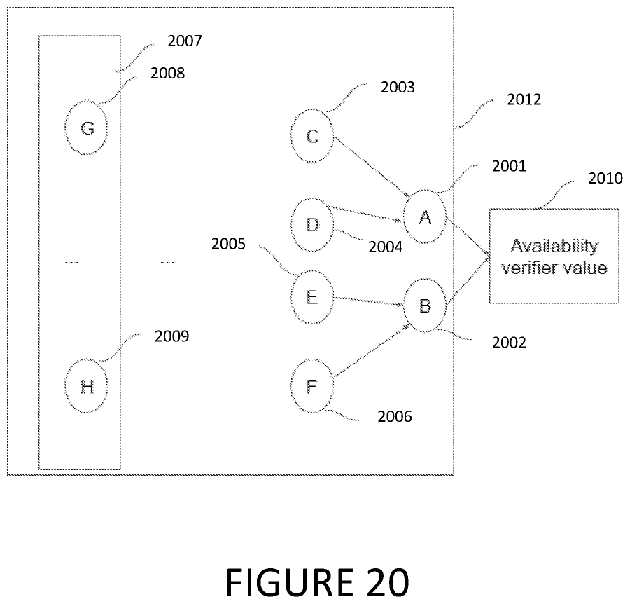

In various cryptographic systems, availability verifier values can be based on Merkle trees. An example of a process for generating an availability verifier value with an incorporation of a Merkle tree is conceptually illustrated in FIG. 20. A process for generating an availability verifier value can be executed by a computer system (e.g., a miner or a verifier). A Merkle tree (e.g., Merkle tree 2012) can be incorporated with a ledger entry and its associated availability verifier value (e.g., availability verifier value 2010). In several embodiments, the availability verifier value could be availability verifier value 1901. (as also illustrated in FIG. 19). The process 2000 can generate the availability verifier value 2010 by iterated application of a one-way function (e.g., SHA-256), to leaf values 2007 (e.g., leaf value G 2008, leaf value H 2009, and others), and internal nodes computed by iterated application of the one-way function, such as internal nodes C 2003, D 2004, E 2005, F 2006, A 2001 and B 2002 can be computed from the leaf values 2007 in a manner consistent with the generation of a Merkle tree.

For example, the value of an internal node A 2001 can be computed by a SHA-256 function of the concatenation of the value of internal node C 2003 and the value of internal node D 2004. Similarly, and as the arrows show, verifier value 2010 can be computed from internal node A 2001 and internal node B 2002 (e.g., by application of SHA-256 to the concatenation of these values).

A Merkle signature on a message M can be generated by computing SHA-256(M) and disclosing the leaf values in accordance with the result of that computation. A variety of approaches of encoding the hash of the message are known, as will be appreciated by a skilled artisan. The selected leaf values and internal node values known to be needed for the verification of the Merkle signature can be published to release the signature on M. In some embodiments, a first set of leaf values (e.g., a first set of leaf values 2007) are used to encode the message M. A second set can be used to sign one or more other Merkle trees. In various embodiments, the message M can be a redaction indictor. The message M can be a declaration by a trusted entity in charge of redaction that the content associated with an availability verifier value should not be transmitted, stored and/or rendered. In some embodiments, the message M can encode a mark-up, such as a forward reference, and/or other information.

While specific processes for generating an availability verifier value with an incorporation of a Merkle tree are described above, any of a variety of processes can be utilized for generating an availability verifier value with an incorporation of a Merkle tree as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generating an availability verifier value with an incorporation of a Merkle tree the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

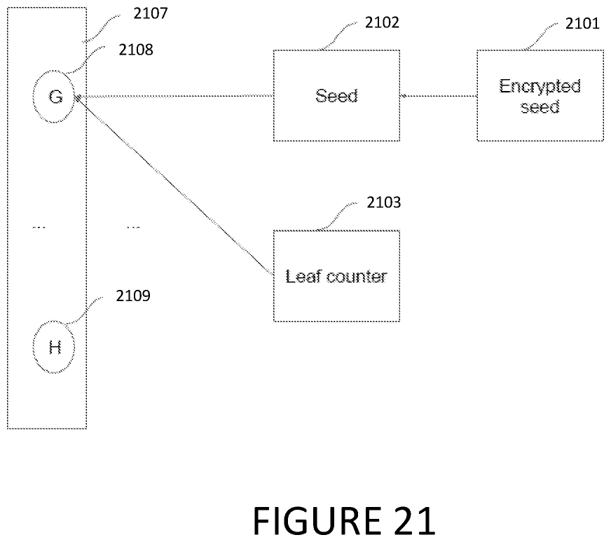

In various cryptographic systems, a Merkle tree can be generated based on a seed. The seed can be based on a ledger entry. An example process for generating leaf values based on a seed incorporated in a ledger entry is conceptually illustrated in FIG. 21. Processes for generating leaf values can be executed by a computer system (e.g., a miner or a verifier). Leaf values 2107 can be generated from a seed 2102 and a leaf counter 2103. The seed 2102 can be represented by the encrypted seed 2101. The encrypted seed can be a value. The encrypted seed can be in a ledger entry. The encryption to generate an encrypted seed can be performed with respect to a trusted third-party entity's key (e.g., public key). A trusted entity can generate the seed 2102 from encrypted seed 2101. The leaf values 2107 can be generated based on the seed 2102. Many methods are available for generating the leaf values based on the seed. In an example method, the first leaf value G 2108 can be computed by applying a one-way function to seed 2102 and a leaf counter 2103, where leaf counter 2103 is set to a first value (e.g., 1). The second leaf value H 2109 can be computed by applying a one-way function to seed 2102 and leaf counter 2103, where leaf counter 2103 is set to a second value (e.g., 2). The second value can be based on the first value. The second value can be an increment of the first value.

While specific processes for generating leaf values based on a seed incorporated in a ledger entry are described above, any of a variety of processes can be utilized for generating leaf values based on a seed incorporated in a ledger entry as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to generating leaf values based on a seed incorporated in a ledger entry the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

In some embodiments, a ledger entry can include a reference associated with a pre-approved service provider. The pre-approved service provider can resolve requests for the reference by conveying the location of storage of the data requested, or by acting as an intermediary that requests the data from a location of storage associated (e.g., storing) the data requested.

In certain embodiments, a ledger entry can include a commitment to an assertion. A commitment can be a cryptographic hash of the assertion. The cryptographic hash can be keyed. A hash function is keyed when the hash function is computed based on a message (e.g. m) and a secret key (e.g. k). The result of a keyed hash function can be a value that equals hash(m,k). Verifying keyed hashes can require both a message (e.g. m) and a secret key (e.g. k). Keyed hashes can be the same as message authentication codes (MACs). A message authentication code can be a symmetric-key version of a digital signature. In several embodiments, the assertion can be a digital signature of an authority. The assertion can be unique to the ledger entry or to a collection of related ledger entries. In several embodiments, a ledger entry can include a commitment to the data (e.g., content data) to be stored. The commitment to the data to be stored can be an authentication value. The authentication value can be verified by computing the hash of the data (e.g., content data), and comparing the result to the authentication value.

In several embodiments, a ledger entry can include a reference to data. The reference can encode a hash of the data. In some embodiments, a request for the data can be made by making a request relative to the reference. The request can be communicated to an entity (e.g., an intermediary). The entity (e.g., intermediary) can determine whether the request should be served. Determining whether the request should be served can be based (at least partially) on whether the reference has been placed on a blocklist. If it is determined that the request should be served, then the request is resolved (e.g., by serving the data being requested or by forwarding the request to a location where the data is stored, thereby causing the resolution of the request). If it is determined that the request should not be served, then a denial value can be transmitted in response to the request. A denial value can include an HTML error value indicative of the unavailability of the data, and/or a digital signature of an authority on the reference value.

In many embodiments, a requestor (e.g., an application making the request, such as a browser), can determine that there was an error and determine whether the denial value is a valid digital signature, by the authority, on the requested reference value. If the digital signature is valid, the requestor can cache the negative response or an indication thereof, thereby avoiding having to make the request again in response to a user request.

In some embodiments, a service denial can be time-limited. If a service denial is time limited the indication of the negative response will only be stored for an indicated duration. After the indicated duration, a new request can be made, and a new determination can be made by the intermediary. As described elsewhere, an intermediary can, in several embodiments, be co-located with a DNS resolution service. An intermediary can also, in certain embodiments, be part of a gateway unit. The gateway unit can perform traffic inspection, and as such, can implement rules (e.g., jurisdiction-based rules) local to an enterprise, community, family or other entity wishing to impose restrictions on content. Such entities can obtain blocklist information from third-party entity sources that curate such blocklists.

In several embodiments, a ledger can be verified based on computing challenges from references to data (e.g., content data). In many embodiments, verification is not based on computing challenges from the data. Verifying that the ledger closings of the ledgers are valid, (e.g., conform with the requirements of the mining approach or other ledger technology) can be based on challenges based on references to the data. In a number of embodiments, the validity of a ledger entry can be determined based on receiving data that, when hashed, corresponds to the encoding of the reference. In several embodiments, the validity of a ledger entry can be determined based on receiving a valid digital signature, generated by an authority, on a reference value. Some embodiments can allow either approach to validate a ledger entry.

In several embodiments, a blocklist can use a probabilistic storage method to store a very large number of binary classifications, corresponding to whether items are legal or not, in a fixed-size vector. The probabilistic storage method can be a Bloom filter. In some embodiments, avoiding false positives, corresponding to the mistaken classification of a reference as being associated with illegal material, can be achieved based on additional storage methods used to list all blocked items. Probabilistic storage methods can allow very fast determinations to be made with a very limited storage requirement for the filter that implements the blocklist membership determination. The determination that a reference is not on the blocklist can be particularly fast to make.

In many embodiments, the determination of whether to resolve a request can be made in real-time or near real-time. The determination can be based on, for example, anomaly detection methods and methods used to flag higher-than-usual fraud risks based on contextual information. The system can use an expert system comprising rules indicating high-risk situations, a machine learning (ML) or artificial intelligence (AI) element that identifies situations associated with risk based on training using examples of previous high-risk situations.

In many embodiments, blocking decisions can be made local to a given jurisdiction, enterprise, family, or other unit of membership for which there is a capability to filter requests. A capability to filter requests can be implemented by the use of a gateway, router, anti-virus filter performing packet analysis, DNS server, and/or other systems.

In certain embodiments, processes can perform post-publication markups of data time-stamped using the ledger entry data structures described herein. For example, one element of a ledger entry can be a pair of data items. A first data item can be a random seed. A random seed can be encrypted using a trusted entity's public key. A second data item can be a root of a Merkle tree generated from a set of leaf values. The set of leaf values can be leaf values generated using a pseudo-random generator. The pseudo-random generator can be instantiated with the random seed of the first data item.

In several embodiments, at a first time, a posting entity can create the first data item and the second data item. The posting entity can post the ledger entry to the ledger. At a second time (e.g., at a later time), a mark-up can be created by the posting entity or by the trusted entity. The created mark-up can be associated with the ledger entry. In numerous embodiments, mark-ups can be hashed using a cryptographic hash function, and the resulting value can encode leaf values of the Merkle tree to reveal. The associated revealed leaf values along with the appropriate node values of the Merkle tree encode a Merkle signature. The Merkle signature can be verified using the already published second data item (e.g., Merkle tree root) described previously. Merkle tree signatures are disclosed in the 1998 publication titled “A Digital Signature Based on a Conventional Encryption Function” by Ralph C. Merkle, which is incorporated by reference in its entirety.

In certain embodiments, no encrypted seed is included in the ledger entry. Still, a mark-up can be used to add a note to a previous record. A note can be an indication that the storage of data has been moved to another location, as indicated by the mark-up. The mark-up in accordance with various embodiments of the invention can also be used to reference a more recent ledger entry (e.g., by hashing a reference to the more recent ledger entry instead of hashing a reference to the mark-up).

In several embodiments, the ledger entry structure described can allow the incorporation of references that point to ledger entries that took place after the ledger entry in which the mark-up is used as a reference. Multiple mark-ups can be added to a record by use of a Merkle tree that has a sufficient number of leaves for three signatures. The first signature can be used to sign a mark-up value, as described above, and the other two signatures can be used to sign two new Merkle trees. Each new Merkle tree can have sufficient leaves for three signatures. Accordingly, using a Merkle tree that grows logarithmically in depth of the number of current markups, any number of mark-ups can be added to a ledger entry after its publication. A skilled artisan will be able to construct many alternative versions of this disclosed methods (e.g., using Merkle trees of other sizes).

In a number of embodiments, a trusted entity can use a mark-up function to label the data associated with the ledger entry. Labelling the data can, for example, be used to indicate that the data fails to meet legal requirements (e.g., legal requirements associated with a jurisdiction), and the reason for this failure. Labelling the data can be used in combination with the other features disclosed herein (e.g., a method in which ledger entries can be blocked from being served when they are found to not be legal).

In some embodiments, a mark-up function can be used to indicate that a ledger entry is not legal in a given jurisdiction, and to block the serving of the content.

In several embodiments, the ability to block content storage retroactively, without affecting the validity of the ledger, can be used by posting entities. The posting entity can enable, at the time of posting, a later retraction. In various embodiments, the retraction can be performed by exposing one or more Merkle leaf values, and the associated verification path. This can create a self-signed authorization. The self-signed authorization can be signed by the posting entity to retract the reference to the content data the material. The disclosure of such a value can be interpreted, by entities storing the referenced data, as a request to no longer to store the referenced data; it will also be interpreted, by intermediaries, such as described above, to cause such content not to be served.

In many embodiments, a cryptographic system with ledger entries capable of self-censorship can also prove self-censorship is not possible for a given ledger entry. In some embodiments, a posting entity can prove, to observers, that retroactive retraction associated with a ledger entry is impossible by omitting the Merkle tree root in the ledger entry. In certain embodiments, a Merkle tree root can be substituted with a value that can be verified not to be a Merkle tree root (e.g., the value can be a hash of another element in the ledger entry). Since hash collisions cannot be determined with a non-negligible probability, this serves as a proof of a future inability to retract. A skilled artisan will recognize that there are many variations on this method, such as replacing the Merkle root with a value with a pre-specified redundancy (such as having a value and a checksum of the value) that will not occur but with a non-negligible probability, for actual Merkle root values.

The cryptographic system associated with a ledger entry configured to enable retraction can be used with a variety of consensus protocols, such as (but not limited to) the Proof-of-Work (PoW) approach used in Bitcoin, or the consensus protocol used in Streamlet (as described in the 2020 post titled “Stream let: An Absurdly Simple, Textbook Blockchain Protocol” by Benjamin Chan and Elaine Shi, available at decentralizedthoughts.github.io/2020-05-14-streamlet/.), Proof-of-Space systems (as disclosed in U.S. Pat. No. 11,017,036 entitled “Publicly Verifiable Proofs of Space”, issued on May 25, 2021, or co-pending U.S. patent application Ser. No. 16/743,503 entitled “Robust and Secure Proof of Space Based Mining” filed Jan. 15, 2020 by Markus Jakobsson), Proof-of-Stake systems, Proof-of-Bus systems, and/or other consensus mechanisms. The cryptographic system associated with a ledger entry configured to enable retraction can be used with systems for increasing a cryptographic system's resistance to grinding attack. Various approaches to improving resistant to grinding attacks are disclosed in co-pending U.S. patent application Ser. No. 17/806,725 “Grinding Resistant Cryptographic Systems and Cryptographic Systems Based on Certified Miners” filed Jun. 13, 2022 by Markus Jakobsson, which is hereby incorporated by reference. The term retraction can be equivalent to redaction, or making unavailable.

In many embodiments, control over accessibility and blocklists can be distributed among hierarchically arranged entities (e.g., admin) to control access to an element using a consensus mechanism. Each admin can be allocated a number of votes. The consensus mechanism can be based on a quorum of admins voting on the accessibility of each identified element. An identified element can be an element identified as potentially breaking the rules for a local jurisdiction in consideration. In some embodiments, the majority vote of the admins determines the accessibility of each identified element.

In many embodiments, at the completion of the vote, an action can be taken. The action can be to block or unblock an element. Elements can be selectively blocked. For example, an element can be blocked for access by some users and not others. Access rights in accordance with some embodiments of the invention can be associated with a geographic location asserted by or associated with a requesting entity, or with an access control list (ACL). In various embodiments, a user can prove access based on a location by use of a distance bounding protocol, such as disclosed by Brands and Chaum in the 2001 publication “Distance Bounding Protocols,” which is incorporated by reference in its entirety.

In several embodiments, a user can use a certificate generated by a trusted entity to prove rights to access an element. In some embodiments, a user can prove knowledge of a private key relative to a certified public key by use of a zero-knowledge proof to prove rights to access an element. The use of zero-knowledge proofs in accordance with many embodiments of the invention are disclosed in the 2001 publication entitled “Designated Verifier Proofs and Their Applications” by Markus Jakobsson, Kazue Sako and Russell Impagliazzo, which is incorporated by reference herein in its entirety. In a number of embodiments, access can be controlled by selective erasure of secrets use to control decryption and access. Selective erasure of secrets in accordance with many embodiments of the invention are disclosed in the 2002 publication entitled “How To Forget a Secret” by Giovanni Di Crescenzo, Niels Ferguson, Russell Impagliazzo and Markus Jakobsson, which is incorporated by reference in its entirety.

In many embodiments, selective undoing of financial transactions can be performed. In several embodiments, the content data referenced by a ledger entry can be transaction data. Transactions can be retroactively blocked. Retroactive blocking of transfers can be the same as selectively undoing transfers.

In several embodiments, the determination of whether to block the access to data and whether to undo a transaction can depend on different jurisdictional (or other types of) entities, and require different quorums. In certain embodiments, ledger entries can be automatically classified in terms of their content. For example, a cryptographic system can determine whether a ledger entry is a time-stamping of a provisional patent application, a transfer of NFT access rights, a publishing of an executed contract, or a transfer using a crypto currency. A ledger entry can be classified. A classified ledger entry can be subjected to a policy based on the classification. The classification can determine what type of modifications are allowed on a given entry. This classification can be, for example, that no changes are allowed, that only markups are allowed, that redaction/blocking/cancelling is allowed, and more. In various embodiments, the classification can be local to a jurisdiction. For example, content may be blocked in a first jurisdiction and not blocked in a second jurisdiction. Blocking can relate to either the storage of content or the access to the content, as disclosed herein. If a first jurisdiction undoes a first transaction but a second jurisdiction does not, this means that the first jurisdiction does not recognize the first transaction whereas the second does. This is simply a special case of current laws by which Bitcoin™ is legal in some jurisdictions but not others, and does not cause internal inconsistencies for transfer schemes.

In several embodiments, a second type of classification (e.g., actor classification) can be made. Actor classification can identify what type(s) of entity can be allowed to take actions, on content. Actor classifications in accordance with numerous embodiments of the invention can be based on a local jurisdiction policy associated with the location of access or transfer. In a variety of embodiments, actor classifications can be expressed as a policy that is enforced by consensus mechanisms.

In some embodiments, an actor classification can identify that in a first jurisdiction there is first requirement for an action, and in a second jurisdiction there is a second requirement for an action. For example, an actor classification can identify that in a first jurisdiction, the quorum for one action can include a body of at least 10 out of 15 government-controlled trusted entities, and in a second jurisdiction the quorum for one action can to a majority of miners expressing consensus. In various embodiments, consensus can be based either on a local policy held by the miners; by the conveyance of a governmental edict declaring the legality (or lack thereof) for a given blockchain entry, collection of such entries; or the publication of a government-certified policy that can be automatically applied to ledger entries by miners and verifiers to determine the legality of a given item.

Alternatively, a requirement for an action can be the generation of a value by a trusted entity. The value could be a digital signature or other proof as described herein.

### Security and Privacy Enhancements

It can be a low-cost effort to determine, for a transferee in a crypto transfer scheme, what ledger entry a transfer corresponds to. Accordingly, it can be a low-cost effort to “track backwards” to verify the validity of the associated ledger entry. This can be done for each transfer received, and is computationally low-cost since the entry for the new transfer can include a reference to the ledger entry of the transferor token (e.g., a backwards reference to the block that can include the public key associated with the public key of the wallet used for the transfer).

However, to answer a question of what wallet (if any) was being paid for a given recorded token and associated public key associated with the transferor can typically be more computationally demanding, as it could, in principle, correspond to any ledger entry that was made after the ledger entry associated with the establishment of the token potentially used to pay with. This token can correspond to a recently minted token (e.g., be formed by the closing of a ledger by a miner) or it can correspond to the receipt of a transfer by a user. Given the volume of transfers, and ledger entries in general, this is a daunting task. This is also the reason why it is very costly, bordering infeasible at times, to track transfers that are made with the intention of obfuscating the source or destination. Accordingly, criminals commonly perform such series of transfers. By maintaining movement of tokens by constantly transferring tokens to new wallets, corresponding to new public keys, criminals can evade detection this way. However, honest users do not benefit accordingly, as they cannot generally keep secret the link between their wallet identifier (such as its public key) and identity (or other handle, such as email address). Accordingly, it is desirable to improve crypto transfer schemes to remove the opportunity for abuse by criminals. A range of methods are disclosed to prevent abuse; a skilled artisan will appreciate that variations of the disclosed methods are straightforward.

In several embodiments, a backwards link can be detected. A backward link can be a reference made in a token transfer to the source of the tokens. The source of the tokens can correspond to a public key, a block reference, and more of the wallet or ledger entry of the transferor. The entity that detects the link can report it. Reporting the link can include associating a transferor token and/or the associated ledger entry with a transferee token its associated ledger entry.

In many embodiments, reporting the link can correspond to saving, in a storage associated with the token that is used for the transfer, information about the destination of the transfer. The information about the destination of the transfer can be indicated by an identifier of the ledger entry where this is recorded. The information can be memorialized by adding the information as a markup of the transferor ledger entry. Adding information as a markup is discussed elsewhere herein.

In a number of embodiments, reporting the link can include storing, along with the ledger entry of the transferor, information about the forward link, which can be a reference to the ledger entry or public key of the transferee. In some embodiments, when a transfer is made to two (or more) recipients and associated public keys, these public keys can be stored with the forward link.

In several embodiments, reporting of a forward link can be encouraged by associating a reward with it. Associating a reward can rely on bounty hunters to identify and report the forward link. The notion of bounty hunters was disclosed in U.S. Pat. No. 11,017,036 entitled “Publicly Verifiable Proofs of Space” issued May 25, 2021, which is incorporated by reference in its entirety; additional aspects of bounty hunters were disclosed in co-pending U.S. patent application Ser. No. 17/806,065 entitled “Systems and Methods for Maintenance of NFT Assets” by filed Jun. 8, 2022 by Markus Jakobsson, Stephen C. Gerber and Guy Stewart, which is also incorporated by reference in its entirety. Bounty hunters are further discussed herein.

In several embodiments, a newly generated token can be stored with a first identifier (e.g., a 2048-bit identifier, a ciphertext). The identifier can include the encrypted identity of the owner of the tokens. The encrypted identity can be decrypted by a trusted entity. Once a forward link is reported for this token, the identifier can be removed and replaced with forward reference (e.g., a 256-bit string). This method can improve the privacy of token holders since historical token ownership can be erased and only current token ownership be maintained. The method can also reduce the amount of storage space required.

As described elsewhere herein, the validity of a ledger entry can be verified in multiple ways. In several embodiments, a ledger entry can be verified by verifying that the encrypted data is of a given format, such as having a certification of corresponding to a real-life user. The certification can be generated by one or more trusted entities and can be associated with a first identifier. In many embodiments, verification of a ledger entry can include verifying an existing and valid forward reference. In some embodiments, other information or no information can be stored in the place of the identifier (e.g., first identifier).

By associating forward links with all or a large number of tokens that have been used, the effort of tracking transfers in the forward direction can be vastly improved, thereby reducing the capabilities of criminals to take advantage of the complexity of tracking to hide their tokens and tokens transfers. In some embodiments, the work of verifying is borne by bounty hunters that verify the transfer (e.g., as they process a ledger entry for other reasons). The reporting can also be made by the transferor, to which the backwards reference is immediately known. If 1/100th of a token, for example, is always allotted to a reward for generating and recording the forward link, then transferors can choose whether they wish to report the forward link or pay the inherent cost of letting a bounty hunter perform this task. Bounty hunters are further discussed herein.

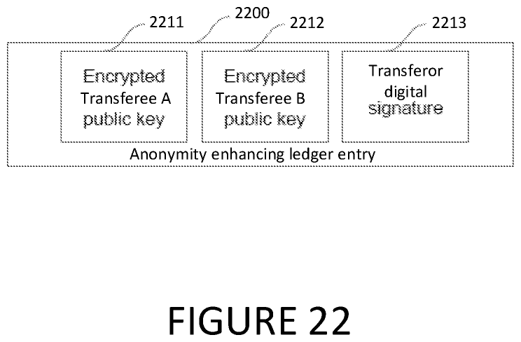

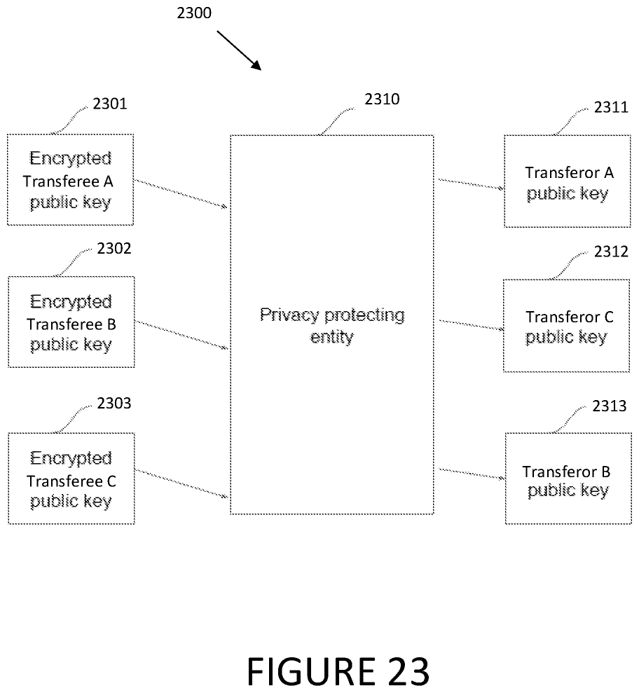

In several embodiments, a cryptographic system for improving user privacy can include an anonymity enhancing ledger entry structure. An example anonymity enhancing ledger entry is conceptually illustrated in FIG. 22. In various embodiments, the anonymity enhancing ledger entry can be generated, transmitted, and/or stored by a transferor, a miner and/or a verifier. The anonymity enhancing ledger entry 2200 can include encrypted transferee A public key 2211, encrypted transferee B public key 2212 and a transferor digital signature 2213. The digital signature 2213 can be verified with the transferor public key, on a message that can include encrypted transferee A public key 2211 and encrypted transferee B public key 2212. The encryption can use a public key related to the mix network illustrated in FIG. 23.

While specific systems including anonymity enhancing ledger entries are described above, any of a variety of systems including anonymity enhancing ledger entries as appropriate to the requirements of specific applications. In certain embodiments, components can be arranged and included in any order or sequence not limited to the order and sequence shown and described. In a number of embodiments, some of the above components may be omitted or rearranged. Although the above embodiments of the invention are described in reference to systems including anonymity enhancing ledger entries the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

In many embodiments, an anonymity enhancing ledger entry structure associated with a cryptographic system, can include encrypted transferee public keys. In many embodiments, a mix network process can be used to decrypt the encrypted transferee public keys. An example process for using a mix network to decrypt an encrypted transferee public key is depicted in FIG. 23. A mix network can include one or more entities that are trusted to protect the privacy of honest users. The trusted entities can trace transfers that are identified as being illegal. The mix network corresponds to a privacy protecting entity 2310. The privacy protecting entity can include multiple independent entities. The multiple independent entities can interpolate the private key corresponding to the public key used for encryption of input ciphertexts. The privacy protecting entity 2310 can receive encrypted transferee A public key 2301, encrypted transferee B public key 2302, and encrypted transferee C public key 2303, to the privacy protecting entity 2310. In some embodiments, one, two, three or more encrypted transferee public keys can be received by the privacy protecting entity. The received public keys being k inputs to the privacy protecting entities. A quorum of the multiple independent entities included in the privacy protecting entity 2310 randomizes the order of the k inputs in one or more steps, and decrypts the order-randomized input ciphertext, thereby outputting a randomized order list of plaintext values, corresponding to transferee A public key 2311, transferee C public key 2312 and transferee B public key 2313. In various embodiments, a privacy protecting entity (e.g., privacy protecting entity 2310) can outputs a zero-knowledge proof of correct mixing. The zero-knowledge proof of correct mixing can be a proof of correspondence between the inputs and the outputs. One example zero-knowledge proof that can be used is disclosed in the 2002 publication “Making Mix Nets Robust For Electronic Voting By Randomized Partial Checking” by Markus Jakobsson, Ari Juels and Ronald L. Rivest, which is incorporated by reference in its entirety. In various embodiments, the output plaintexts (e.g., public keys 2311, 2312, and 2313) can be ordered in dictionary order, by the associated public keys of the transferees. A skilled artisan will appreciate that other mix network technologies can be used instead, both of the type that re-randomizes ciphertexts and the type that decrypts ciphertexts as the order randomization takes place. A skilled artisan will also appreciate that since partially decrypted elements appear random, they can be lexicographically ordered by consecutive layers of the mix network instead of being randomized, thereby reducing the reliance of sufficiently strong randomness.

Improving privacy in transfer systems without enabling criminal activity is discussed in the 1997 PhD thesis entitled “Privacy vs. Authenticity” by Markus Jakobsson, which is incorporated by reference in its entirety. To solve this problem in the context of ledger-based transfers, the techniques disclosed in the 1999 publication entitled “Mix-Based Electronic Transfers” by Markus Jakobsson and David M'Raïhi, can be used; this is also incorporated by reference in its entirety.

In several embodiments, the entries of an open ledger can be identified in terms of their type. A number of the entries can be for transfers, while other entries may not be for transfers. For a transaction to obtain k-privacy, the system can require that there are at least k transfers associated with an open ledger before the ledger can be closed. K-privacy can correspond to the notion of hiding something among k transactions. In some embodiments, if there is not a sufficient number (e.g., less than k transactions) and a time-out occurs (e.g., every 20 minutes), then the observed transfers can be pushed to the next open ledger for inclusion. In various embodiments, the ciphertexts (e.g., the encrypted transferee public keys) can be digitally signed using the transferor private keys. After at least k such ciphertexts are collected (corresponding to at least k transfers being made) the ledger can be closed. After closing the ledger, the k ciphertexts can be processed as disclosed in the 1999 publication entitled “Mix-Based Electronic Transfers” by Markus Jakobsson and David M'Raïhi, resulting in the associated k transferee public keys being output. In various embodiments, the processing of the ciphertexts is performed by a quorum of entities that are part of a privacy protecting entity. An example mix network that can be used is described in the 2010 publication “Deterring Voluntary Trace Disclosure in Re-encryption Mix-Networks” by Philippe Golle, Xiao Feng Wang, Markus Jakobsson, and Alex Tsow, which is incorporated by reference in its entirety.

In various embodiments, to support fractional token transfers, tokens can be broken up into fractions. For example, each token can be made into 16 identical-size transfers to unique public keys associated with the one or more transferees, where the transferor can also be a transferee. Thus, in this example, 1/16 of a token will be paid to the public key of each of the holders of the public keys that are output by the mix network.

Privacy protecting entities can be implemented in a variety of ways, as disclosed in co-pending U.S. patent application Ser. No. 17/808,264 entitled “Systems and Methods for Token Creation and Management” filed Jun. 22, 2022 by Markus Jakobsson and Stephen C. Gerber, which incorporated by reference in its entirety.

While specific processes for using a mix network to decrypt an encrypted transferee public key are described above, any of a variety of processes can be utilized for using a mix network to decrypt an encrypted transferee public key as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to using a mix network to decrypt an encrypted transferee public key the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

### Probabilistic Aggregation of Bounty Hunter Rewards

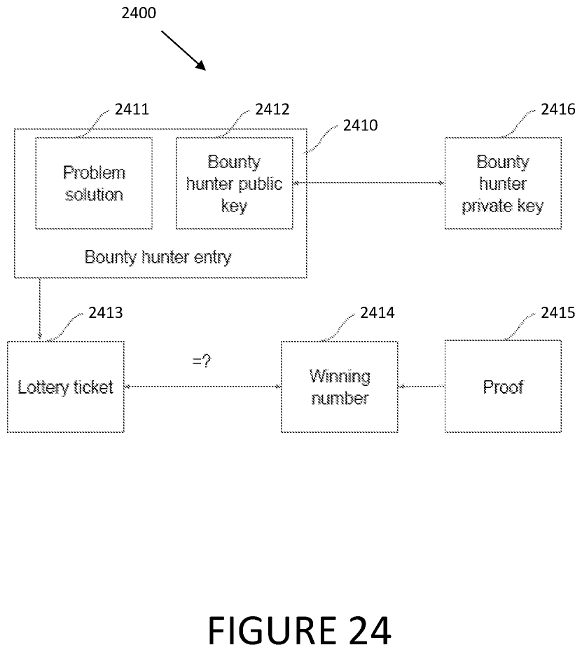

As described elsewhere herein, bounty hunters can perform tasks and receive rewards. In some embodiments, rewards may be probabilistically aggregated. An example process for distributing probabilistically aggregated rewards to bounty hunters is conceptually illustrated in FIG. 24. In some embodiments, processes for distributing probabilistically aggregated rewards to bounty hunter can be executed by miners. Process 2400 can receive a bounty hunter entry 2410. The bounty hunter entry 2410 can a problem solution 2411 to a problem that the bounty hunter claims to have solved, and bounty hunter public key 2412 associated with the bounty hunter (e.g., the corresponding bounty hunter private key 2416 is known by the bounty hunter). Based on the bounty hunter entry 2410, a lottery ticket 2413 can be generated. The ticket 2413 can be generated as a function of the representation of bounty hunter entry 2410. The process 2400 can close a ledger on which the bounty hunter entry 2400 is recorded. Closing the ledger can include generating a proof 2415. In various embodiments, the generated proof can be a proof or work, a proof of space, a proof of knowledge, or another proof. Based on the proof 2415, a winning number 2414 can generated. In several embodiments, the winning number 2414 can be generated by selecting a portion of a proof, hashing the proof, and/or by another method. The winning zero, one, or more lottery tickets can be determined based on the winning number 2414.

A process can receive (e.g., from a bounty hunter) evidence of a winning lottery ticket. Evidence of a winning lottery ticket can include in the form of the proof 2415, the associated winning number 2614 matching a pre-set portion of lottery ticket 2413; along with bounty hunter entry 2410. A verifier can determine that the lottery ticket 2413 is correctly generated from bounty hunter entry 2410. The verifier can determine that the lottery ticket 2413 matches the computed winning number 2414. As the verification is performed, the verifier will know that the public key 2412 associated with bounty hunter entry 2410 is associated with an amount of tokens. In some embodiments, a bounty hunter can digitally sign a message using a bounty hunter private key. The digital signature can be verified based on a corresponding bounty hunter public key. By signing a message that can include a transferee public key (not shown), an amount of tokens can be transferred to the holder of the associated private key (also not shown).

In numerous embodiments, a bounty hunter can be sent tokens in a probabilistic manner or in a non-probabilistic manner for performing a task. In several embodiments, a non-probabilistic transfer can be performed, by a smart contract specifying a task. The smart contract can initiate a transfer based on the provision of evidence, by the bounty hunter, of having performed the requested task. In several embodiments, a determination of the provision of evidence can be made using a consensus mechanism. The consensus mechanism can include a collection of verifiers (e.g., miners) agreeing that the task has been performed.

In many embodiments, a probabilistic transfer can be made. In a probabilistic transfer, as described in connection to FIG. 24 a bounty hunter can generate entries. Each bounty hunter entry can correspond to a problem solution associated with a completed task, and a public key associated with a bounty hunter. Each bounty hunter entry can be used to generate a lottery ticket. Each lottery ticket can be recorded or referenced before a ledger closes. As the ledger is closed, a value obtained in response to the closing of the ledger can be used to select winning lottery tickets. For example, a bounty hunter can identify forward links. Forward links can identify transfers being made from a previously recorded token, and associate such forward links in a manner that is associated with the previously recorded token. Each forward link can be a problem solution for inclusion in a bounty hunter entry. A lottery ticket can be generated based on a bounty hunter entry. In some embodiments, a lottery ticket can end in the series of bits (e.g., 1011001, 0000110). Multiple lottery tickets recorded at the same time can end in the same series of bits. As a ledger that is open at the time the forward links are recorded is closed, the closing of ledger also can be expressed as a closing value. The closing value can end in a series of bits (e.g., 0000110). In some embodiments, all the lottery tickets, with an ending series of bits matching an ending series of bits associated with the closing value are winning lottery tickets. For any ledger closing there can be zero, one, or more winning lottery tickets. The winning lottery tickets can be identified by a process. Based on a consensus (e.g., by miners or other verifiers) tokens can be transferred to bounty hunter public keys associated with the winning lottery tickets. In various embodiments, the probability of a lottery ticket being a winning lottery ticket is 1/(2\hat{ }(the number of matching bits required)). The notion of probabilistic rewards can be used in contexts other than for bounty hunting. For example, probabilistic rewards can be used to probabilistically aggregate many microtransfers into one larger sum. Uses of microtransfers are disclosed in the 2004 publication “Peppercoin Microtransfers” by Ronald L. Rivest, which is incorporated by reference in its entirety.

While specific processes for using a distributing probabilistically aggregated rewards to bounty hunters are described above, any of a variety of processes can be utilized for distributing probabilistically aggregated rewards to bounty hunters as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to distributing probabilistically aggregated rewards to bounty hunters the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

### Secure and Intelligent Decentralized Technology

In several embodiments, miners can have an incentive to store the blockchain. An incentive mechanism can cause the storage of the blockchain. The absence of an incentive structure to store the entries linked from the blockchain in a decentralized storage can hamper the deployment and use of blockchain supporting rich media. That, and related problems, are addressed herein. One embodiment for creating immutable storage is to incentivize entities to store relevant data, and to respond to requests for such data.

In several embodiments of the invention, features of composite cryptographic systems can be used with a machine learning (ML) or artificial intelligence (AI) mechanism that is controlled using consensus mechanisms. Examples of composite cryptosystems in accordance with many embodiments of the invention are described in U.S. patent application Ser. No. 17/806,060, entitled “Composite Cryptographic Systems with Variable Configuration Parameters and Memory Bound Functions”, filed Jun. 8, 2022, the disclosure of which is incorporated by reference herein in its entirety. Using such techniques, two or more constituent cryptographic systems can be associated with each other. The interaction of the two or more constituent cryptographic systems can be controlled by configuration parameters. Configuration parameters in accordance with various embodiments of the invention can be changed automatically consensus mechanisms. For example, two mining paradigms such as Proof or Work (PoW) and Proof of Space (PoS) can be combined and their relative portion of the associated composite cryptographic system can be adjusted in an automated manner. Consensus mechanisms can also be used to adjust the configuration parameters of constituent cryptographic systems of a composite cryptographic systems to create an evolving system.

In several embodiments, the evolving system can implement a distributed learning system. The distributed learning system can be based on machine learning (ML) or artificial intelligence (AI) mechanisms that are controlled using consensus mechanisms. The distributed learning system can be a mechanism to update parameters and connections in ML and AI. The collection of parameters that expresses connections and weights in accordance with many embodiments of the invention can be encoded in an intelligent token. In some embodiments, intelligent tokens can be used with token hierarchies, including (but not limited to) the creation and interaction of token hierarchies. In various embodiments, intelligent tokens can consume and generate various forms of tokens and data. Tokens, token hierarchies, creation and interaction are disclosed in co-pending U.S. patent application Ser. No. 17/808,264 entitled “Systems and Methods for Token Creation and Management” filed Jun. 22, 2022, the disclosure of which is incorporated by reference in its entirety.

In some embodiments, models specifying the functionality of miners and verifiers can include ML and/or AI systems that rely on distributed learning for their maintenance and/or to better respond to changing situations. In several embodiments, a collection (e.g., distributed collection) of intelligent elements can be filters. The filters can consume and generate data. Filters in accordance with various embodiments of the invention can use distributed learning to enable collective modification of the functionality of a cryptographic system. Modification of a cryptographic system can be achieved by varying one or more configuration parameters. In certain embodiments, filters can be used to create adaptive security models. The adaptive security models can react to threats on the network based on current, recent and past observations.

In various embodiments, intelligent tokens can be static (e.g., unchanging with time). In some embodiments, intelligent tokens can be dynamic (e.g., changeable over time). An intelligent token can represent an animated character. The animated character can adapt to its user by updating configuration data or executable code. The configuration data or executable code can be stored in the intelligent token or can be stored off-ledger (e.g., in a distributed storage system). In various embodiments, intelligent tokens can be required to adapt to updates. The updates can include (but are not limited to) updates to security details, ownership information, and log file appending.

One example update can be initiated when a large number of miners and verifiers each perform a localized update of the current parameters of an intelligent token. An update to an intelligent token can be based on training material comprising recently computed input and output values to the intelligent token. Each of the miners and verifiers, can separately determine a new set of parameters based on the same training data (e.g., training data available on blockchain). A consensus can be reached about the new parameters to use.

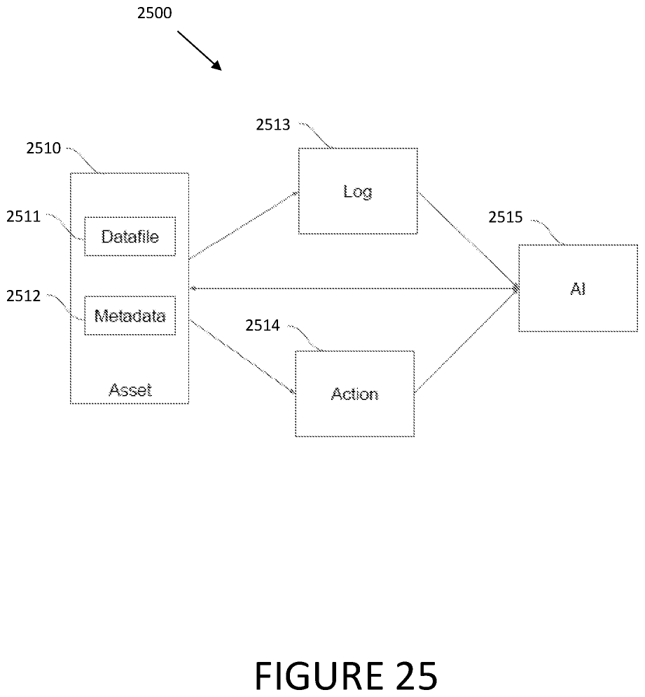

In several embodiments, an artificial intelligence or machine learning entity can access a corresponding asset. The assets can be an animated character personality or another asset. The artificial intelligence or machine learning entity can learn (e.g., train) from actions. The actions can include interactions with associated users. The asset can be improved based upon its training. An example process for updating an asset using artificial intelligence or machine learning, such as an animated character personality is conceptually illustrated in FIG. 25.

A process 2500 can access an asset 2510. The asset 2510 can include a datafile 2511. In various embodiments, the datafile can be a music file, a text document, an animated character personality, or another datafile. The asset 2510 can include metadata 2512. The metadata can be terms of use or other metadata. In an example, the asset 2510, is an animated dog personality. The asset 2510 can perform actions 2514. For example, an animated dog personality can perform actions such as listening to one or more users, and dancing while a user swipes a finger back and forth on a display. The process 2500 can receive inputs from one or more sensors (e.g., such as from a microphone, or from finger swipes) in an effort to improve the asset (e.g., the animated dog personality). The inputs can be evaluated by an AI or a ML model 2515. The model can be an AI classifier. Models in accordance with several embodiments of the invention can be trained to recognize user speech mannerisms. For example, if a user has a strong New York accent, the AI can update the datafile 2511 to respond verbally to the user with a similar New York accent during future encounters. A log 2513 of changes to asset 2510 can be time stamped. Logs in accordance with various embodiments of the invention can be part of a decentralized multi-user blockchain ledger system on which assets are embedded, or pointed to, if off-chain.

While specific processes for updating an asset using artificial intelligence or machine learning are described above, any of a variety of processes can be utilized for updating an asset using artificial intelligence or machine learning as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to updating an asset using artificial intelligence or machine learning the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

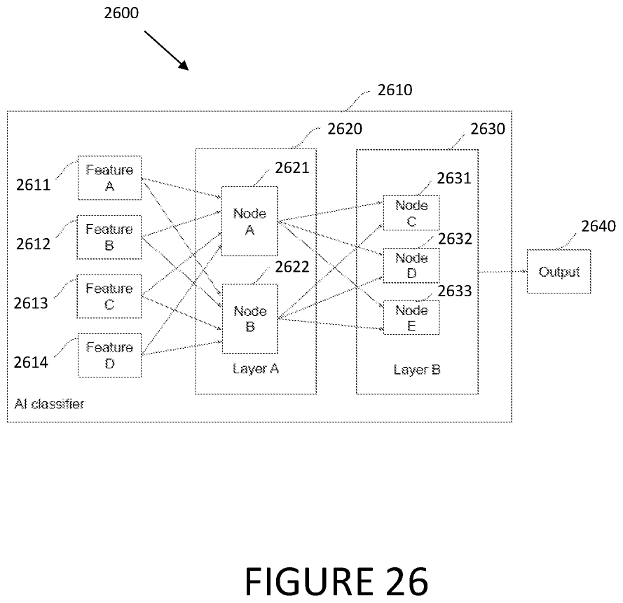

In several embodiments, an AI classifier can be trained with feature inputs, layers, weighted nodes, and an output. An example of an AI classifier is conceptually illustrated in FIG. 26. AI classifier 2610 includes four features—feature A 2611, feature B 2612, feature C 2613, and feature D 2614. In some embodiments, feature extraction can be a part of the classifier 2610. The feature extraction can also be performed separately. Each feature can describe a different characteristic. Feature A 2611 can describe the image object color, feature B 2612 can describe the texture, feature C 2613 can describe the hue, and feature D 2614 can describe the pixel to pixel variation.

The features can be input to a sequence of hidden layers of neural network processing. The number of layers can vary between embodiments. Each layer, layer A 2620 and layer B 2630 can contain nodes, such as node A 2621, node B 2622, node C 2611, node D 2632, and node E 2633. Each node, can include a weight. A weight can be a value between 0 and 1 corresponding to the match between an input image and an associated training value. The weights can be used to determine an output 2640. In the example, the output can be a value of either an apple or an orange. The number of layers (e.g., layer 2620, 2630), the number of nodes (e.g., nodes 2621, 2622, 2631, 2632, 2633), and the weights at each hidden layer node can reside within ledger entries on a ledger (e.g., blockchain).

While specific processes for updating an asset using an AI classifier are described above, any of a variety of processes can be utilized for AI classifier as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to an AI classifier the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

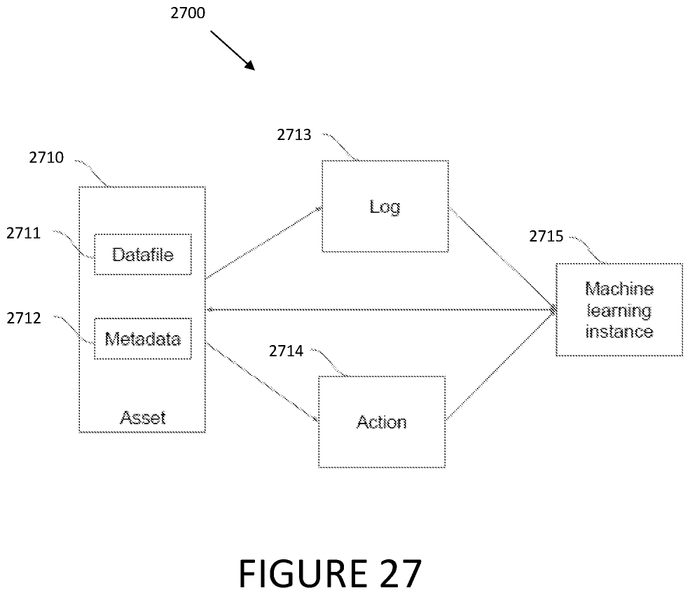

An example process for using an artificial intelligence or machine learning entity to adjust security requirements based on a shift in security posture is conceptually illustrated in FIG. 27. A security posture can be a quality of a security situation of a device. A quality of a security situation in accordance with some embodiments of the invention can be determined based on how recently an anti-virus has been updated, on recent downloads, and/or on other factors. An asset 2710 can include a datafile 2711. The datafile can be a music file containing digital rights management (DRM) features. The asset 2710 can include metadata 2712, such as (but not limited to) terms of use. The asset 2710, which in this case is a music file, is accessed by a user and an action 2714 is automatically executed. The action can be a DRM action. A DRM action can be to not play a file because a royalty has not yet been paid, to degrade a file before it is rendered since the premium version has not been purchased, to record what user rendered the content and whether it was rendered from beginning to end or partially, to determine that the content is not allowed to be rendered on a given monitor (such as a monitor in a home for content intended for a movie theatre), and/or other actions. Actions in accordance with certain embodiments of the invention can be monitored by machine learning instances and a DRM action can be detected at a specific IP address. The specific address can correspond to a mobile smart phone, and/or to a specific user name. The specific address can be known to the asset 2710. The machine learning instance 2715 can update the security posture within asset 2710 to enable a login-free song access for a given period of time from the same device and IP address. The DRM actions and the machine learning security posture updates can be recorded in log 2713 for future use. The log 2713 can be stored in a ledger entry on a ledger.

While specific processes for updating an asset using an artificial intelligence or machine learning entity to adjust security requirement based on a shift in security posture are described above, any of a variety of processes can be utilized for using an artificial intelligence or machine learning entity to adjust security requirement based on a shift in security posture as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to using an artificial intelligence or machine learning entity to adjust security requirement based on a shift in security posture the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

Storage Associated with a Blockchain

In some embodiments, a decentralized storage pseudo-immutable dual blockchain includes two or more blockchains. The two or more blockchains can each be associated with a cryptographic system. The two or more blockchains can be interconnected. A first blockchain can be supported by a consensus mechanism. The first blockchain can serve as an index to one or more secondary chains. Secondary chain(s) can contain and protect resources, such as NFT assets.

Providing an incentive to store the block can be insufficient to assure the immutability of the data, as an entity that has promised to store data can fail to do so, whether intentionally (e.g., selling space that does not exist) or accidentally (e.g., suffering a hard drive crash). A combination of incentives and penalties can be used to increase the resilience of the data. Intentional erasure can be subjected to penalties. To prevent loss of data, replication can be used.

In some embodiments, replication can mean to create multiple copies of each data item. However, that is a very coarse-grained approach that does not permit gradual increases of assurance. In some embodiments, error-correction can be performed on a file or on a series of segments of a file. In this way, a file can be expanded to various extents, where a greater degree of error correction will correspond directly to a greater degree of expansion of the file or file segment. Such error-corrected files or file segments can then be broken into parts and distributed to multiple entities. The entities can store the expanded elements. For example, a 100 MB file can have error correction performed. The error corrected file can grow to 130 MB. This error corrected file can then be split into 15 equal-size pieces, where any 12 of these can allow a reconstitution of the original file.

In various embodiments, the storage of a file piece can be either a successful event (if the same piece is returned in response to a request at a later time) or an unsuccessful event (if the same piece is not returned in response to a request, or no response at all is generated). Correlation of unsuccessful events (e.g., five pieces not returned) is undesirable. In several embodiments, methods are used to prevent multiple associated pieces from being stored on a single piece of storage, or on storage in the same physical facility.

In some embodiments, each storage facility can be associated with a number (e.g., such as a value between 1 and 10,000). Multiple facilities can be associated with the same number. No two file pieces associated with the same expanded file can be stored on one or more facilities with the same number. Combined with an incentive mechanism, the resulting system improves distributed storage by reducing storage waste, and/or improving robustness against accidents and/or intentional failures.

In a number of embodiments, an incentive mechanism associates a reward with the storage of a data element such as one of the file pieces described above, where the storage entity obtains a reward in a periodic manner. The reward can be a token reward, or a reputational reward. The mechanism can include a penalty associated with failing to respond to requests within a predefined response time. The penalty can be a token penalty or a reputational penalty. Different storage entities can offer different terms with regards to required awards, allowed penalties, and/or acceptable response times to avoid a penalty. An entity can be associated with multiple pairs of values of penalties and delays, where increasing delays (or absence of a response) can be associated with increasing penalties.

In some embodiments, an entity requesting to have data stored can select a degree of redundancy. The degree of redundancy can be expressed as an amount of error correction, and/or a degree of replication. The requesting entity can determine (e.g., select) minimum penalties, acceptable delays, and/or minimum reputational thresholds for storing entities. The storing entities can be units for storing information. The requesting entity requirements can be conveyed along with a request to store data. The request to store data can be associated with or can include the data to be stored.

In several embodiments, a matching can be performed to match one or more storing entities to the request to store data. The storing entities can be associated with terms and policies. The terms and policies can include (but are not limited to) minimum penalties, acceptable delays, and other information. The terms and policies can be set by the entity wishing to receive requests to store data.

In certain embodiments, one or more bounty hunters can receive notification of the terms and the policies associated with a matched request to store data. The one or more bounty hunters can probe the one or more storing entities to determine their compliance with the policies. Based on the probe, a bounty hunter can determine that a failure to store is detected. When a failure to store is detected, the whole file can be reconstituted by a service provider from the remaining pieces. Based on the reconstituted whole file, any lost pieces (e.g., lost due to the failure to store) can be reconstructed and stored with a one or more new storing entities (e.g., based on a match).

In several embodiments, a file record can identify the locations and unique identifiers of the various pieces corresponding to a file. New requests to store data can cause an update to a file record. Each file piece can be encrypted to block access to unauthorized entities. Decryption keys can be stored by the entity to whom the file belongs, and/or be outsourced for storage. Storage of the decryption keys can include maintaining secret the correspondence between the decryption key and the encrypted file. Digital rights management (DRM) policies and trusted execution environment (TEE) requirements can be used to control access to key material.

In several embodiments, file migration can include a file being reconstituted and at least one portion of the file being stored in a new location. File migration may be complete or partial. Files can migrate for various reasons. In some embodiments, when a first entity offering storage services with a first specified assurance and associated with first specified terms unloads some of its storage, the first entity can transfer the storage of some data to a second entity that provides storage services meeting or exceeding the terms agreed to. The transfer of some data to a second entity can be based at least partially on a smart contract.

In many embodiments, when a migration is performed, the access information, which is a reference to the file element, can be updated. In some embodiments, the access information can be referenced from a container. The container can include the stored data. Entities with access to the storage container can transmit update notifications to the services hosting the references.

In various embodiments, each file element (e.g., file piece) can be associated with an identifier related to the original file. The association can include (but is not limited to) a URL or a domain. Accessing the identifier and/or the association information can enable the determination of location information. The location information can include where the individual file pieces are stored. An entity storing a file component (e.g., file piece), can access the location information using the URL, domain, ledger entry or in another way. The accessing entity can receive a list of components in response, or receive access to a service that can determine the locations of the components. Based on the location information, a requesting storage provider can identify what file piece reference pertains to the information it stores, and cause this to be updated.

In several embodiments, an entity can request an update of references. A request can include a token. The token can identify the requesting entity as having the right to make the update request. The token can demonstrate that the requesting entity corresponds to the entity that performs the storage. Demonstrating that a requesting entity corresponds to a storing entity can be performed using a challenge-response approach. In the challenge-response approach the requester can be sent a message including a nonce. Access to the nonce can prove that the requester is the entity with the right to make the update request. These methods can be useful for preventing abuse.

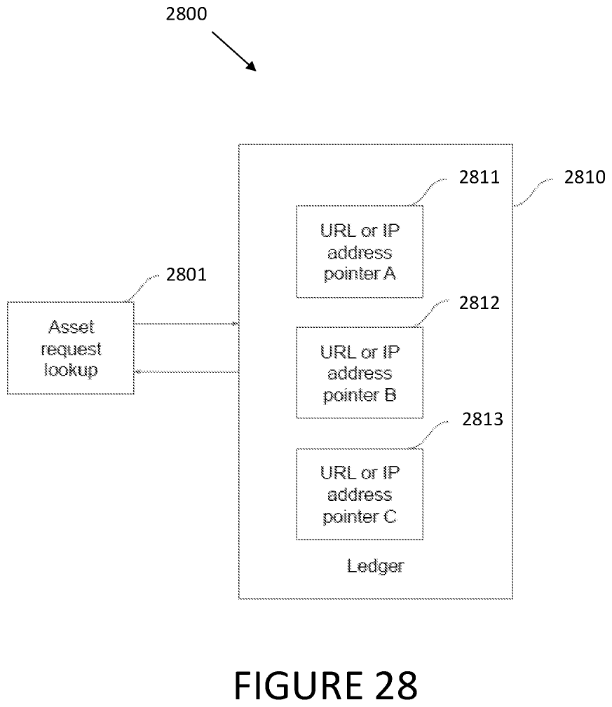

In several embodiments, an off-chain resource can be requested. Pointers to the URL or IP address of the off-chain resource can be stored on a ledger (e.g., a distributed ledger, a blockchain). An example process for requesting an off-chain resource is conceptually illustrated in FIG. 28. The process 2800 can include sending an asset request lookup (2801) to request to locate a media file asset associated with an NFT. A ledger 2810 can be accessed. A response can be received. The response can include one or more pointers. In this example, a response can include URL or IP address pointer A 2811, B 2812, and C 2813. In several embodiments, the one or more pointers can be provided with a priority. In some embodiments, the priority can be inferred by the order of the response.

In several embodiments, storing rich media using blockchain can require storing a reference on a blockchain. The reference (e.g., a URL, an IP address, etc.), such as a URL, can be stored on a blockchain and can be associated with an asset. In some embodiments, a reference can include multiple URLs or IP addresses. Multiple URLs or IP addresses can be used if the asset is stored in pieces. One or more references can be added to a ledger entry. In certain embodiments, ledger entries can be closed by a miner, thereby timestamping the entry.

In various embodiments, the URL can include a domain name. When the URL includes a domain name, the URL needs to be resolved to an IP address. In some embodiments, the URL can use an IP address instead of a domain. In various embodiments, a DNS service used. In many embodiments, to strengthen the system against failure of DNS or failure to maintain a particular DNS registration, the reference can include two or more elements, where each of the elements is an address or other reference. In some embodiments, references can have a preferred order. The order can correspond to the order in which the references should be used. The lower ranked options can be used as a fail-back if there is a time-out.

In various embodiments, multiple URLs can be included as references and can be used in an order. The order can be determined based on a priority ranking transmitted with the URLs. In many embodiments, one or more of the references can include an IP address. A reference with an IP address can be used while bypassing a DNS. In several embodiment's, URLs can have equal priorities. URLs with equal priorities can be selected based on the preferences of a requestor. The requestor can select a more local or favored source for reasons such as latency and load balancing.

In some embodiments, there can be multiple references including ranked URLs, IP addresses, and/or domain-based addresses. The ranked list of references can be stored as multiple elements, which can be sent to a browser or other application by an operating system in an order corresponding to the ranking. In a number of embodiments, multiple simultaneous sessions can be started at the same time, each such session corresponding to a separate reference (e.g., URL or IP address). In some embodiments, the reference can be a meta-reference including an array of references. A browser or app can parse the meta-reference to extract the component references. A browser or app can select from among the component references, according to a policy that specifies the order and the time until a new reference is tried. In some embodiments, multiple references can be used in parallel attempts.

In some embodiments, data can be received based on a request for data. The request for data can be based on the reference in a ledger (e.g., blockchain). The data can be received from a server. The server can be an entity that can locate the requested data. The requested data can be stored in a distributed database. The requested data can correspond to one or more collaborating servers associated with the URL in the ledger entry. To incentivize storage entities to store data associated with the reference, the data to be stored can be associated with tokens. The tokens can be contract tokens. The contract tokens can specify rewards. The rewards can be claimed by successfully storing data. The data can be stored using error correcting methods as described herein. In some embodiments, rewards can be claimed after a gatekeeper entity probes the storage entities at a random time according to a recurring schedule. If no response is given or the server does not store valid information, a penalty can be assessed. Verification of valid information can be determined using a message authentication code or other authentication information.

While specific processes for requesting an off-chain resource are described above, any of a variety of processes can be utilized for requesting an off-chain resource as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to for requesting an off-chain resource the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

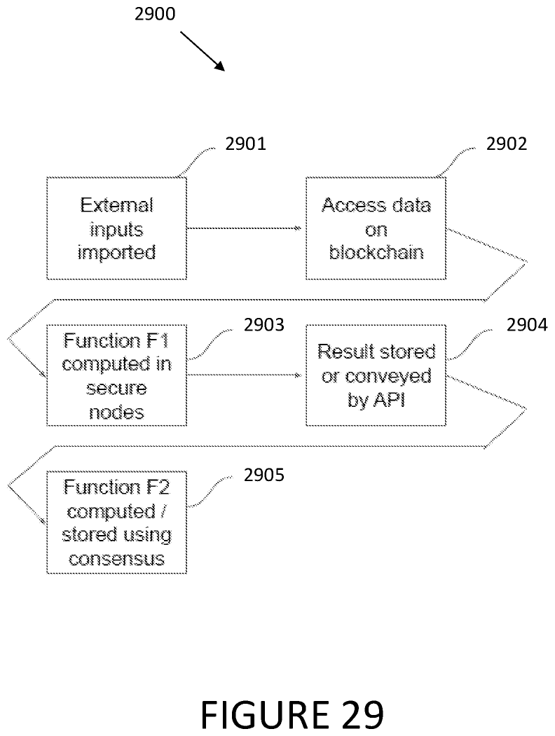

In various embodiments a function can be computed in part on secure nodes, and in part using a consensus mechanism. In some embodiments, secure nodes can be centralized entities. In several embodiments, functions are computed partially by decentralized entities and partially by centralized entities. In several embodiments, a function can be computed in two steps. A first step can be computed in secure nodes. The second step can be computed and/or stored using a consensus mechanism. An example of a process for computing a function computed with a first step computed in secure nodes and a second step computed and/or stored using a consensus mechanism is conceptually illustrated in FIG. 29. The process 2900 can import (2901) external inputs. In several embodiments, the external inputs can be integrated. Techniques for integrating external inputs are disclosed in U.S. Provisional Patent Application No. 63/229,924 entitled “Integration of Real-World Data and Measurements into Distributed and Consensus-Based Environments” filed Aug. 5, 2021 by Markus Jakobsson, which is incorporated by reference in its entirety. The external inputs can be off-chain inputs. The process 2900 can access (2902) data stored on a blockchain. Process 2900 can compute (2903) function F1 using secure nodes and based on the external inputs and the accessed data stored on the blockchain. The secure nodes can be computational nodes corresponding to security requirements. The security requirements can be selected by the process. Computational nodes in accordance with numerous embodiments of the invention can include TEEs or use DRMs meeting a required standard. The result of the computation of the function F1 can be a state. Process 2900 can store (2904) the result on the blockchain or otherwise made available (e.g., conveyed by API) to other computational nodes. For example, the state can be conveyed over an API after access control verifications have been performed or transfers received. Process 2900 can perform (2905) function F2 on the result described in 2904. The output of function F2 can be stored (e.g., on a blockchain). In various embodiments, F2 can be computed by miners and verifiers.

In certain embodiments, DRM policies can be associated with content containers. A content container can be a data unit. A content container can be encrypted using a symmetric key that is known by or can be acquired by a DRM-enabled computational entity. A DRM-enabled computational entity can be a computer equipped with an Intel Trusted Execution Technology, or an Apple DRM enabled device. The content container can contain a DRM policy or be associated with it. DRM policies in accordance with many embodiments of the invention can identify the conditions under which data is allowed to be extracted from the content container. In various embodiments, the DRM policy can enable access to decryption keys.

In various embodiments, a DRM policy can contain or reference to a public key pk that can be combined with a secret key sk held by the DRM-equipped device (e.g., using Diffie-Hellman key exchange technology). In some embodiments, the DRM policy can contain or reference an identifier. A shared secret key can be generated from the identifier by an access control entity. The access control entity can store a master key MK and apply a function f to MK and identifier ID to generate a symmetric key K (e.g., K=f(MK,ID)). The symmetric key can be used to decrypt content data in a content container.

In several embodiments, an entity wishing to access content data can transmit an identifier ID and a credential to the access control entity. The access control entity can be a distributed entity (e.g., a quorum-controlled distributed entity). The credential can indicate a right to access the data. The credential can include information indicating the entity has a sufficient security clearance or DRM status to access the data. The access control entity can generate K as described. The access control entity can transmit K to the requesting entity over a secure channel, after having verified the credentials. In some embodiments, an access control entity can perform a risk assessment related to the requesting entity and the information or originator associated with the identifier ID. The information or originator associated with the identifier can be information that the access control entity stores or accesses from a third entity. In various embodiments, an entity using a trusted execution environment (TEE) can have a security clearance from a third entity, such as a manufacturer or a standards body. The security clearance can include a digital certificate on a public key associated with the TEE and a security rating or other indication of degree of protection from threats. The security clearances can be associated with computational environments that are certified based on various criteria, such as (but not limited to), running up-to-date anti-virus technology, approved digital rights management modules, and/or secure operating systems.

While specific processes for computing a function computed with a first step computed in secure nodes and a second step computed and/or stored using a consensus mechanism are described above, any of a variety of processes can be utilized for computing a function computed with a first step computed in secure nodes and a second step computed and/or stored using a consensus mechanism as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to computing a function computed with a first step computed in secure nodes and a second step computed and/or stored using a consensus mechanism the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

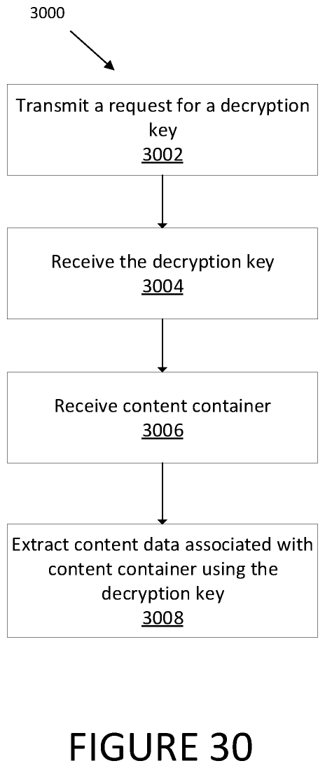

An example process for accessing content data using a decryption key is conceptually illustrated in FIG. 30. The process 3000 can transmit (3002) a request for a decryption key. The request for the decryption key can be transmitted to an access control entity. The request for the decryption key can include an identifier and a credential. The credential can indicate a clearance to access the data. The process 3000 can receive (3004) the decryption key. The decryption key can be a symmetric key (e.g., symmetric key K), or another decryption key. The process 3000 can receive (3006) one or more content containers. The one or more content containers can be associated with (e.g., contain) content data. The process 3000 can extract (3008) content data associated with the one or more content containers using the decryption key.

In many embodiments, there can be minimum requirements associated with a content container. The minimum requirements associated with a content container can be set using a policy associated with the content container. The minimum requirement can indicate which entities can access data associated with the content container.

In a number of embodiments, content data can be extracted using an obtained decryption key. The content data can be extracted in a controlled environment (e.g., a TEE or a DRM protected environment). Content can be extracted using the obtained decryption key. The content container can include policies. Policies in accordance with some embodiments of the invention can indicate permissible use. Indications of permissible use can correspond to information related to copyright and other licensing requirements. The controlled environment can control actions related to the extracted content data in accordance with the policies. For example, a policy can state that an asset cannot be redistributed in cleartext, and that the encrypted content container can be transmitted to other entities or otherwise be made public. The controlled environment can apply the policy.

While specific processes for accessing content data using a decryption key are described above, any of a variety of processes can be utilized for accessing content data using a decryption key as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to accessing content data using a decryption key the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

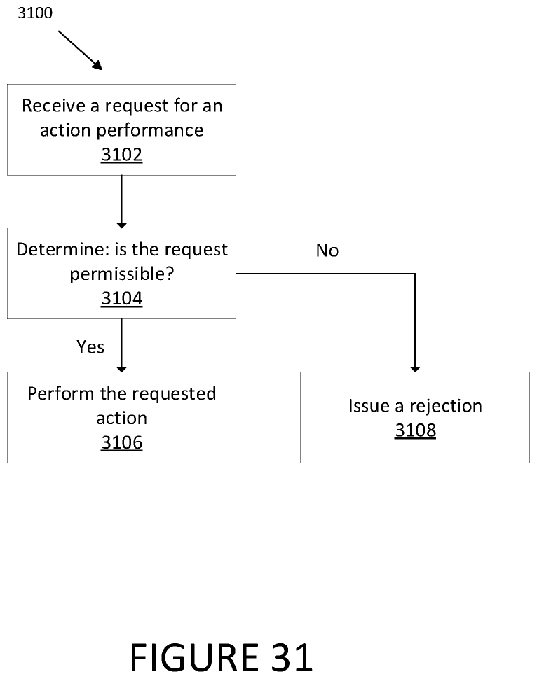

In various embodiments, controlled environments can perform actions upon request. The requests can be received from another process, a user or an application. The requests can be to render material, store material, or perform derivatives of the material. The material can be content data. An example process for performing a requested action is conceptually illustrated in FIG. 31. In various embodiments, the process can be executed by a controlled environment. A process 3100 can receive (3102) a request for an action performance. The process 3100 can determine (3104) if the action(s) associated with the request are permissible or not. The determination of permissibility can be based on policies associated with content data associated with the request. If the process 3100 determines (3104) the request is permissible, the process 3100 can perform (3106) the requested action. If the process 3100 determines (3104) the request is not permissible the process 3100 can issue (3108) a rejection. Rejections can be accompanied with error messages and/or explanations.

In some embodiments, the controlled environment can cause a configuration of a UI facing a user. The UI configuration can limit the UI to only enable requests that will be permissible. Limiting the UI can include making some buttons inactive (e.g., greyed out and not possible to click), by removing the buttons and/or replacing buttons with an indication of what actions are available. In some embodiments, an error message or notification conveyed to a user can provide the user with information of how to enable the requested action (e.g., by upgrading the license or use of another rendering unit that complies with the policy).

While specific processes for performing a requested action are described above, any of a variety of processes can be utilized for performing a requested action as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to performing a requested action the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

In some embodiments, a method is used for locating assets stored on a highly-splintered decentralized storage system. Files of certain types can be located on particular resources. Small portions of individual assets can be stored at different locations. In numerous embodiments, storage providers can elect to only store selected content types (e.g., podcasts). Storage providers can elect to not store selected content types (e.g., videos above a certain file size). Storage providers can elect to only serve assets that provide the highest financial incentives. Incentives for storage providers in accordance with a variety of embodiments of the invention are described in U.S. patent application Ser. No. 17/806,065, entitled “Systems and Methods for Maintenance of NFT Assets”, filed Jun. 8, 2022, the disclosure of which is incorporated by reference herein in its entirety. In some embodiments, a dual blockchain system can identify at least a primary asset destination and update that primary asset destination as necessary when storage resources change. Dual blockchains in accordance with many embodiments of the invention can identify an appropriate destination by smart contract. A storage provider can be incentivized to host an asset in perpetuity and can be financially rewarded at the time of the contract, and/or periodically. A dual blockchain system can reflect this contractual arrangement by maintaining a contracted provider's asset address.

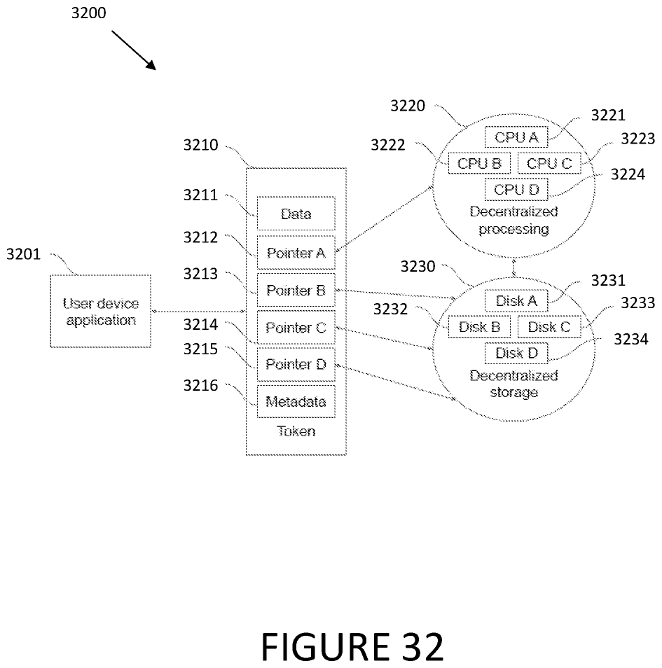

In several embodiments, a process can include a token for interacting with decentralized processing and decentralized storage. An example of accessing decentralized storage and processing is conceptually illustrated in FIG. 32. In several embodiments, various user devices can be used to access decentralized storage and processing. For example, the user device can be virtual reality glasses. In this example, user device application 3201 transmits a request to token 3210. Token 3210 can include data 3211, Metadata 3216, and pointers such as pointer A 3212, pointer B 3213, pointer C 3214, and pointer D 3215. The data 3211 can include information about a particular character personality, such as an animated dog. One or more off-ledger requests can be transmitted to one or more off-ledger resources. The one or more off-ledger requests (3203) can be based on the pointers associated with token 3210. In several embodiments, the off-ledger requests can be sent from the user device. A request for processing can be transmitted to a decentralized processing network 3220 based on Pointer A 3212. Decentralized processing network 3212 can include compute platforms of numerous varieties co-located and non-co-located. The processing systems can be personal computers, server computers, mobile device, edge IoT devices and other devices. The decentralized processing network 3212 can include CPU A 3221, CPU B 3222, CPU C 3223, and CPU D 3224. The processing systems can be personal computers, server computers, mobile device, edge IoT devices and other devices. Pointer A 3212 can indicate (e.g., select) one or more processors at random to perform the execution of an executable process (e.g., code). The code can be secure or nonsecure and the CPU can be a trusted execution environment (TEE), depending upon the needs of the request. In this example, pointer B 3213, pointer C 3214, and pointer D 3215 point to a decentralized storage network 3230. The decentralized storage system can include remote off-ledger resources including storage systems Disk A 3231, Disk B 3232, Disk C 3233, and Disk D 3234. In some embodiments, a decentralized storage system can be co-mingled with a decentralized processing system as the storage systems require CPU resources and connectivity to perform their function. From a functional perspective, the processing systems and the storage systems can be referred to separately. Pointer B 3213 can point to one or more decentralized storage locations 3230 for the purposes of maintaining an off-chain log file of token activity and requests. Pointer C 3214 can point to executable code within one or more decentralized storage locations 3230. Pointer D 3215 can point to rights management data, security keys, and configuration data within one or more decentralized storage locations 3230.

Tokens, as described in connection with various processes herein, can be used with other distributed technologies, such as (but not limited to) polynomial sharing of secret keys and/or the distributed storage of content using error correcting codes, as disclosed herein.

In various embodiments, computational entities, also referred to as computing nodes, can perform computations of inputs and state, and can store or convey state in a manner that enables other computing nodes to use the computation. Computing nodes can be included in decentralized processing networks. Computing nodes can include (but are not limited to) miners and verifiers, which together can form a consensus mechanism. Computing nodes can include script tokens, other tokens with computational capability, and processors that use such tokens. Computing nodes can be used to generate state data.

In some embodiments, computing nodes can use TEE or DRM to secure the computation. Data (e.g., state data) generated by a computing node can be stored on one or more ledgers (e.g., distributed ledgers). Generated data can be aggregated data, as disclosed in U.S. Provisional Patent Application No. 63/229,924 entitled “Integration of Real-World Data and Measurements into Distributed and Consensus-Based Environments” filed Aug. 5, 2021 by Markus Jakobsson. A generated state can be made available to other computing nodes. In many embodiments, generated states can be made available using APIs. The APIs can be secure. APIs can require authentication for access to the generated state data. In some embodiments, state data is encrypted and is only decryptable by computing nodes that are verified (e.g., verified as meeting a pre-set security standard or requirement). In several embodiments, state data can only be decrypted by a TEE that meets a set minimum security standard or brand. In some embodiments, state data can only be decrypted by a DRM with a pre-set security standard. In some embodiments, state data can only be decrypted by a bonded/insured system.

In various embodiments, assets forming part of interactive decentralized apps can be stored. The stored assets can include one or more media files, one or more logs of file changes (e.g., evolution), one or more interaction capabilities associated with the media files, and/or one or more trained machine learning models (e.g., ML and/or AI). The machine learning models can be personalized.

In some embodiments, the functionality of the ML and AI components of a token can be automatically evolved in real-time using distributed learning, and potentially, by using intelligent tokens embodying elements that are updated. In certain embodiments, two or more intelligent tokens can be configured to work with each other by pulling and pushing data using APIs or other communication interfaces. Intelligent tokens in accordance with certain embodiments of the invention can be connected in a graph form. The graph can include nodes representing scripts that are not maintained using intelligent learning. The scripts can be static. A collection of one or more nodes can correspond to distributed software. The distributed software can be compartmentalized into modules. The modules can correspond to one or more tokens associated with the nodes of the graph. The edges of the graph can correspond to connections formed between different modules. The connections can be added, removed or modified over time, in response to functional modifications. Functional modifications in accordance with numerous embodiments of the invention can be determined using the distributed consensus mechanisms. This modular, distributed, intelligent and consensus-driven system can be used to create an intelligent self-updating execution environment. The execution environment can include DRM functionality that can protect against abuses indicated by specifications. In many embodiments, specifications can be modified using the distributed learning mechanisms disclosed herein.

In several embodiments, modifications can be made in response to detections of threats, or events that are believed to be associated with threats. In some embodiments, an automatic modification can be performed in response to an indication of risk. An indication of risk can include a rapid increase in transaction volume, a rapid increase in transaction volume associated with a small number of entities. The automatic modification can change configuration parameters associated with a composite cryptographic system. Transactions can correspond to mining instances submitted, purchases made, tokens sent, requests for sensitive assets, and more. Parameters can be modified to increases security around the observed event.

In some embodiments, configuration parameters can be modified to increase the difficulty of mining in response to a detected increased mining velocity. Configuration parameters in accordance with a number of embodiments of the invention can be modified to control a percentage of transactions requiring a CAPTCHA to complete in response to a volume increase for some transaction-requesting IP addresses for which the volume is anomalous. A change in NFT creation or observation tokens can, if exceeding a threshold value, cause an increased scrutiny of such transactions. The increased scrutiny can be increased scrutiny of ownership claims for NFTs. Increased rates of complaints filed by bounty hunters can cause parameters governing the underlying aspects to be modified to reduce the risk of such events taking place. The above actions in response to conditions are examples only. In various embodiments, any of the described actions can be matched with any of the described conditions.

In a number of embodiments, graphs can include at least one selected node in which a cryptographic hash function is computed from an input message. The selected node can have a minimum reputation or a minimum insurance. Reputation and insurance in accordance with numerous embodiments of the invention is described in U.S. Provisional Patent Application No. 63/229,924, entitled “Integration of Real-World Data and Measurements into Distributed and Consensus-Based Environments”, filed Aug. 5, 2021, the disclosure of which is incorporated by reference herein in its entirety. In some embodiments, the selected node can be trusted based on the actions of bounty hunters. In certain embodiments, a second node in the graph, connected to the first node and using the state data computed by the first node, can be a distributed computation of a digital signature, using a quorum of computational nodes that are embodied on TEEs with a set DRM running on the TEE. The computational nodes can each store fragments of a secret key, where the fragments are generated and used based on polynomial secret sharing. The output of the second node can be included in a ledger entry and incorporated on a blockchain by miners and verifiers expressing a consensus. In certain embodiments, outputs can represent certifications. A certification can be a certification of the input message provided to the first node.

In some embodiments, connectors and weights associated with a ML model or an AI model can be part of the certified model. For example, the AI classifier associated with FIG. 26 can be certified.

In various embodiments, models can refer to configuration parameters using unique identifiers. The unique identifiers can be stored separately and determined and updated using a consensus mechanism, as described herein.

Automated and distributed maintenance of AI modules and ML modules can be managed using consensus-driven methods. Critical data for AI and ML modules can be stored on-chain relative to a blockchain that supports rich media, including executable content. An environment can enable feature-rich animation characters, executable content, and/or intelligent distributed technology including (but not limited to) distributed learning. The environment can correspond to an interplanetary compute system.

In some embodiments, processing resources can be decentralized, and collaboration can be governed by bounty-hunters, consensus-based mechanisms, and/or other techniques. Secure code can reside in immutable distributed blockchains. The code can be protected by cryptography. The code can be executed, parametrized and updated in a distributed processing environment. The processing can be performed using either a fragmented approach, or using a randomly selected processing environment. In some embodiments, a distributed AI can be an AI hosted on a distributed blockchain and a distributed processing network. The distributed processing network can correspond to the interplanetary compute system. The distributed AI can support a character personality that an end user can interact with on a phone, VR or AR glasses, in a car, and/or in a virtual world.

While specific processes for accessing decentralized storage and processing are described above, any of a variety of processes can be utilized for accessing decentralized storage and processing as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to accessing decentralized storage and processing the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

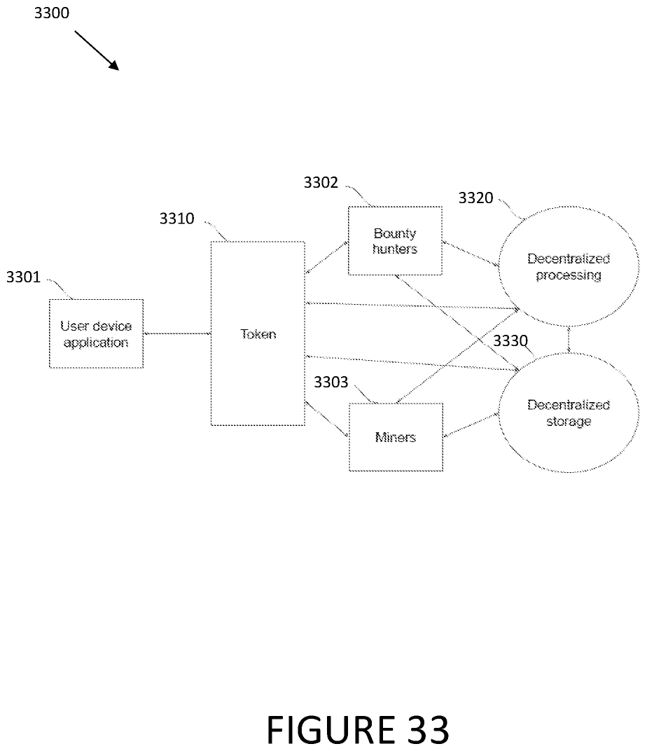

In various embodiments, a bounty hunter can monitor decentralized mining and storage systems. An example system including a bounty hunter for monitoring decentralized processing and storage systems is conceptually illustrated in FIG. 33. The illustrated decentralized processing and storage networks can be similar to the networks illustrated in FIG. 32. A user device application 3301 can make a request for token access to access token 3310. The token 3310 can point to resources. The resources can include decentralized processing network 3320 and decentralized storage network 3330. Bounty hunters 3302 can monitor the decentralized storage network 3330, the decentralized processing network 3320, and/or the token 3310. In various embodiments, bounty hunters can locate incorrect or missing data and executable code within the token or associated networks. The miners 3303 can perform minting processes and/or can provide consensus mechanisms.

In some embodiments, bounty hunters can be incentivized to help identify assets that are no longer available at their destination, as described in co-pending U.S. patent application Ser. No. 17/806,065 entitled “Systems and Methods for Maintenance of NFT Assets” filed Jun. 8, 2022, and co-pending U.S. Provisional Patent Application No. 63/229,924 entitled “Integration of Real-World Data and Measurements into Distributed and Consensus-Based Environments” filed Aug. 5, 2021, the disclosures of which are incorporated by reference in their entireties. In some cases, an asset can be no longer available at a destination due to a storage failure, or due to a functional failure in accessing stored data. A functional failure can be caused by an expired DNS registration, or a failure to resolve an access request. Failures to resolve access requests commonly occur when storage locations are changed but location references are not updated. To address this problem in the context of storage that might migrate, as described above, the updating of references can be tied to the migration of data. In some embodiments, access data can be stored with content data. The access data can describe the manner in which the content data is referenced. When the data is migrated, the reference can be updated. If there are aliases for or multiple references to one asset, one or more of the aliases or multiple references can be linked to, or stored along with the content data.

In several embodiments, smart contracts contain executable code that monitors and flags or reports problems associated with the asset, such as from abuse, unintended or unexpected asset modification, host failures, changes in ownership, illicit duplication of tokens or assets, use of an asset outside its license terms, as described in U.S. patent application Ser. No. 17/806,065 entitled “Systems and Methods for Maintenance of NFT Assets” filed Jun. 8, 2022, the disclosure of which is incorporated by reference in its entirety. Smart contracts in accordance with certain embodiments of the invention can be in the form of a token.

In various embodiments, a method for public removal of content that is jurisdictionally inappropriate or illegal, as described in U.S. Provisional Patent Application No. 63/216,662 entitled “Pseudo-Immutable Blockchain Method with Security and Privacy Enhancements” filed Jun. 30, 2021, the disclosure of which is incorporated by reference in its entirety.

One aspect of the disclosed technology is a method for detection of abuse, such as bounty hunters or vigilantes locating malware in executable tokens, as described in U.S. Provisional Patent Application No. 63/218,342 entitled “Security Against Deception and Abuse in Distributed and Tokenized Environments” filed Jul. 4, 2021, the disclosure of which is incorporated by reference in its entirety.

In various embodiments, a consensus-based blockchain can include a universal resource locator (URL) for each asset that is used in a subsequent lookup operation in a manner similar to how website URLs are permanent and the universal resource locator maps the website address to a numerical internet protocol address. For example, an asset for an image can be recorded in the blockchain as an IP address 142.250.138.101:nnnnn, where “nnnnn” can be a port number, or a filename, a filename and path, or any suitably distinguishable reference to the image.

In some embodiments, an asset can be recorded on the blockchain as a hash representation of the content. A separate resource locator can map the hash representation of the content to the current destination of the content.

In certain embodiments, an update process can be based on a third-party entity. The third-party entity can be a bounty hunter. The third-party entity can have deep knowledge in parameter tuning, and determining a new set of parameters. The third-party entity can provide new configuration parameters. The new configuration parameters can include a replacement of one computing methodology for another, the addition of nodes, layers, edges, feedback channels, or the changing of existing parameters. The third-party entity can provide superiority evidence that is evidence of the superiority of the new configuration parameters over the existing parameters. The superiority evidence can include an assessment based on recent training data. The assessment can indicate that the new configuration parameters more accurately predict a value that the intelligent token is intended to estimate and predict. In a variety of embodiments, assessments can include a simulation of configuration parameters demonstrating that the simulation results in evidence of a better fit. A better fit can be determined using a reduction of the squared error, a maximum likelihood measure, and/or another error minimization technique. When the improvement exceeds a threshold requirement, miners and verifiers can adopt the new parameter values and the consensus mechanism can update the configuration parameters of the token. When a new configuration parameter selection is submitted, no reward may be given if the new parameters closely match a previous set. This can correspond to an improvement that does not exceed a threshold requirement.

In some embodiments, a bounty hunter can commit to a suggested configuration parameter selection using a one-way function. A commitment can be time-stamped using a blockchain. The time-stamped commitment can demonstrate the origin of the new parameters, and can function as a submission of the new configuration parameters for consideration. When the new configuration parameter choices are selected, the bounty hunter can be rewarded. The bounty hunter can be rewarded reputationally, or by a transaction. The transaction can be a transfer of tokens.

While specific systems including a bounty hunter for monitoring decentralized processing and storage systems are described above, any of a variety of systems including a bounty hunter for monitoring decentralized processing and storage systems as appropriate to the requirements of specific applications. In certain embodiments, components can be arranged and included in any order or sequence not limited to the order and sequence shown and described. In a number of embodiments, some of the above components may be omitted or rearranged. Although the above embodiments of the invention are described in reference to systems including a bounty hunter for monitoring decentralized processing and storage systems the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

### Reversal of Blockchain Transactions

In several embodiments, methods and techniques enable the reversal of transactions on a blockchain. The methods can implement smart contracts to perform the reversals. Traditionally, no method exists for reversing blockchain transactions.

Reversals can be useful in various scenarios, such as (but not limited to) undoing accidental transfer, for undoing fraudulent transfers, for undoing spam transfers (e.g., advertising airdrop of NFT), etc. In some embodiments, a transaction written to a blockchain can be undone based on a vote of trusted entities. In some embodiments, a transaction can be sent to an escrow authority. The escrow authority can hold the transaction for some time before completing the transaction. During the hold time the transaction can be reversible by the escrow authority.

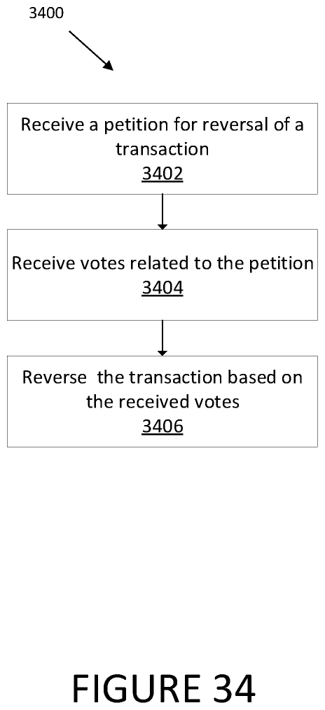

In several embodiments, a smart contract can instantiate a fungible token or non-fungible token. Smart contracts in accordance with a number of embodiments of the invention can include computer code allowing for the registration or recording of one or more trusted entities who can reverse an unintended transaction transferring a digital asset. In some embodiments, a transaction can be reversed based on a vote of trusted entities. An example process reversing a transaction based on a vote is conceptually illustrated in FIG. 34. The process 3400 in accordance with several embodiments of the invention can be executed by a smart contract. The smart contract can be deployed on a blockchain. The smart contract can be executed by computer systems on a network.

Deployers can deploy a smart contract on a blockchain. In various embodiments, the smart contract can instantiate one or more tokens. The list of trusted entities can be registered in the smart contract. Registering in accordance with a number of embodiments of the invention the list of trusted entities, can be performed by a deployer and/or the smart contract. In some embodiments, deploying a first smart contract can include registering a list of trusted entities.

A transaction can be submitted. Transactions can be submitted to make transfers on the blockchain. In various embodiments, transactions are submitted by posting data to a location accessible by miners. Miners can subsequently add the data to an open ledger and close the ledger (e.g., mining). Transactions can be submitted to smart contracts (e.g., a instantiating smart contract). The transaction can include a transfer of one or more tokens to another entity. In various embodiments, the transaction can be submitted by a transactor. A petition for reversal can be submitted. The petition for reversal can reference a transaction. Petitions for reversal can be submitted by a transactor that submitted the transaction or another entity such as (but not limited to) a trusted entity, a bounty hunter, a monitor, and/or another transactor. The petition can be submitted as a transaction on the blockchain. In some embodiments, the petition can include a transfer of tokens (e.g., cryptocurrency, NFT or other tokens) to an escrow smart contract. The transferred tokens can be considered part of a “stake”. Petitions in accordance with several embodiments of the invention can include one or more reasons describing why the associated transaction should be reversed, or reversed in part. Example reversal reasons can include (but are not limited to) one or more of: indications of fraud, indications of malware, indications of human error, a change in a market value of assets transferred in the transaction, or information on an identity of a recipient of assets transferred in the transaction (e.g., it can come to light after the transaction has been submitted that the recipient is a terrorist organization, a rogue state, a known criminal, or some other banned entity), etc. In some embodiments, the one or more reasons can be automatically generated by a client device of the associated entity to the petition or transaction, (e.g., by the wallet residing on such a device).

In various embodiments, the petition can be filed by a marketplace, including the marketplace involved in the transaction. In several embodiments, the petition can be automatically generated, e.g., based on the detection of malware. In some embodiments, at least a portion of a petition can be generated automatically generated (e.g., the generation of supporting evidence can, at least in part, be generated by an algorithm associated with a wallet after a user associated with the wallet initiates the generation of the complaint). In some embodiments, portions of the petition can be completed by a user.

In several embodiments, the petition can be auto-generated by a software bot. Software bot in accordance with several embodiments of the invention can utilize machine learning or artificial intelligence to detect the patterns of fraudulent transactions. For example, a software bot may identify as fraudulent: the creation of a new wallet into which numerous assets are transferred from multiple disassociated entities and rapidly listed for re-sale at unusually low prices in an effort to liquidate the assets as rapidly as possible. A petition can be generated in part by an end user, or by an admin associated with such an end user. The end user can be an entity associated with a wallet associated with a transaction, or a user that is affiliated with such.

In various embodiments, a trusted entity can be an escrow entity. A trusted entity can be included in an escrow authority.

The process 3400 can receive (3402) a petition for reversal of a transaction. In some embodiments, a petition can be submitted to the smart contract directly. For example, the petition can be submitted to the smart contract using a function call to a petition function of the smart contract. In various embodiments, a petition can be submitted to a proxy smart contract. The proxy smart contract can include a proxy component that transfers the petition to the first smart contract. In some embodiments, the petition can include an escrow transfer. An escrow transfer is described herein. Petitions in accordance with a variety of embodiments of the invention can include information about a transaction such as transaction ID, a sending address a receiving address, a token contract address, a text string describing a reason for reversing the transaction, and other information pertinent to the reversal. In several embodiments, submission of a petition can include calling a function in the smart contract. Calling the function in the smart contract can include (but is not limited to) supplying one or more of: a transaction Id, a sending address, a receiving address, a token contract address, a text string describing a reason for reversing the transaction, and/or other information pertinent to the reversal.

Process 3400 can receive (3404) votes related to the petition. In several embodiments, processes can receive votes from only trusted entities. In some embodiments, a smart contract can include a voting component. For example, the smart contract can include decentralized autonomous organization (DAO) code for managing voting. In some embodiments, each trusted entity can vote through a submission of a transaction to the blockchain. The smart contract can access the blockchain to receive the votes. In various embodiments, voting can occur through a function call by each of one or more trusted entities to the smart contract.

In some embodiments, the trusted entities can be notified of the vote through a blockchain monitoring component. Blockchain monitoring components can regularly query a smart contract for any votes in progress. In certain embodiments, blockchain monitoring components can text, email, message or communicate through another channel with the trusted entities. In some embodiments, the vote can require trusted entities to submit their vote within a predetermined time span. In some embodiments, a website can provide an interface to the trusted entities. The interface can display reversal proposals and information related to the transactions associated with the reversal proposals.

In various embodiments, trusted entities can be alerted to a petition through a web3 server monitoring the blockchain, and sending out emails, messages, or other forms of alerts to the trusted entities. The web3 server can be a bounty hunter, a marketplace server, or the escrow authority.

In several embodiments, trusted entities can be selected and recorded by a call to a function implemented in the smart contract. Selecting and recording the trusted entities can include providing identifiers for the trusted entities. The identifiers can be stored in a data structure within the smart contract. In some embodiments, the trusted entities can be selected and recorded on creation and deployment of the smart contract, through hard coded identifiers for the trusted entities. In some embodiments, an owner of the smart contract can be the only entity capable of causing the smart contract to record further trusted entities, delete existing trusted entities, or edit details on trusted entities. In several embodiments, recording, deleting and/or editing permitted trusted entities can require approval from existing trusted entities recorded in the smart contract. Approval can be required from all existing trusted entities, all but one of the existing trusted entities, a majority of existing trusted entities, or some other proportion of the existing trusted entities.

In some embodiments, the votes can be received from an arbitrator or plurality of arbitrators. In some embodiments, the arbitrators can be trusted entities. In some embodiments, the arbitrators can be selected through one or more of: a voting procedure, each arbitrator locking up a stake in order to become an arbitrator, a reputation algorithm measuring positive participation on the blockchain through prior approved transactions, or some other procedure.

In various embodiments, the votes can be received from escrow entities. The escrow entities can be trusted entities.

After the trusted entities have voted, the DAO can tally the votes and reach a decision as to whether the petition is to be granted or denied.

Based on the received votes the process 3400 can reverse (3406) the transaction. In some embodiments, the smart contract can automatically tally votes in favor or against reversing a transaction. In some embodiments, a vote can be concluded after all trusted entities have voted. In various embodiments, a vote can be concluded when a specified period of time has passed, when a specified number of trusted entities have voted, and/or when a predetermined threshold of votes in favor or against reversal have been cast. In some embodiments, reversing the transaction can include rewriting a record of ownership of one or more tokens in a ledger. The ledger can be the ledger instantiating the one or more tokens. The rewritten record of ownership can match an original record of ownership. The original record of ownership can be the record of ownership before the transaction for reversal was incorporated into the blockchain and acted on by the smart contract. In some embodiments, reversing the transaction can include submitting an inverse of the transaction. The inverse of the transaction can effectively reverse the transaction. The inverse of a transaction can be a transfer of tokens.

In some embodiments, when a transaction is reversed, an entity that submitted the petition can receive a reward. The reward can include (but is not limited to) a fixed number of cryptocurrency or tokens, an amount of cryptocurrency or tokens determined from a valuation of the reversed transaction (e.g., the reward can include 10% or some other percentage of a value of the reversed transaction T), and/or a predetermined proportion of a reward fund.

In some embodiments, when a transaction is reversed, a sending entity (e.g., a party sending spam NFTs) associated with the transaction can be penalized. In some embodiments, if a transaction is not reversed based on received votes, the entity having sent the petition (e.g., bounty hunter) can be penalized.

In several embodiments, an entity requesting (e.g., requesting entity) a transaction be reversed (e.g., submitting a petition for reversal) can pay a deposit to the entity capable of reversing the ownership (e.g., a smart contract, an escrow agency, one or more trusted entities). In cases where the transaction is reversed, the deposit or parts thereof can be returned to the requesting entity. Parts of the deposit can be paid or transferred to trusted entities and/or another account. The trusted entities receiving a portion of the deposit can be trusted entities involved in a vote on the petition. In cases where the transaction is not reversed the deposit or a portion of the deposit can be paid or transferred to a recipient and/or the trusted entities or another account. The recipient can be a receiving entity associated with the transaction. In various embodiments, the deposit can be unavailable after being transferred for a pre-set time.

In some embodiments, a recipient of a token, such as an NFT, can request the reversal of the transaction that caused the transfer of the token to this entity. The transfer for a reversal transaction can be borne by the sending entity. Thus, as a transfer of ownership is performed, a transfer deposit associated with the cost of reversal of the transaction can be held in escrow (e.g., by an escrow authority) for a set amount of time that can be stipulated by a marketplace, a jurisdiction, and/or by a system. Transfer deposits in accordance with a variety of embodiments of the invention can be refunded to the sending entity after a set amount of time, unless there is a reversal. In a number of embodiments, transfer deposits can be adjusted based on a configuration parameter.

In certain embodiments, trusted entities can be required to stake digital assets to participate as trusted entities. A trusted entity with staked digital assets can be referred to as a trusted staker. Trusted stakers can receive an income of digital assets of value for their staked contribution. The income can be in proportion to an amount staked, and/or a level of participation. Trusted stakers can have their stake reduced (also known as slashed) for failing to vote on petitions to reverse transactions, and/or for voting maliciously. For example, if a trusted staker votes against a reversal of a transaction, and it subsequently transpires that the trusted staker is connected to the potentially malicious recipient, other trusted stakers can vote to slash the trusted staker's stake.

While specific processes for reversing a transaction based on a vote are described above, any of a variety of processes can be utilized to reversing a transaction based on a vote as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to reversing a transaction on a blockchain the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

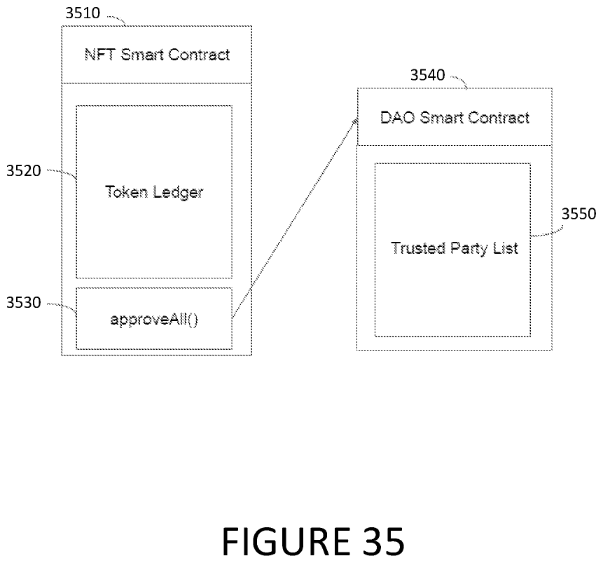

An example smart contract for implementing a process for reversing a transaction based on a vote is conceptually illustrated in FIG. 35. An NFT collection can be instantiated through an NFT smart contract 3510. In some embodiments, the NFT smart contract can implement an ERC721, ERC1155, or other NFT standard. The NFT smart contract 3510 can include a token ledger data structure 3520. The token ledger data structure 3520 can include a mapping that instantiates a ledger recording NFT token identifiers to owners. The NFT smart contract 3510 can include approveAll( ) functionality 3530. The approveAll( ) functionality 3530 can enable a DAO smart contract 3540 to operate on the token ledger 3520 contents, allowing the DAO smart contract 3540 to make alterations to the token ledger 3520. Alterations to the token ledger 3520 can include changing an owner of a specific token instantiated by the token ledger 3520. The DAO smart contract 3540 can only undertake such alterations through instructions provided by members of a trusted entity list 3550 when DAO smart contract 3540 encoded conditions are met.

For example, a specific token in the token ledger 3520 can have its owner changed to a previously recorded owner if a majority of the members of the trusted entity list 3550 vote to do so.

While specific smart contracts for reversing a transaction based on a vote are described above, any of a variety of smart contracts can be utilized to reversing a transaction based on a vote as appropriate to the requirements of specific applications. In certain embodiments, components can be arranged and included in any order or sequence not limited to the order and sequence shown and described. In a number of embodiments, some of the above components may be omitted or rearranged. Although the above embodiments of the invention are described in reference to reversing a transaction on a blockchain the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

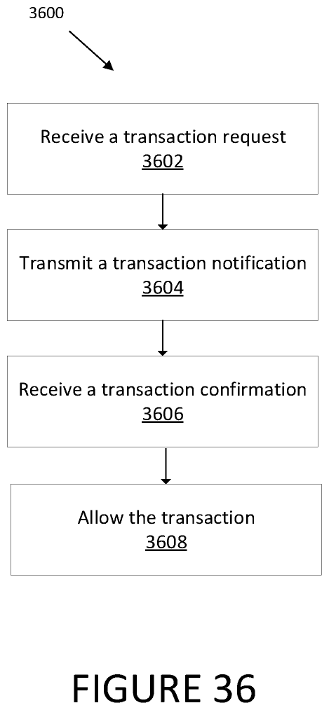

In several embodiments, a process can be implemented to protecting a transactor from fraudulent asset transfers by confirming transactions. An example process for transaction confirmation is conceptually illustrated in FIG. 36. In some embodiments, the process can be implemented when a linked account initiates a transfer. In some embodiments, a user's blockchain wallet can perform the process in the form of a wallet software component. In some embodiments, the user can selectively link some or all accounts within their blockchain wallet to a smart contract implementing the process. In various embodiments, a threshold can be set by the user. Transactions exceeding the threshold can be subjected to the process. In various embodiments, the process can be implemented by a smart contract. In several embodiments, the process can be implemented by an escrow authority.

The process 3600 can receive (3602) a transaction request. The transaction request can be a received from a user. The transaction request can be associated with a transaction that a user wants to send. The process 3600 can transmit (3604) a notification. The notification can be transmitted to the user. The notification can label the transaction as pending, and optionally indicating one or more of: what asset is to be transferred, from what account it is being transferred, to which account it is being transferred, and/or a value, estimated or actual, of the asset proposed for transfer. The process 3600 can receive (3606) a transaction confirmation from the user. The confirmation can indicate that the transaction should proceed. The process 3600 can allow (3608) the transaction to proceed.

In several embodiments, a user or owner of digital assets can associate, link, connect or lock their wallet holding the digital assets to one or more escrow authorities. A wallet linked in this way can require any transactions of assets to be conducted using the one or more escrow authorities. Consequently, in case a malicious smart contract attempts to transfer ownership of a digital asset of the wallet, the transfer can only be done through an escrow authority to which the owner has associated, linked, connected or locked their wallet. In this way, the owner can be given the possibility to cancel the transfer once being aware of it taking place. The escrow authority can be obliged to inform the seller of any initiated transfer of ownership, thereby giving the seller an opportunity to either approve or disapprove the transfer by performing one or more predetermined actions. In various embodiments, the user can petition to have the transaction reversed as described herein. The escrow authority can lock the digital assets associated with the transaction. In some embodiments, the escrow authority can lock the transaction until the transaction is allowed (e.g., in step 3608). Locking digital assets in this manner can be performed, for example, with changes made to the metadata of a particular token. The modified metadata can be recognized by a controlling smart contract as enabling a transfer lock or delay mechanism.

While specific processes for protecting a transactor from fraudulent asset transfers are described above, any of a variety of processes can be utilized for protecting a transactor from fraudulent asset transfers as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to protecting a transactor from fraudulent asset transfers the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

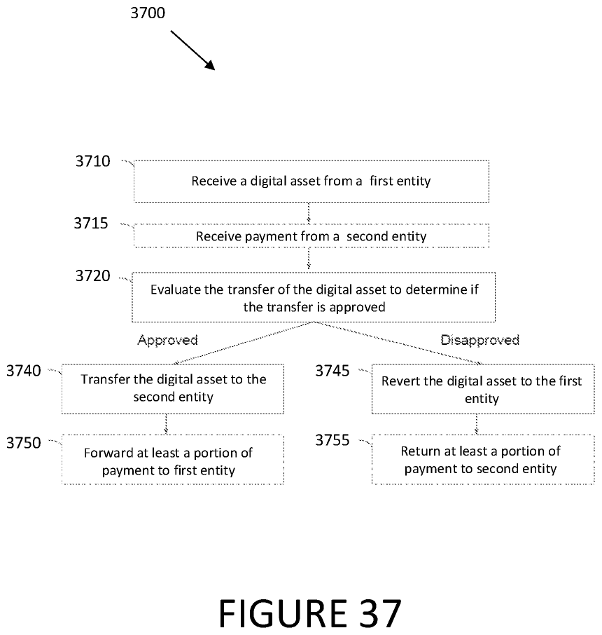

In various embodiments, smart contracts can be used to control the transfer of a digital asset for value. Smart contracts in accordance with a variety of embodiments of the invention can receive a digital asset and payment for the asset from two transacting parties before approving or disapproving the transaction. An example of a process for a controlled transfer of a digital asset for value is conceptually depicted in FIG. 37. In various embodiments, the process can be executed by a smart contract or an escrow authority.

The process 3700 can receive (3710) a digital asset. The digital asset can be received from a first entity. The process can receive, with the digital asset, information describing the conditions for transferring the digital asset. The information can include (but is not limited to) a second entity, a sale price, and/or other information. The first and second entities can be users, wallets associated with different users, etc.

The process 3700 can evaluate (3720) the transfer of the digital asset in order to determine if the transfer is approved. The evaluation of the transfer can include a variety of different actions as described in detail herein. Processes in accordance with numerous embodiments of the invention can evaluate the validity or probability of non-malicious actions associated with the transfer of the ownership of the digital asset. The result of the evaluation 3720 of the transfer results in the process approving or disapproving the transfer of the digital asset.

The process 3700 can transfer (3740) the digital asset to the second entity based on the process 3700 approving the transfer. The process 3700 can revert (3745) the digital asset to the first entity based on the process disapproving the transfer.

Optionally, the process 3700 can receive (3715) payment for the digital asset from the second entity. Optionally, the process 3700 can forward (3750) at least a portion of the payment to the first entity when the transferring the digital asset to the second entity. Optionally, the process 3700 can return (3755) at least a portion of the payment to the second entity if the transaction is disapproved.

In several embodiments, a smart contract can specify an approach for performing a transaction (e.g., the smart contract can require that ownership transfers are performed using an escrow authority from a list of approved escrow authorities. The escrow authorities can be associated with escrow authority smart contracts. Smart contracts in accordance with a variety of embodiments of the invention can require that all transfers be performed on a specific blockchain, such as (but not limited to) a particular blockchain associated with a watchful bridge. Watchful bridges are disclosed in U.S. Provisional Patent Application No. 63/365,936 entitled “Using Watchful Bridging for Blockchain Fraud Prevention” filed Jun. 6, 2022 by Markus Jakobsson, Stefan Dufva and Keir Finlow-Bates. The smart contract can specify whether a given node, such as a wallet, can access a token or associated content, as disclosed in co-pending application titled “Cross-Device Digital Rights Management” by Markus Jakobsson. The smart contract can also specify what types of content can be provided to nodes with various characterizations; node characterization is disclosed in the co-pending application titled “Node Characterization and Scoring Method” by Markus Jakobsson.

While specific processes control the transfer of a digital asset for value are described above, any of a variety of processes can be utilized to control the transfer of a digital asset for value as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to control the transfer of a digital asset for value the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

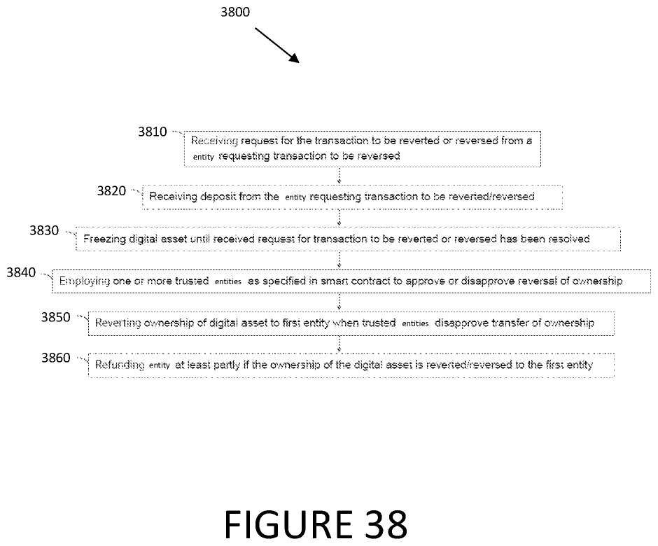

In several embodiments, transactions can be undone by reverting a transfer of ownership from first entity to a second entity. An example process for reverting a previous transfer of ownership is conceptually depicted in FIG. 38. In several embodiments, a process for reverting a previous transfer of ownership can be executed by a smart contract or an escrow authority.

The process 3800 can receive (3810) a request for the transaction to be reverted/reversed from a requesting entity. The request for the transaction to be reverted/reversed can be a petition. The requesting entity can be an entity sending a petition for a transaction to be reversed. Various entities that can request a transaction be reverted. For example, the previous owner, a bounty hunter, a smart contract etc.

The process 3800 can employ (3840) one or more trusted entities as specified in the smart contract to approve or disapprove the reversal of ownership. As described herein, the smart contract associated with the digital asset can specify one or more trusted entities to evaluate and decide upon the request for reversing or reverting the ownership of the digital asset.

The process 3800 can revert (3850) ownership of the digital asset to the first entity when the trusted entities disapprove the transfer.

Optionally, the process 3800 can receive (3820) a deposit from the requesting entity. Optionally, the process 3800 can freeze (3830) the digital asset until the received request for transaction to be reverted or reversed (e.g., petition) has been resolved. Freezing the digital asset in accordance with a variety of embodiments of the invention can include degrading the digital asset with reference to its functionalities, and/or prohibiting any further transactions of ownership, and/or disabling one or more functionalities of the digital asset. Optionally, the process 3800 can refund (3860) a received deposit to the depositing entity when the transaction is reverted or reversed.

In some embodiments, a petition to reverse a transaction can be sent within a predefined time limit after the transaction is sent. In various embodiments, the asset can be prohibited from further transactions until after a petition is resolved. In some embodiments, the petition can be an the on-chain submission of a message to one or more smart contracts, a communication to one or more bounty-hunters, an off-chain communication to trusted entities as defined by the smart contract, or another communication.

In certain embodiments, for the transaction to be reversed, a specified proportion of the trusted entities can be required to sign an approval of the reversal within a voting time-limit. In various embodiments, rusted entities can be assigned different weights for their vote to reverse or not reverse the transaction. For example, there can be ten trusted entities, with nine entities receiving one vote, and one entity receiving six votes, with a total of eight votes being required to reverse the transaction. Those skilled in the art will appreciate that weightings and proportions can be selected from a wide range of values, including non-integer values, depending on the particular power and influence distribution selected for the trusted entities. In some embodiments, weights specifying an entity's influence can be dependent on the size of the stake this entity has allocated.

In several embodiments, a requesting entity can be required to provide a deposit. Deposits in accordance with some embodiments of the invention can be a transfer of cryptocurrency or other digital assets to the smart contract, or to another arbitration or escrow smart contract. A deposit can be required for the petition to receive the attention of the trusted entities. In the event of a positive decision for the reversal of the transaction, the deposit (or a part thereof) can be returned to the requesting entity. In various embodiments, a percentage of the deposit can be paid to the trusted entities. The deposit can be paid to the trusted entities in proportion to their voting power. In various embodiments, a proportion of the deposit can be transferred to a common account instantiated on the blockchain through, for example, a smart contract.

In some embodiments, the petition from the requesting entity can be disapproved. When the petition is disapproved, the deposit can be transferred to a recipient. The recipient can be a recipient associated with the transaction identified in the petition. In some embodiments, a portion of the deposit can be transferred to the recipient, a portion of the deposit can be transferred to one or more of: the trusted entities, and/or a common account instantiated on the blockchain through, for example, a smart contract.

While specific processes reverting a previous transfer of ownership are described above, any of a variety of processes can be utilized for reverting a previous transfer of ownership as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to reverting a previous transfer of ownership the techniques disclosed herein may be used in any of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

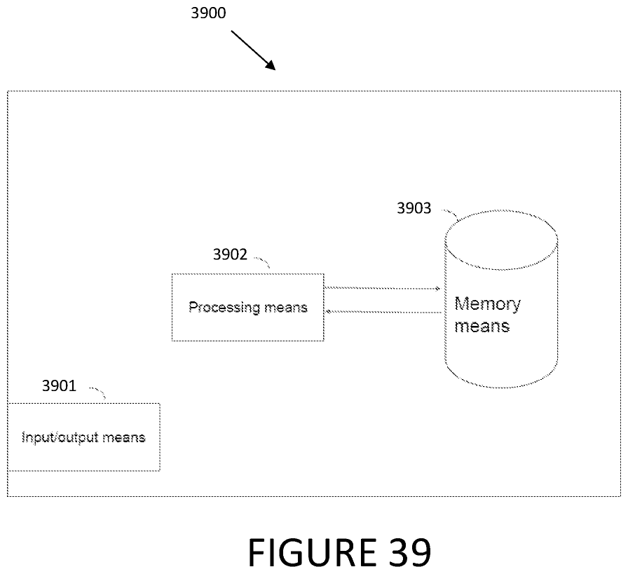

An example of an escrow authority is conceptually illustrated in FIG. 39. Escrow authority 3900 can be configured for handling various processes described herein. The escrow authority 3900 can include an input/output means 3901 by means of which the escrow authority 3900 can receive information and transmit or provide information to other units, devices and/or entities. The escrow authority 3900 can include processing means 3902 and memory means 3903, the memory means 3903 including instructions, which when executed by the processing means 3902 can cause the escrow authority 3900 to execute a process.

Those skilled in the art will recognize that the various descriptions are provided as an illustration of a particular implementation within current blockchain systems and is not limiting in any way. The present disclosure equally applies to blockchain systems in which digital assets are instantiated as native assets rather than through the use of a smart contract, and also to other forms of blockchain-like systems, such as directed acyclic graph-based consensus systems.

In several embodiments, a transaction submitted to a blockchain, can cause nodes maintaining and extending the blockchain to alter a ledger embodied within a smart contract. The transaction can record a transfer of a digital asset from a first entity with a first blockchain address, said first blockchain address listed within the ledger against the digital asset, to a second entity with a second blockchain address, such that the digital asset is now recorded as owned by the second blockchain address.

In some embodiments, an escrow authority can facilitate a transaction. A transfer can be made to an escrow authority, with the buyer identified as the recipient to which the escrow authority is to release the token after a specified condition has been met. The specified condition can be the passing of a specified amount of time without the filing of a complaint by the seller or an entity representing the seller. The escrow authority can hold the token to be transferred and the transfer (e.g., payment) made for the token. The transfer for the token can be crypto tokens, an NFT, a credit card transfer, etc., or a combination of these.

In several embodiments, a marketplace can play the role of an escrow authority. When the holder of a token to be transferred is a marketplace, and the same entity also plays the role of the escrow authority, fewer transfers can be required to effectuate a purchase of a token or, more generally, an exchange of two collections of assets.

In various embodiments, a smart contract executing a transfer can serve as an escrow authority. For example, a smart contract can include an ability to transfer tokens to the smart contract's wallet address whereby tokens can be held for a duration of time or until an accompanying message is received by the smart contract from either an authorized participant in the transaction or another smart contract. An example implementation uses an escrow authority corresponding to a process to which temporary ownership is assigned, along with instructions from one or more entities governing how to complete an exchange. This can be done using the process P, as disclosed in U.S. Provisional Patent Application No. 63/365,464 entitled “Safeguarding Ownership Transfer Against Abuse” filed May 27, 2022 by Markus Jakobsson, where P is external to the transacting entities or can include digital rights management (DRM) modules associated with the transacting entities. The process P can operate as a single trusted entity, as a distributed entity applying cryptographic operations using a quorum of participants, or using a consensus-based implementation; all of these approaches are disclosed in the cited application, where the process P was used to guard the interests of a user for which P works. As implemented herein, P can instead be objective and not work for any one of the participants of the transaction, but instead as a neutral entity.

In various embodiments, when a petition is granted, a smart contract can reverse the effects of a transaction. Reversing the effects of a transaction in accordance with a number of embodiments of the invention can be performed by reverting ownership of the digital asset to the entities who assigned them to an escrow authority, or who were indicated as beneficiaries of a reversing action (e.g., as part of a specification of terms associated with the assignment of the assets to the escrow authority). In some instances, assets can revert to a content creator if there is an unresolvable conflict as to what entity should be assigned the rights to the assets.

If the petition is denied, ownership of the digital asset can remain with the entities specified by the transfer agreements received by the escrow authority.

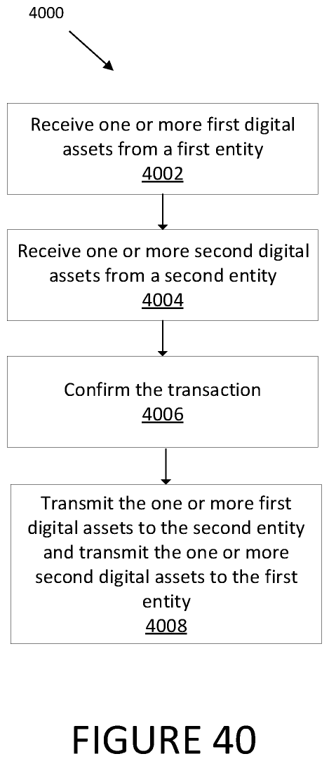

Traditionally, the endpoints of a transaction are referred to as the “buyer” and the “seller”. In various embodiments, two endpoints (e.g., two entities) can exchange digital assets through an escrow authority. In some embodiments, the escrow authority can be a smart contract. A process for two entities exchanging digital assets is conceptually illustrated in FIG. 40.

A process 4000 can receive (4002) one or more first digital assets from a first entity. The process 4000 can receive (4004) one or more second digital assets from a second entity. The process 4000 can confirm (4006) the transaction. Based on the transaction being confirmed the process 4000 can transmit the one or more first digital assets to the second entity and transmit the one or more second digital assets to the first entity. The digital assets can include an NFT, a subscription, a service agreement, a collection of assets etc.

Confirming the transaction can include satisfying one or more conditions. A condition can be associated with a set of inputs that satisfies the trading requirements of all endpoint entities. Endpoint entities can correspond to all entities receiving any digital assets at the conclusion of the process. The first entity and the second entity can both be endpoint entities. In some embodiments, a condition can, be a minimum amount to be received in return for the sale of an NFT, or for the provision of a service. In various embodiments, a condition can be to receive assets whose cumulative weighted score exceeds a threshold. Each endpoint entity can provide a set of weights identifying the value of selected resources, and a threshold, and wherein the escrow authority verifies that the cumulative weighted score of the assets to be received by each entity results the condition being satisfied for each entity, based on their inputs to the escrow authority. In certain embodiments, a condition can be the absence of a complaint within a pre-specified amount of time, as described above. In the case of the filing of a complaint, the escrow authority or an entity associated the escrow authority can determines whether the complaint is valid. A valid complaint can correspond to a situation in which there appears to be fraud. Fraud could be detected where there is an indication of malware causing a trade. When there is a valid complaint, the escrow authority can undo the transaction and notifies the endpoint entities of this. In many embodiments, there can be scenarios, as described in U.S. patent application Ser. No. 17/198,123 entitled “Managing Ownership and Access” filed Mar. 10, 2021, whereby a transaction can involve disparate asset consumption times and whereby third entities and/or smart contracts can be used.

In some embodiments, at least some access rights can be transferred immediately when an escrow authority receives all input assets in a trade. The immediately transferred access rights can be limited (e.g., not include the right to resell an asset until the end of a reversal time period during which a transaction can be reversed). In some embodiments, the assets can be resold even during the reversal time period. An asset transfer can be configured for resale during the reversal time period when a trusted buyer has a staked position or has sufficiently doxxed themselves—documenting their identity.

A subsequent buyer can be aware of the risks associated with buying assets during a reversal time period. In various embodiments, a subsequent buyer can provide auto-reversal inputs to a transaction to purchase the asset, the asset still subject to the reversal time period. The auto-reversal inputs can require that the reversal of the ownership rights of any assets acquired automatically leads to the reversal of the associated transaction. The automatic transaction can be performed using an escrow authority. As an illustrative example: if user A sells token T to user B, user B can resell T to C before the holding period has ended. However, if A forces the reversal of the transaction of T to B, then C can automatically get refunded the amount C paid to B for T. In some embodiments, C can be refunded an amount different from what it paid to B, e.g., a smaller amount or a larger amount, as specified by an agreement between B and C, and wherein such adjustments of transfers are managed by an escrow authority involved in the transaction between B and C, which can be the same escrow authority as is involved in the transaction between A and B. In a situation where user A has an asset transferred illegitimately to user B, and user B immediately resells the item to legitimate user C, it would be possible for the escrow authority (e.g., smart contract) to have restricted user B's sale proceeds for a time period which corresponds to user A's ability to make a claim regarding the initial theft, thereby enabling user A to receive compensation from user B in the form of the proceeds from the sale to user C.

In several embodiments, when an asset is allowed to be resold during a reversal time period associated with a first sale, an escrow authority can be used to manage all subsequent sales of the asset. Using an escrow authority can guarantee the reversal of all sales in the chain if it is determined that the first sale of the asset is to be reversed.

In some embodiments, each subsequent buyer of the asset can send its transfer for the asset, whether a currency transfer or a transfer of a different form such as a traded non-fungible token, to the same escrow authority handling the initial transaction of the asset. Continuing the example involving A, B, C, and T discussed herein, both B and C send transfers for T to the same escrow authority X. If C sells the asset to another entity D then D will also send its transfer to X. If the initial transaction of the asset is determined to be reversed, the escrow authority can return the asset to the original owner and reverses the transfers for subsequent sales to the subsequent buyers. For instance, X will refund transfers to C and D, potentially adjusted up or down as described elsewhere herein. If it is determined that the initial transaction of the asset is to go forward without reversal, then the escrow authority simply proceeds with the escrow procedure for the subsequent sales. In the example, after the first reversal time period ends, then the sale of T from B to C is treated as the “first transaction”, and any subsequent sales of T that take place during this escrow period, such as a sale from D to another entity E, must also entail sending the transfer for T to X, so that they can be rolled back if this transfer from B to C is determined to be reversed. A person of skill in the art will recognize that escrow periods for subsequent sales in a chain can overlap and can involve identical or different conditions for finalizing or reversing a transaction, depending for instance on properties of a smart contract, of a buyer or seller, and/or other conditions. A person of skill in the art will also recognize that the same functionality of guaranteeing reversal of sales in a chain can be achieved through the use of multiple coordinating, trusted escrow authorities rather than relying on one single authority that handles all transactions.

In some embodiments, an entity can be blacklisted by an escrow authority. A blacklisted entity can be blocked from receiving any transfers. The blacklisted entity can be made a non-valid recipient of tokens. Assets associated with a blacklisted entity can be liquidated. In various embodiments, miners can stop accepting inputs that correspond to a tokens transfer to the public key of the backlisted entity. The blacklisted entity can provide evidence indicating legitimate behavior to an escrow authority in order to avoid being penalized, or to lift an improper penalty. In some embodiments, transaction reversals can be made to selectively to penalize entities that are determined to be acting in poor faith, based on, e.g., a security assessment associated with the different transactions of a series of associated transactions.

In some embodiments, more than two entities can be involved as endpoints of the transaction. One such setting is disclosed in co-pending U.S. patent application Ser. No. 17/198,123 entitled “Managing Ownership and Access” filed Mar. 10, 2021 by Markus Jakobsson and Stephen C. Gerber.

In several embodiments, an escrow authority is associated with a public key and a private key. The escrow authority can be a distributed entity comprising a collection of escrow entities. Each of the escrow entities can independently verifies transactions, requests, and complaints. In some situations, a quorum of such entities can be required to perform an action, such as an ownership transfer. In various embodiments, an endpoint entity, or a marketplace representing the endpoint entity, can initiate a transaction by assigning ownership of resources to the escrow authority, e.g., by recording it as the owner of the resources. Assigning ownership to an escrow authority can be performed by signing an agreement using a private key associated with the holding entity. The agreement can specify the resources along with any conditions, such as the conditions governing what an acceptable trade is, and as described above are associated with the ownership assignment. In some embodiments, entities can have conditions stating the maximum time during which the assets can be held by the escrow authority. In several embodiments, entities can have conditions stating the minimum time of holding, or identifying one or more standards for reversing transactions. An example standard for reversing a transaction can identify a set of indications, e.g., of malware infection or of scam, and can specify how a complaint can be filed.

In various embodiments, an escrow authority can include two or more entities whose collective actions are governed by a consensus mechanism. For example, analogously to how a proof of stake mining mechanism can be used to close ledgers by two or more participating entities, two or more entities governed by a consensus mechanism can cause the performance of tasks associated with an escrow authority (e.g., as described herein).

In several embodiments, the escrow authority can include a plurality of escrow entities acting as transaction reversal proposers, and a further two entities acting as transaction reversal endorsers. The consensus mechanism for transaction reversal endorsement can include proof of work. Once the plurality of escrow entities have collectively voted on reversing a transaction through a transaction reversal proposal, the transaction reversal proposal can require endorsement before passing and being included in the ledger. Endorsement can occur when one of the two entities acting as a transaction reversal endorser submits an endorsement transaction with an appropriate level of proof of work before a second transaction reversal endorser submits a refusal of endorsement transaction with the appropriate level of proof of work. In the exemplary implementation, two entities are presented as acting as transaction reversal endorsers, however, those skilled in the art will recognize that this can be generalized to any number of entities, and that the number of entities can increase or decrease over time.

While specific processes for two entities exchanging digital assets are described above, any of a variety of processes can be utilized for two entities exchanging digital assets as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to two entities exchanging digital assets the techniques disclosed herein may be used in of the rich media systems, permissioned blockchains, cryptographic systems, intelligent tokens, ledgers and/or ledger entries for selective removal of content, ledgers and/or ledger entries for security and privacy enhancements, processes for awarding bounty hunter rewards, systems for blockchain based decentralized storage and/or computation, processes for reversal of transactions posted to the blockchain, process for reversing transactions at an escrow authority, and other systems and processes discussed herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A device configured to reverse a transaction recorded on a distributed ledger maintained by a cryptographic system, the device comprising:
a network interface;
memory; and
a processor, the processor configured to:
obtain a petition for reversal of a transaction, the transaction incorporated into a distributed ledger;
obtain one or more votes from one or more trusted entities;
based on the obtained one or more votes, generate a ledger entry reversing the transaction;
compute a challenge using a cryptographic system, wherein the challenge is based on the ledger entry; and
broadcast a block incorporating the ledger entry to securely add the block to the distributed ledger, wherein the block is capable of being validated by using a cryptographic system to obtain a proof based on the challenge.

2. The device of claim 1, wherein:
the processor is further configured to receive the block; and
the proof is obtained based on the block.

3. The device of claim 1, wherein the proof is generated based on an iterative process.

4. The device of claim 1, wherein the petition comprises a transaction Id, a sending address and a receiving address.

5. The device of claim 1, wherein the one or more trusted entities are registered on a ledger.

6. The device of claim 1, wherein the processor is further configured to register a list of trusted entities.

7. The device of claim 1, wherein the one or more trusted entities are one or more trusted stakers.

8. The device of claim 1, wherein the processor is further configured to notify the one or more trusted entities.

9. The device of claim 8, wherein notifying the one or more trusted entities comprises using a blockchain monitoring component.

10. The device of claim 9, wherein the blockchain monitoring component regularly queries a smart contract for any votes in progress.

11. The device of claim 8, wherein notifying the one or more trusted entities comprises sending a message to the one or more trusted entities.

12. The device of claim 1, wherein the one or more votes are recorded on the distributed ledger.

13. The device of claim 1, wherein the one or more votes are received from one or more trusted entities.

14. The device of claim 1, wherein the transaction is reversed based on a tally of the one or more votes.

15. The device of claim 14, wherein a tally of the one or more votes is determined after all trusted entities have voted.

16. The device of claim 14, wherein a tally of the one or more votes is determined after a specified period of time has passed.

17. The device of claim 1, wherein reversing the transaction comprises rewriting a record of ownership of one or more tokens in the distributed ledger.

18. The device of claim 1, wherein reversing the transaction comprises rewriting a record of ownership of one or more tokens in the distributed ledger to match an original record of ownership.

19. The device of claim 1, wherein reversing the transaction comprises submitting an inverse transaction, the inverse transaction configured to undo changes associated with the transaction.

20. The device of claim 1, wherein the processor if further configured to generate a reward transaction, the reward transaction transferring tokens to an entity that submitted the petition.
